(19) United States
(12) Patent Application Publication
(10) Pub. No.: US 2010/0144545 A1
(43) Pub. Date: Jun. 10, 2010

(54) Arrays, Systems, and Methods of Using Genetic Predictors of Polycystic Diseases

(76) Inventor: Arlene Chapman, Decatur, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/532,767

(22) PCT Filed: Mar. 24, 2008
(86) PCT No.: PCT/US08/57996

§ 371 Date: Feb. 11, 2010

Related U.S. Application Data
(60) Provisional application No. 60/919,822, filed on Mar. 23, 2007.
(60) Provisional application No. 61/036,699, filed on Mar. 14, 2008.

(51) Int. Cl. C40B 30/04; C40B 40/06

(52) U.S. Cl. 506/9; 506/16

(57) ABSTRACT

Embodiments of the present disclosure encompass resequencing and comparative genomic hybridization arrays for identifying inherited polycystic diseases. The arrays allow identification of one or more of the following features: SNPs, deletions, duplications, mutations, unstable repeats, and the like that can be used to determine if a host has a polycystic disease such as ADPKD.

### RELATED APPLICATIONS/PATENTS

This application claims priority to provisional U.S. applications entitled “Arrays, Systems, and Methods of Using Genetic Predictors of Disease Severity in Autosomal Dominant Polycystic Kidney Disease” Ser. No. 60/919,822 filed Mar. 23, 2007 and “Arrays, Systems, and Methods of Using Genetic Predictors of Disease Severity in Autosomal Dominant Polycystic Kidney Disease” Ser. No. 61/036,699 filed Mar. 14, 2008, the contents of which are hereby expressly incorporated herein by reference.

### STATEMENT REGARDING FEDERALLY SPONSORED RESEARCH OR DEVELOPMENT

This invention was made with government support under NIH Grant No. U01 DK56956 awarded by the U.S. National Institutes of Health of the United States government. The government has certain rights in the invention

### FIELD OF THE INVENTION(S)

The present disclosure relates to array based systems and methods of use thereof for detecting genetic variation linked to polycystic disease.

### BACKGROUND

Extensive progress in the field of biotechnology over the last two decades has given rise to new and promising routes to the identification and investigation of diseases. Specifically, advances in nucleic acid synthesis and sequencing have led to the development of the science of genomics. High-throughput sequencing technologies have enabled significant milestones, including the mapping of the human genome. With the ability to rapidly sequence large amounts of DNA, large-scale analysis of genomic characteristics has become possible. Technologies are now evolving to identify and characterize features of the human genome pertinent to individual or population-based variations in genotypes that may be used to identify an individual's susceptibility to a given disease. Among the most promising of avenues for detecting genomic variance in individuals and populations is the analysis and characterization of single nucleotide polymorphisms.

Polymorphisms relate to variances in genomes among different species, for example, or among members of a species, among populations or sub-populations within a species, or among individuals in a species. Such variances are expressed as differences in nucleotide sequences at particular loci in the genomes in question. These differences include, for example, deletions, additions or insertions, rearrangements, or substitutions of nucleotides or groups of nucleotides in a genome.

One important type of polymorphism is a single nucleotide polymorphism (SNP). Single nucleotide polymorphisms occur with a frequency of about 8 in 10,000 base pairs, where a single nucleotide base in the DNA sequence varies among individuals. SNPs may occur both inside and outside the coding regions of genes. It is believed that many diseases, including cancer, hypertension, heart disease, and diabetes, for example, are in part due to SNPs or collections of SNPs found in subsets of the human population. Currently, a significant focus of clinical and investigative genomics is the identification and characterization of SNPs and groups of SNPs that contribute to the severity of phenotypic expression of medical disorders and the response to pharmacological agents. Importantly, in mendellian disorders such as autosomal dominant polycystic kidney disease, these SNP's may play an important role in disease severity and predict outcome in affected individuals.

Autosomal dominant polycystic kidney disease (ADPKD) is the most common inherited renal disease occurring in approximately 1 in 700-1,000 individuals and accounts for approximately 4.7% of the ESRD population in the United States. ADPKD is a systemic disorder characterized by the presence of renal cysts as well as cardiovascular (hypertension, mitral valve prolapse, intracranial aneurysms and left ventricular hypertrophy), gastrointestinal (liver cysts and diverticular disease), and extracellular matrix (inguinal hernias) manifestations. Renal involvement in ADPKD is characterized by the presence of epithelial lined cysts, which develop and expand and result in extreme renal enlargement resulting in ESRD. The majority of ADPKD individuals will enter ESRD by the seventh decade of life. The cost of renal replacement therapy alone for ADPKD in the United States is greater than $1 billion/year. Interventions successful at curing ADPKD or halting the progression to renal failure are important from both a patient care and health policy perspective and worthy of investigation.

ADPKD is a disease of slow renal progression where the majority of patients present with clinical symptoms in the third or fourth decade after significant disease progression such as renal and renal cyst volume has already occurred. The age of clinical presentation varies and can predate entry into ESRD by >25 years. Although most ADPKD patients will enter ESRD by the sixth decade of life, some remain oligosymptomatic and die of causes unrelated to ADPKD. When age of onset of ESRD is used as a measure of disease severity, large inter-individual variability exists and little predictive value of disease severity based on the age of entry to ESRD in affected family members is available. Given the slow rate of progression and the large inter-individual variability in age of entry into ESRD, ADPKD behaves more like a complex medical disorder with varying genetic contributions to disease severity, although a mendellian disease. We have demonstrated in two ADPKD study populations that renal volume is a more sensitive measure of disease severity than renal function measures (e.g., serum creatinine concentration) early in the course of disease.

Despite the discovery of the PKD1 and PKD2 genes 10 years ago, curative therapies are not yet available. PKD gene type (PKD1 vs. PKD2, with PKD1 being more severe), the presence of hypertension, albuminuria, and increased renal volume account for a significant portion of the variability of the mean age of entry into ESRD. However, age of entry into ESRD in ADPKD is an insensitive marker of disease severity (too late in a slowly progressive disorder) affected by variables (differing practice habits) that do not allow for the identification of important genetic contributors to disease severity. Identification of genetic contributions to earlier, more accurate and reliable measures of disease severity, such as renal volume, would allow for identification of those individuals most likely to progress to ESRD decades before its occurrence, when therapeutic intervention would be most likely to succeed.

Mutation based molecular diagnostics of ADPKD is complicated by genetic and allelic heterogeneity, large multi-exon genes, duplication of PKD1 and a high level of unclassified variants (UCV). Present mutation detection levels are 60-70%, and PKD1 and PKD2 UCV have not been systematically classified. We have analyzed the CRISP ADPKD population by molecular analysis. A cohort of 202 probands was screened by DHPLC, followed by direct sequencing using a clinical test of 121 with no definite mutation (plus controls). A subset was also screened for larger deletions and RT-PCR used to test abnormal splicing. Definite mutations were identified in 127 probands (62.9%) and all UCV were assessed for their potential pathogenicity. From this analysis, 43 missense, plus 2 atypical splicing, and 7 small in-frame changes were defined as probably pathogenic and assigned to a mutation group. Mutations were thus defined in 179 probands (88.6%): 155 (84.9%) PKD1 and 27 (15.1%) PKD2. The majority of mutations were unique to a single family, but recurrent mutations accounted for 30.2% of the total. A total of 190 polymorphic variants were identified in PKD1 (average of 10.1 per patient) and 8 in PKD2. The potential for molecular diagnostics and prediction in ADPKD is likely to become increasingly important. Utilizing less expensive and more reliable sequence variation detection methods such as the resequencing array described in this application will be important.

The cumulative genetic contributions to disease severity, such as renal volume and serum creatinine estimate of GFR with regard to PKD genotype (PKD1 vs. PKD2), mutation type, and location and sequence variation (single nucleotide polymorphisms (SNPs)) in exon and intron structures of the PKD1 and PKD2 genes and their promoters in ADPKD individuals, is currently unknown. In addition, candidate non-PKD related genetic contributions (e.g.: related to the hypertensive state) have not been systematically evaluated using these measures of disease severity in ADPKD.

### SUMMARY

Embodiments of the present disclosure encompass resequencing and comparative genomic hybridization arrays for identifying inherited polycystic diseases. In particular, the resequencing and comparative genomic hybridization arrays may encompass a plurality of unique polynucleotide sequences for one or more of the following genes: polycystic kidney disease 1 (PKD1), polycystic kidney disease 2 (PKD2), polycystic kidney and hepatic disease 1, tuberous sclerosis 1, tuberous sclerosis 2, nephronophthisis 1, nephronophthisis 2, nephronophthisis 3, nephronophthisis 4, medullary cystic kidney disease type 1, medullary cystic kidney disease type 2, and autosomal dominant inherited polycystic liver disease. The unique polynucleotide sequences allow identification of one or more of the following features: SNPs, deletions, duplications, mutations, unstable repeats, and the like. The identifcation of one or more of the features of one or more of the genes mentioned above can be used to determine if a host has autosomal dominant polycystic kidney disease, other cystic diseases, what the severity of the autosomal dominant polycystic kidney disease is, treatment options for the host having autosomal dominant polycystic kidney disease, the determination of renal donor eligibility, family planning, paternity, affectation status of a variety of cystic disorders, and the like.

One aspect of the disclosure encompasses arrays for the detection of genetic variation associated with a polycystic disease or a plurality of polycystic diseases comprising: a plurality of nucleic acid segments, wherein each nucleic acid segment is immobilized to a discrete and known spot on a substrate surface to form an array of nucleic acids, and each spot comprises a segment of a nucleic acid sequence associated with a polycystic disease, wherein the unique polynucleotide sequences allow identification of one or more of the following: SNPs, deletions, duplications, and mutations.

In embodiments of this aspect of the disclosure, the nucleic acid sequences associated with a polycystic disease are derived from human genes selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease).

In one embodiment, the nucleic acid sequences associated with a polycystic disease are selected from the group consisting of PKD1 (GenBank Accession No: NM001009944), PKD2 (GenBank Accession No: NM000297), PKHD1 (GenBank Accession No: NM138694), TSC1 (GenBank Accession No: NM000368), TSC2 (GenBank Accession No: NM000548), PRKCSH (GenBank Accession No: NM002743), UMOD (GenBank Accession No: NM003361), NPHP1 (GenBank Accession No: NM000272), NPHP2 (GenBank Accession No: NM014425), NPHP3 (GenBank Accession No: NM153240), NPHP4 (GenBank Accession No: 015102), and SEC63 (GenBank Accession No: NM007214).

In one embodiment of the disclosure, the nucleic acid segments are derived from the nucleic acid sequences shown in Table 8 or Table 9 below. In one embodiment, the nucleic acid segments are derived from the nucleic acid sequences shown in Table 8. In another embodiment, the nucleic acid segments are derived from the nucleic acid sequences shown in Table 9.

In various embodiments of the disclosure, the nucleic acid segments on the array may be about 20 to 80 nucleotides in length.

Embodiments of the disclosure may include nucleic acid segments associated with PKD1 derived from the cDNA sequence having GenBank Accession No: NM001009944.

In the embodiments of the disclosure, the array(s) may have nucleic acid segments derived from a plurality of genes associated with polycystic diseases, and wherein the genes are selected from the group consisting of PKD1 cDNA, PKD2, PKHD1, TSC1, TSC2, PRKCSH, UMOD, NPHP1, NPHP2, NPHP3, NPHP4, and SEC63.

In some embodiments, the plurality of genes comprises the group PKD1, PKD2, PRKCSH, and UMOD.

In embodiments of the disclosure, the array may be distributed on a single substrate surface.

In the embodiments of the disclosure, at least one nucleic acid spot may comprise a nucleic acid segment acting as a negative control, and wherein the array-immobilized genomic nucleic acid segments in a first spot are non-overlapping in sequence compared to the array-immobilized genomic nucleic acid segments in a second spot.

In other embodiments, the array-immobilized genomic nucleic acid segments in the first spot are non-overlapping in sequence compared to the array-immobilized genomic nucleic acid segments in all other genomic nucleic acid-comprising spots on the array. In some embodiments, at least one genomic nucleic acid segment may be spotted in duplicate or triplicate on the array. In one embodiment, in the array the duplicate spot or triplicate spot has a different amount of nucleic acid segments immobilized. In embodiments of the disclosure, all the genomic nucleic acid segments are spotted in duplicate or triplicate on the array. In one embodiment, at least 95% of the array-immobilized genomic nucleic acid segments comprise a label.

Another aspect of the disclosure are methods for screening a host for at polycystic disease, comprising: detecting a polynucleotide sequence having intronic and/or exonic variation a gene associated with a polycystic disease comprising contacting a nucleic acid sample isolated from a patient with an array of nucleic acids derived from a plurality of genes associated with a polycytic disease, wherein the plurality of genes are selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease). In embodiments of this aspect of the disclosure, the methods may comprise isolating a nucleic acid from a patient, synthesizing a cDNA using the isolated nucleic acid, hybridizing the cDNA to a resequencing array comprising fragments of a plurality of genes associated with polycystic diseases, identifying variations in the sequences of the cDNAs compared to the sequences of the corresponding genes attached to the array, and determining if the sequence variations are correlated to a polycystic disease, thereby identifying the patient as either having the disease or capable of having the disease.

In embodiments of the methods of the disclosure, the methods may further comprise amplifying regions of a nucleic acid sample from a patient, hybridizing the amplified nucleic acid to an array comprising a plurality of nucleotide regions of a plurality of target genes associated with at least one polycystic disease, and identifying whether the nucleic acid of the patient has an insertion or deletion within at least one of the target genes when compared to the target genes of the array, thereby determining if the sequence variations are correlated to a polycystic disease, thereby identifying the patient as either having the disease or capable of having the disease

In one embodiment of the disclosure, the method encompasses detection of the variation in an intron of PKD1 in a biological sample from a host that indicates disease severity in ADPKD, wherein disease severity is defined as renal and cyst volume measured by MR after adjusting for age, gender, race, hypertension, and number of SNPs analyzed.

In the embodiments of the methods of this aspect of the disclosure, the host is a human embryo, a human fetus, a human newborn, a human infant, or a human adult.

Another aspect of the disclosure encompasses kits for detecting a genetic variation in a gene associated with a polycystic disease comprising a resequencing array for detecting a polymorphism in a nucleic acid sequence associated with a polycystic disease are derived from human genes selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease), and instructions for the use thereof.

### BRIEF DESCRIPTION OF THE FIGURES

Many aspects of the disclosure can be better understood with reference to the following drawings.

FIG. 1 illustrates the serum creatinine estimate of GFR and renal volume relationships in PKD1 and PKD2 individuals.

FIG. 2 illustrates renal volume estimates based on mutation type in PKD2 subjects.

FIG. 3 illustrates the frequency of sequence variants (SNPs) found in PKD2 individuals.

FIG. 4A illustrates renal volume measures in PKD1 and PKD2 individuals based on the three most common polymorphisms found in the PKD2 gene and promoter.

FIG. 4B illustrates renal volume measures in PKD1 and PKD2 individuals based on the three most common polymorphisms found in the PKD2 gene and promoter.

FIG. 4C illustrates renal volume measures in PKD1 and PKD2 individuals based on the three most common polymorphisms found in the PKD2 gene and promoter.

FIGS. 5A-5D illustrate typical data profiles reflecting SNPs in the PDK1 gene.

FIG. 6 illustrates a typical CGH scan, in this case for the NPHP2 gene.

FIGS. 7A-7E show the sequence of PKD1 with the positions of the forward and reverse primers indicated. Primer sequences are in bold. Forward sequences are in italics and single underlined. Reverse primers are double underlined.

The drawings are described in greater detail in the description and examples below.

The details of some exemplary embodiments of the methods and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of genetics, synthetic organic chemistry, biochemistry, biology, molecular biology, and the like, which are within the skill of the art. Such techniques are explained fully in the literature. In accordance with the present disclosure there may be employed conventional molecular biology, microbiology, and recombinant DNA techniques within the skill of the art. Such techniques are explained fully in the literature. See, e.g., Maniatis, Fritsch & Sambrook, “Molecular Cloning: A Laboratory Manual (1982); “DNA Cloning: A Practical Approach,” Volumes I and II (D. N. Glover ed. 1985); “Oligonucleotide Synthesis” (M. J. Gait ed. 1984); “Nucleic Acid Hybridization” (B. D. Hames & S. J. Higgins eds. (1985)); “Transcription and Translation” (B. D. Hames & S. J. Higgins eds. (1984)); “Animal Cell Culture” (R. I. Freshney, ed. (1986)); “Immobilized Cells and Enzymes” (IRL Press, (1986)); B. Perbal, “A Practical Guide To Molecular Cloning” (1984), each of which is incorporated herein by reference.

Prior to describing the various embodiments, the following definitions are provided and should be used unless otherwise indicated.

### DEFINITIONS

In describing and claiming the disclosed subject matter, the following terminology will be used in accordance with the definitions set forth below.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

As used in this specification and the appended claims, the singular forms “a,” “an” and “the” include plural references unless the content clearly dictates otherwise. Thus, for example, reference to “a carrier” includes a mixture of two or more carriers.

By the term “complementarity” or “complementary” is meant, for the purposes of the specification or claims, a sufficient number in the oligonucleotide of complementary base pairs in its sequence to interact specifically (hybridize) with the target nucleic acid sequence of the polycystic disease gene polymorphism to be amplified or detected. As known to those skilled in the art, a very high degree of complementarity is needed for specificity and sensitivity involving hybridization, although it need not be 100%. Thus, for example, an oligonucleotide that is identical in nucleotide sequence to an oligonucleotide disclosed herein, except for one base change or substitution, may function equivalently to the disclosed oligonucleotides. A “complementary DNA” or “cDNA” gene includes recombinant genes synthesized by reverse transcription of messenger RNA (“mRNA”).

By “detectably labeled” is meant that a fragment or an oligonucleotide contains a nucleotide that is radioactive, or that is substituted with a fluorophore, or that is substituted with some other molecular species that elicits a physical or chemical response that can be observed or detected by the naked eye or by means of instrumentation such as, without limitation, scintillation counters, colorimeters, UV spectrophotometers and the like. As used herein, a “label” or “tag” refers to a molecule that, when appended by, for example, without limitation, covalent bonding or hybridization, to another molecule, for example, also without limitation, a polynucleotide or polynucleotide fragment provides or enhances a means of detecting the other molecule. A fluorescence or fluorescent label or tag emits detectable light at a particular wavelength when excited at a different wavelength. A radiolabel or radioactive tag emits radioactive particles detectable with an instrument such as, without limitation, a scintillation counter. Other signal generation detection methods include: chemiluminescence, electrochemiluminescence, raman, colorimetric, hybridization protection assay, and mass spectrometry

The term “polynucleotide” as used herein refers to any polyribonucleotide or polydeoxyribonucleotide, which may be unmodified RNA or DNA or modified RNA or DNA. Thus, for instance, polynucleotides as used herein refers to, among others, single- and double-stranded DNA, DNA that is a mixture of single- and double-stranded regions, single- and double-stranded RNA, and RNA that is mixture of single- and double-stranded regions, hybrid molecules comprising DNA and RNA that may be single-stranded or, more typically, double-stranded or a mixture of single- and double-stranded regions. Polynucleotide encompasses the terms “nucleic acid,” “nucleic acid sequence,” or “oligonucleotide” as defined above.

In addition, the term “polynucleotide” as used herein refers to triple-stranded regions comprising RNA or DNA or both RNA and DNA. The strands in such regions may be from the same molecule or from different molecules. The regions may include all of one or more of the molecules, but more typically involve only a region of some of the molecules. One of the molecules of a triple-helical region often is an oligonucleotide.

“DNA” refers to the polymeric form of deoxyribonucleotides (adenine, guanine, thymine, or cytosine) in either single stranded form, or as a double-stranded helix. This term refers only to the primary and secondary structure of the molecule, and does not limit it to any particular tertiary forms. Thus, this term includes double-stranded DNA found, inter alia, in linear DNA molecules (e.g., restriction fragments), viruses, plasmids, and chromosomes. In discussing the structure of particular double-stranded DNA molecules, sequences may be described herein according to the normal convention of giving only the sequence in the 5′ to 3′ direction along the nontranscribed strand of DNA (i.e., the strand having a sequence homologous to the mRNA).

By the terms “enzymatically amplify” or “amplify” is meant, for the purposes of the specification or claims, DNA amplification, i.e., a process by which nucleic acid sequences are amplified in number. There are several means for enzymatically amplifying nucleic acid sequences. Currently the most commonly used method is the polymerase chain reaction (PCR). Other amplification methods include LCR (ligase chain reaction) which utilizes DNA ligase, and a probe consisting of two halves of a DNA segment that is complementary to the sequence of the DNA to be amplified, enzyme Qβ replicase and a ribonucleic acid (RNA) sequence template attached to a probe complementary to the DNA to be copied which is used to make a DNA template for exponential production of complementary RNA; strand displacement amplification (SDA); Qβ replicase amplification (QβRA); self-sustained replication (3SR); and NASBA (nucleic acid sequence-based amplification), which can be performed on RNA or DNA as the nucleic acid sequence to be amplified.

A “fragment” of a molecule such as a protein or nucleic acid is meant to refer to any portion of the amino acid or nucleotide genetic sequence.

As used herein, the term “genome” refers to all the genetic material in the chromosomes of a particular organism. Its size is generally given as its total number of base pairs. Within the genome, the term “gene” refers to an ordered sequence of nucleotides located in a particular position on a particular chromosome that encodes a specific functional product (e.g., a protein or RNA molecule).

By “heterozygous” or “heterozygous polymorphism” is meant that the two alleles of a diploid cell or organism at a given locus are different, that is, that they have a different nucleotide exchanged for the same nucleotide at the same place in their sequences.

By “homozygous” or “homozygous polymorphism” is meant that the two alleles of a diploid cell or organism at a given locus are identical, that is, that they have the same nucleotide for nucleotide exchange at the same place in their sequences.

By “immobilized on a solid support” is meant that a fragment, primer or oligonucleotide is attached to a substance at a particular location in such a manner that the system containing the immobilized fragment, primer or oligonucleotide may be subjected to washing or other physical or chemical manipulation without being dislodged from that location. A number of solid supports and means of immobilizing nucleotide-containing molecules to them are known in the art; any of these supports and means may be used in the methods of this disclosure.

As used herein, the term “locus” or “loci” refers to the site of a gene on a chromosome. A single allele from each locus is inherited from each parent. Each patient's particular combination of alleles is referred to as its “genotype”. Where both alleles are identical, the individual is homozygous for the trait controlled by that pair of alleles; where the alleles are different, the individual is the to be heterozygous for the trait.

A “melting temperature (Tm)” is meant the temperature at which hybridized duplexes dehybridize and return to their single-stranded state. Likewise, hybridization will not occur in the first place between two oligonucleotides, or, herein, an oligonucleotide and a fragment, at temperatures above the melting temperature of the resulting duplex. It is presently advantageous that the difference in melting point temperatures of oligonucleotide-fragment duplexes of this disclosure be from about 1° C. to about 10° C. so as to be readily detectable.

As used herein, the term “nucleic acid molecule” is intended to include DNA molecules (e.g., cDNA or genomic DNA), RNA molecules (e.g., mRNA), analogs of the DNA or RNA generated using nucleotide analogs, and derivatives, fragments and homologs thereof. The nucleic acid molecule can be single-stranded or double-stranded, but advantageously is double-stranded DNA. An “isolated” nucleic acid molecule is one that is separated from other nucleic acid molecules that are present in the natural source of the nucleic acid. A “nucleoside” refers to a base linked to a sugar. The base may be adenine (A), guanine (G) (or its substitute, inosine (I)), cytosine (C), or thymine (T) (or its substitute, uracil (U)). The sugar may be ribose (the sugar of a natural nucleotide in RNA) or 2-deoxyribose (the sugar of a natural nucleotide in DNA). A “nucleotide” refers to a nucleoside linked to a single phosphate group.

As used herein, the term “oligonucleotide” refers to a series of linked nucleotide residues, which oligonucleotide has a sufficient number of nucleotide bases to be used in a PCR reaction. A short oligonucleotide sequence may be based on, or designed from, a genomic or cDNA sequence and is used to amplify, confirm, or reveal the presence of an identical, similar or complementary DNA or RNA in a particular cell or tissue. Oligonucleotides may be chemically synthesized and may be used as primers or probes. Oligonucleotide means any nucleotide of more than 3 bases in length used to facilitate detection or identification of a target nucleic acid, including probes and primers.

“Polymerase chain reaction” or “PCR” refers to a thermocyclic, polymerase-mediated, DNA amplification reaction. A PCR typically includes template molecules, oligonucleotide primers complementary to each strand of the template molecules, a thermostable DNA polymerase, and deoxyribonucleotides, and involves three distinct processes that are multiply repeated to effect the amplification of the original nucleic acid. The three processes (denaturation, hybridization, and primer extension) are often performed at distinct temperatures, and in distinct temporal steps. In many embodiments, however, the hybridization and primer extension processes can be performed concurrently. The nucleotide sample to be analyzed may be PCR amplification products provided using the rapid cycling techniques described in U.S. Pat. Nos. 6,569,672; 6,569,627; 6,562,298; 6,556,940; 6,569,672; 6,569,627; 6,562,298; 6,556,940; 6,489,112; 6,482,615; 6,472,156; 6,413,766; 6,387,621; 6,300,124; 6,270,723; 6,245,514; 6,232,079; 6,228,634; 6,218,193; 6,210,882; 6,197,520; 6,174,670; 6,132,996; 6,126,899; 6,124,138; 6,074,868; 6,036,923; 5,985,651; 5,958,763; 5,942,432; 5,935,522; 5,897,842; 5,882,918; 5,840,573; 5,795,784; 5,795,547; 5,785,926; 5,783,439; 5,736,106; 5,720,923; 5,720,406; 5,675,700; 5,616,301; 5,576,218 and 5,455,175, the disclosures of which are incorporated by reference in their entireties. Other methods of amplification include, without limitation, NASBR, SDA, 3SR, TSA and rolling circle replication. It is understood that, in any method for producing a polynucleotide containing given modified nucleotides, one or several polymerases or amplification methods may be used. The selection of optimal polymerization conditions depends on the application.

A “polymerase” is an enzyme that catalyzes the sequential addition of monomeric units to a polymeric chain, or links two or more monomeric units to initiate a polymeric chain. In advantageous embodiments of this disclosure, the “polymerase” will work by adding monomeric units whose identity is determined by and which is complementary to a template molecule of a specific sequence. For example, DNA polymerases such as DNA pol 1 and Taq polymerase add deoxyribonucleotides to the 3′ end of a polynucleotide chain in a template-dependent manner, thereby synthesizing a nucleic acid that is complementary to the template molecule. Polymerases may be used either to extend a primer once or repetitively or to amplify a polynucleotide by repetitive priming of two complementary strands using two primers.

It will be appreciated that a great variety of modifications have been made to DNA and RNA that serve many useful purposes known to those of skill in the art. The term polynucleotide as it is employed herein embraces such chemically, enzymatically or metabolically modified forms of polynucleotides, as well as the chemical forms of DNA and RNA characteristic of viruses and cells, including simple and complex cells, inter alias.

By way of example, a polynucleotide sequence of the present disclosure may be identical to the reference sequence, that is be 100% identical, or it may include up to a certain integer number of nucleotide alterations as compared to the reference sequence. Such alterations are selected from the group including at least one nucleotide deletion, substitution, including transition and transversion, or insertion, and wherein said alterations may occur at the 5′ or 3′ terminal positions of the reference nucleotide sequence or anywhere between those terminal positions, interspersed either individually among the nucleotides in the reference sequence or in one or more contiguous groups within the reference sequence. The number of nucleotide alterations is determined by multiplying the total number of nucleotides in the reference nucleotide by the numerical percent of the respective percent identity (divided by 100) and subtracting that product from said total number of nucleotides in the reference nucleotide. Alterations of a polynucleotide sequence encoding the polypeptide may alter the polypeptide encoded by the polynucleotide following such alterations.

A “primer” is an oligonucleotide, the sequence of at least a portion of which is complementary to a segment of a template DNA which to be amplified or replicated. Typically primers are used in performing the polymerase chain reaction (PCR). A primer hybridizes with (or “anneals” to) the template DNA and is used by the polymerase enzyme as the starting point for the replication/amplification process. By “complementary” is meant that the nucleotide sequence of a primer is such that the primer can form a stable hydrogen bond complex with the template; i.e., the primer can hybridize or anneal to the template by virtue of the formation of base-pairs over a length of at least ten consecutive base pairs.

The primers herein are selected to be “substantially” complementary to different strands of a particular target DNA sequence. This means that the primers must be sufficiently complementary to hybridize with their respective strands. Therefore, the primer sequence need not reflect the exact sequence of the template. For example, a non-complementary nucleotide fragment may be attached to the 5′ end of the primer, with the remainder of the primer sequence being complementary to the strand. Alternatively, non-complementary bases or longer sequences can be interspersed into the primer, provided that the primer sequence has sufficient complementarity with the sequence of the strand to hybridize therewith and thereby form the template for the synthesis of the extension product.

“Probes” refer to oligonucleotides nucleic acid sequences of variable length, used in the detection of identical, similar, or complementary nucleic acid sequences by hybridization. An oligonucleotide sequence used as a detection probe may be labeled with a detectable moiety. Various labeling moieties are known in the art. The moiety may, for example, either be a radioactive compound, a detectable enzyme (e.g. horse radish peroxidase (HRP)) or any other moiety capable of generating a detectable signal such as a calorimetric, fluorescent, chemiluminescent or electrochemiluminescent signal. The detectable moiety may be detected using known methods.

The term “codon” as used herein refers to a specific triplet of mononucleotides in the DNA chain. Codons correspond to specific amino acids (as defined by the transfer RNAs) or to start and stop of translation by the ribosome.

The term “degenerate nucleotide sequence” as used herein denotes a sequence of nucleotides that includes one or more degenerate codons (as compared to a reference polynucleotide molecule that encodes a polypeptide). Degenerate codons contain different triplets of nucleotides, but encode the same amino acid residue (e.g., GAU and GAC triplets each encode Asp).

The term “isolated” as used herein is meant to describe a polynucleotide, a polypeptide, an antibody, or a host cell that is in an environment different from that in which the polynucleotide, the polypeptide, the antibody, or the host cell naturally occurs.

“Optional” or “optionally” means that the subsequently described circumstance may or may not occur, so that the description includes instances where the circumstance occurs and instances where it does not.

The term “array” as used herein encompasses the term “microarray” and refers to an ordered array presented for binding to polynucleotides and the like.

An “array” includes any two-dimensional or substantially two-dimensional (as well as a three-dimensional) arrangement of addressable regions including nucleic acids (e.g., particularly polynucleotides or synthetic mimetics thereof) and the like. Where the arrays are arrays of polynucleotides, the polynucleotides may be adsorbed, physisorbed, chemisorbed, and/or covalently attached to the arrays at any point or points along the nucleic acid chain.

A substrate may carry one, two, four or more arrays disposed on a front surface of the substrate. Depending upon the use, any or all of the arrays may be the same or different from one another and each may contain multiple spots or features. A typical array may contain one or more, including more than two, more than ten, more than one hundred, more than one thousand, more ten thousand features, or even more than one hundred thousand features, in an area of less than about 20 cm² or even less than about 10 cm² (e.g., less than about 5 cm², including less than about 1 cm² or less than about 1 mm² (e.g., about 100 μm², or even smaller)). For example, features may have widths (that is, diameter, for a round spot) in the range from about 10 μm to 1.0 cm. Non-round features may have area ranges equivalent to that of circular features with the foregoing width (diameter) ranges.

Arrays can be fabricated using drop deposition from pulse-jets of either polynucleotide precursor units (such as monomers), in the case of in situ fabrication, or the previously obtained nucleic acid. Such methods are described in detail, for example, in U.S. Pat. No. 6,242,266, U.S. Pat. No. 6,232,072, U.S. Pat. No. 6,180,351, U.S. Pat. No. 6,171,797, and U.S. Pat. No. 6,323,043. In particular, for the purposes of the present disclosure an advantageous protocol is that of Nimbelgen Inc, Madison, Wis. These references are incorporated herein by reference.

The term “array package” as used herein may be the array plus a substrate on which the array is deposited, although the package may include other features (such as a housing with a chamber). A “chamber” references an enclosed volume (although a chamber may be accessible through one or more ports). It will also be appreciated that throughout the present application, that words such as “top,” “upper,” and “lower” are used in a relative sense only.

An array is “addressable” when it has multiple regions of different moieties (e.g., different polynucleotide sequences) such that a region (i.e., a “feature” or “spot” of the array) at a particular predetermined location (i.e., an “address”) on the array will detect a particular probe sequence. Array features are typically, but need not be, separated by intervening spaces. In the case of an array in the context of the present application, the “probe” will be referenced in certain embodiments as a moiety in a mobile phase (typically fluid), to be detected by “targets,” which are bound to the substrate at the various regions.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which a resulting signal is detected and recorded. For example, in fluorescent detection embodiments, the scan region includes the entire area of the slide scanned in each pass of the lens, between the first feature of interest and the last feature of interest, even if there exist intervening areas that lack features of interest.

An “array layout” refers to one or more characteristics of the features, such as feature positioning on the substrate, one or more feature dimensions, and an indication of a moiety at a given location.

The assays of this invention are diagnostic and/or prognostic (predictive), i.e., diagnostic/prognostic. The term “diagnostic/prognostic” is herein defined to encompass the following processes either individually or cumulatively depending upon the clinical context: determining the predisposition to a disease, determining the nature of a disease, distinguishing one disease from another, forecasting as to the probable outcome of a disease state, determining the prospect as to recovery from a disease as indicated by the nature and symptoms of a case, monitoring the disease status of a patient, monitoring a patient for recurrence of disease, and/or determining the preferred therapeutic regimen for a patient. The diagnostic/prognostic methods of this disclosure are useful, for example, for screening populations for the presence of ADPKD, determining the risk of developing ADPKD, diagnosing the presence of ADPKD, monitoring the disease status of ADPKD, determining the severity of ADPKD, and/or determining the prognosis for the course of disease.

By “hybridization” or “hybridizing,” as used herein, is meant the formation of A-T and C-G base pairs between the nucleotide sequence of a fragment of a segment of a polynucleotide and a complementary nucleotide sequence of an oligonucleotide. By complementary is meant that at the locus of each A, C, G or T (or U in a ribonucleotide) in the fragment sequence, the oligonucleotide sequenced has a T, G, C or A, respectively. The hybridized fragment/oligonucleotide is called a “duplex.” The terms “hybridizing” and “binding”, with respect to polynucleotides, are used interchangeably. The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

A “hybridization complex”, such as in a sandwich assay, means a complex of nucleic acid molecules including at least the target nucleic acid and a sensor probe. It may also include an anchor probe.

The term “stringent assay conditions” as used herein refers to conditions that are compatible to produce binding pairs of nucleic acids (e.g., surface bound and solution phase nucleic acids) of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the disclosure can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions that determine whether a nucleic acid is specifically hybridized to a surface bound nucleic acid. Wash conditions used to identify nucleic acids may include, but are not limited to, one or more of the following: a salt concentration of about 0.02 molar at pH 7 and a temperature of at least about 50° C. or about 55° C. to about 60° C.; a salt concentration of about 0.15 M NaCl at 72° C. for about 15 minutes; a salt concentration of about 0.2×SSC at a temperature of at least about 50° C. or about 55° C. to about 60° C. for about 15 to about 20 minutes or, equivalent conditions. In another example, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes. Stringent conditions for washing can also be, for example, 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference), followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

The term “polymorphism” as used herein refers to the occurrence of two or more genetically determined alternative sequences or alleles in a population. A polymorphic marker or site is the locus at which divergence occurs. A polymorphism may comprise one or more base changes, an insertion, a repeat, or a deletion. A polymorphic locus may be as small as one base pair (SNP). Polymorphic markers include restriction fragment length polymorphisms (RFLPs), variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

The term “allele” as used herein is any one of a number of alternative forms at a given locus (position) on a chromosome. An allele may be used to indicate one form of a polymorphism, for example, a biallelic SNP may have possible alleles A and B. An allele may also be used to indicate a particular combination of alleles of two or more SNPs in a given gene or chromosomal segment. The frequency of an allele in a population is the number of times that specific allele appears divided by the total number of alleles of that locus.

The term “genotype” as used herein refers to the genetic information an individual carries at one or more positions in the genome. A genotype may refer to the information present at a single polymorphism, for example, a single SNP. For example, if a SNP is biallelic and can be either an A or a C, then if an individual is homozygous for A at that position the genotype of the SNP is homozygous A or AA. Genotype may also refer to the information present at a plurality of polymorphic positions.

A “single nucleotide polymorphism” or “SNP” refers to polynucleotide that differs from another polynucleotide by a single nucleotide exchange. For example, without limitation, exchanging one A for one C, G, or T in the entire sequence of polynucleotide constitutes a SNP. Of course, it is possible to have more than one SNP in a particular polynucleotide. For example, at one locus in a polynucleotide, a C may be exchanged for a T, at another locus a G may be exchanged for an A, and so on. When referring to SNPs, the polynucleotide is most often DNA. A transition is the replacement of one purine by another purine or one pyrimidine by another pyrimidine. A transversion is the replacement of a purine by a pyrimidine or vice versa. Single nucleotide polymorphisms can also arise from a deletion of a nucleotide or an insertion of a nucleotide relative to a reference allele. Typically the polymorphic site is occupied by a base other than the reference base. For example, where the reference allele contains the base “T” at the polymorphic site, the altered allele can contain a “C”, “G” or “A” at the polymorphic site.

As used herein, the term “host” or “organism” includes humans, mammals (e.g., cats, dogs, horses, etc.), living cells, and other living organisms. A living organism can be as simple as, for example, a single eukaryotic cell or as complex as a mammal.

A “cyclic polymerase-mediated reaction” refers to a biochemical reaction in which a template molecule or a population of template molecules is periodically and repeatedly copied to create a complementary template molecule or complementary template molecules, thereby increasing the number of the template molecules over time.

“Denaturation” of a template molecule refers to the unfolding or other alteration of the structure of a template so as to make the template accessible to duplication. In the case of DNA, “denaturation” refers to the separation of the two complementary strands of the double helix, thereby creating two complementary, single stranded template molecules. “Denaturation” can be accomplished in any of a variety of ways, including by heat or by treatment of the DNA with a base or other denaturant.

A “detectable amount of product” refers to an amount of amplified nucleic acid that can be detected using standard laboratory tools. A “detectable marker” refers to a nucleotide analog that allows detection using visual or other means. For example, fluorescently labeled nucleotides can be incorporated into a nucleic acid during one or more steps of a cyclic polymerase-mediated reaction, thereby allowing the detection of the product of the reaction using, e.g., fluorescence microscopy or other fluorescence-detection instrumentation.

By the term “detectable moiety” is meant, for the purposes of the specification or claims, a label molecule (isotopic or non-isotopic) which is incorporated indirectly or directly into an oligonucleotide, wherein the label molecule facilitates the detection of the oligonucleotide in which it is incorporated, for example when the oligonucleotide is hybridized to amplified ob gene polymorphisms sequences. Thus, “detectable moiety” is used synonymously with “label molecule”. Synthesis of oligonucleotides can be accomplished by any one of several methods known to those skilled in the art. Label molecules, known to those skilled in the art as being useful for detection, include chemiluminescent or fluorescent molecules. Various fluorescent molecules are known in the art which are suitable for use to label a nucleic acid for the method of the present disclosure. The protocol for such incorporation may vary depending upon the fluorescent molecule used. Such protocols are known in the art for the respective fluorescent molecule.

“DNA amplification” as used herein refers to any process that increases the number of copies of a specific DNA sequence by enzymatically amplifying the nucleic acid sequence. A variety of processes are known. One of the most commonly used is the polymerase chain reaction (PCR), which is defined and described in later sections below. The PCR process of Mullis is described in U.S. Pat. Nos. 4,683,195 and 4,683,202. PCR involves the use of a thermostable DNA polymerase, known sequences as primers, and heating cycles, which separate the replicating deoxyribonucleic acid (DNA), strands and exponentially amplify a gene of interest. Any type of PCR, such as quantitative PCR, RT-PCR, hot start PCR, LAPCR, multiplex PCR, touchdown PCR, etc., may be used. Advantageously, real-time PCR is used. In general, the PCR amplification process involves an enzymatic chain reaction for preparing exponential quantities of a specific nucleic acid sequence. It requires a small amount of a sequence to initiate the chain reaction and oligonucleotide primers that will hybridize to the sequence. In PCR the primers are annealed to denatured nucleic acid followed by extension with an inducing agent (enzyme) and nucleotides. This results in newly synthesized extension products. Since these newly synthesized sequences become templates for the primers, repeated cycles of denaturing, primer annealing, and extension results in exponential accumulation of the specific sequence being amplified. The extension product of the chain reaction will be a discrete nucleic acid duplex with a termini corresponding to the ends of the specific primers employed.

The term “identity,” as used herein refers to a relationship between two or more polypeptide sequences or polynucleotide sequences, as determined by comparing the sequences. In the art, “identity” also means the degree of sequence relatedness between polypeptides as determined by the match between strings of such sequences. “Identity” and “similarity” can be readily calculated by known methods, including, but not limited to, those described in (Computational Molecular Biology, Lesk, A. M., Ed., Oxford University Press, New York, 1988; Biocomputing: Informatics and Genome Projects, Smith, D. W., Ed., Academic Press, New York, 1993; Computer Analysis of Sequence Data, Part I, Griffin, A. M., and Griffin, H. G., Eds., Humana Press, New Jersey, 1994; Sequence Analysis in Molecular Biology, von Heinje, G., Academic Press, 1987; and Sequence Analysis Primer, Gribskov, M. and Devereux, J., Eds., M Stockton Press, New York, 1991; and Carillo, H., and Lipman, D., SIAM J Applied Math., 48: 1073 (1988).

Preferred methods to determine identity are designed to give the largest match between the sequences tested. Methods to determine identity and similarity are codified in publicly available computer programs. The percent identity between two sequences can be determined by using analysis software (e.g., Sequence Analysis Software Package of the Genetics Computer Group, Madison Wis.) that incorporates the Needelman and Wunsch, (J. Mol. Biol., 48: 443-453, 1970) algorithm (e.g., NBLAST, and XBLAST). The default parameters are used to determine the identity for the polypeptides of the present disclosure.

A “polynucleotide” refers to a linear chain of nucleotides connected by a phosphodiester linkage between the 3′-hydroxyl group of one nucleoside and the 5′-hydroxyl group of a second nucleoside which in turn is linked through its 3′-hydroxyl group to the 5′-hydroxyl group of a third nucleoside and so on to form a polymer comprised of nucleosides liked by a phosphodiester backbone. A “modified polynucleotide” refers to a polynucleotide in which one or more natural nucleotides have been partially or substantially replaced with modified nucleotides.

As used herein, a “template” refers to a target polynucleotide strand, for example, without limitation, an unmodified naturally-occurring DNA strand, which a polymerase uses as a means of recognizing which nucleotide it should next incorporate into a growing strand to polymerize the complement of the naturally-occurring strand. Such DNA strand may be single-stranded or it may be part of a double-stranded DNA template. In applications of the present disclosure requiring repeated cycles of polymerization, e.g., the polymerase chain reaction (PCR), the template strand itself may become modified by incorporation of modified nucleotides, yet still serve as a template for a polymerase to synthesize additional polynucleotides.

A “thermocyclic reaction” is a multi-step reaction wherein at least two steps are accomplished by changing the temperature of the reaction.

A “thermostable polymerase” refers to a DNA or RNA polymerase enzyme that can withstand extremely high temperatures, such as those approaching 100° C. Often, thermostable polymerases are derived from organisms that live in extreme temperatures, such as Thermus aquaticus. Examples of thermostable polymerases include Taq, Tth, Pfu, Vent, deep vent, UITma, and variations and derivatives thereof.

A “variance” is a difference in the nucleotide sequence among related polynucleotides. The difference may be the deletion of one or more nucleotides from the sequence of one polynucleotide compared to the sequence of a related polynucleotide, the addition of one or more nucleotides or the substitution of one nucleotide for another. The terms “mutation,” “polymorphism” and “variance” are used interchangeably herein. As used herein, the term “variance” in the singular is to be construed to include multiple variances; i.e., two or more nucleotide additions, deletions and/or substitutions in the same polynucleotide. A “point mutation” refers to a single substitution of one nucleotide for another.

The term “variant” as used herein refers to a polypeptide or polynucleotide that differs from a reference polypeptide or polynucleotide, but retains essential properties. A typical variant of a polypeptide differs in amino acid sequence from another, reference polypeptide. Generally, differences are limited so that the sequences of the reference polypeptide and the variant are closely similar overall and, in many regions, identical. A variant and reference polypeptide may differ in amino acid sequence by one or more modifications (e.g., substitutions, additions, and/or deletions). A variant of a polypeptide includes conservatively modified variants. A substituted or inserted amino acid residue may or may not be one encoded by the genetic code. A variant of a polypeptide may be naturally occurring, such as an allelic variant, or it may be a variant that is not known to occur naturally.

Modifications and changes can be made in the structure of the polypeptides of this disclosure and still obtain a molecule having similar characteristics as the polypeptide (e.g., a conservative amino acid substitution). For example, certain amino acids can be substituted for other amino acids in a sequence without appreciable loss of activity. Because it is the interactive capacity and nature of a polypeptide that defines that polypeptide's biological functional activity, certain amino acid sequence substitutions can be made in a polypeptide sequence and nevertheless obtain a polypeptide with like properties.

Unless otherwise defined, all technical and scientific terms used herein have the same meaning as commonly understood by one of ordinary skill in the art of molecular biology. Although methods and materials similar or equivalent to those described herein can be used in the practice or testing of the present disclosure, suitable methods and materials are described herein.

Further definitions are provided in context below. Unless otherwise defined, all technical and scientific terms used herein have the same meaning as commonly understood by one of ordinary skill in the art of molecular biology. Although methods and materials similar or equivalent to those described herein can be used in the practice or testing of the present disclosure, suitable methods and materials are described herein.

### Discussion:

### Tissue and DNA Samples

In order to determine the genotype of a patient according to the methods of the present disclosure, it is necessary to obtain a sample of genomic DNA from that patient. Typically, that sample of genomic DNA will be obtained from a sample of tissue or cells taken from that patient.

The tissue sample can comprise hair (including roots), buccal swabs, blood, saliva, semen, embryos, muscle or any internal organs. In the method of the present disclosure, the source of the tissue sample, and thus also the source of the test nucleic acid sample, is not critical. For example, the test nucleic acid can be obtained from cells within a body fluid, or from cells constituting a body tissue. The particular body fluid from which cells are obtained is also not critical to the present disclosure. For example, the body fluid may be selected from the group consisting of blood, ascites, pleural fluid and spinal fluid. Furthermore, the particular body tissue from which cells are obtained is also not critical to the methods of the present disclosure. For example, the body tissue may be selected from the group consisting of skin, endometrial, uterine and cervical tissue. Both normal and tumor tissues can be used.

Typically, the tissue sample may be marked with an identifying number or other indicia that relates the sample to the individual patient from which the sample was taken. The identity of the sample advantageously remains constant throughout the methods of the disclosure thereby guaranteeing the integrity and continuity of the sample during extraction and analysis. Alternatively, the indicia may be changed in a regular fashion that ensures that the data, and any other associated data, can be related back to the patient from which the data was obtained.

The amount/size of sample required is known to those skilled in the art. For example, non-limiting examples of sample sizes/methods include hair roots: greater than five and less than twenty; buccal swabs: 15 to 20 seconds of rubbing with modest pressure in the area between outer lip and gum using one Cytosoft® cytology brush; bone: 0.0020 g to 0.0040 g; and blood: 30 to 70 μl.

Generally, the tissue sample is placed in a container that is labeled using a numbering system bearing a code corresponding to the patient, for example. Accordingly, the genotype of a particular patient is easily traceable at all times.

DNA is isolated from the tissue/cells by techniques known to those skilled in the art (see, e.g., U.S. Pat. Nos. 6,548,256 and 5,989,431, Hirota et al., Jinrui Idengaku Zasshi. 1989 September; 34(3):217-23 and John et al., Nuc. Acids Res. 1991 Jan. 25; 19(2):408; the disclosures of which are incorporated by reference in their entireties). For example, high molecular weight DNA may be purified from cells or tissue using proteinase K extraction and ethanol precipitation. DNA may be extracted from an animal specimen using any other suitable methods known in the art.

### Determining the Genotype of a Patient

There are many methods known in the art for determining the genotype of a patient and for identifying whether the given DNA sample contains a particular SNP. Such methods include, but are not limited to, amplimer sequencing, DNA sequencing, fluorescence spectroscopy, fluorescence resonance energy transfer (or “FRET”)-based hybridization analysis, high throughput screening, mass spectroscopy, nucleic acid hybridization, polymerase chain reaction (PCR), RFLP analysis and size chromatography (e.g., capillary or gel chromatography), all of which are well known to one of skill in the art. In particular, methods for determining nucleotide polymorphisms, particularly single nucleotide polymorphisms, are described in U.S. Pat. Nos. 6,514,700; 6,503,710; 6,468,742; 6,448,407; 6,410,231; 6,383,756; 6,358,679; 6,322,980; 6,316,230; and 6,287,766 and reviewed by Chen & Sullivan, Pharmacogenomics J 2003; 3(2):77-96, the disclosures of which are incorporated by reference in their entireties.

### Determining the Genotype Using Cyclic Polymerase Mediated Amplification

In certain embodiments of the present disclosure, the detection of a given SNP can be performed using cyclic polymerase-mediated amplification methods. Any one of the methods known in the art for amplification of DNA may be used, such as for example, the polymerase chain reaction (PCR), the ligase chain reaction (LCR) (Barany, F., Proc. Natl. Acad. Sci. (U.S.A.) 88:189-193 (1991)), the strand displacement assay (SDA), or the oligonucleotide ligation assay (“OLA”) (Landegren, U. at al., Science 241:1077-1080 (1988)). Nickerson, D. A. et al., have described a nucleic acid detection assay that combines attributes of PCR and OLA (Nickerson, D. A. of al., Proc. Natl. Acad. Sci. (U.S.A.) 87:8923-8927 (1990)). Other known nucleic acid amplification procedures, such as transcription-based amplification systems (Malek, L. T. et al., U.S. Pat. No. 5,130,238; Davey, C. et al., European Patent Application 329,822; Schuster at al., U.S. Pat. No. 5,169,766; Miller, H. I. et al., PCT Application WO89/06700; Kwoh, D. et al., Proc. Natl. Acad. Sci. (U.S.A.) 86:1173 (1989); Gingeras, T. R. et al., PCT Application WO88/10315)), or isothermal amplification methods (Walker, G. T. et al., Proc. Natl. Acad. Sci. (U.S.A.) 89:392-396 (1992)) may also be used.

The most advantageous method of amplifying DNA fragments containing the SNPs of the disclosure employs PCR (see e.g., U.S. Pat. Nos. 4,965,188; 5,066,584; 5,338,671; 5,348,853; 5,364,790; 5,374,553; 5,403,707; 5,405,774; 5,418,149; 5,451,512; 5,470,724; 5,487,993; 5,523,225; 5,527,510; 5,567,583; 5,567,809; 5,587,287; 5,597,910; 5,602,011; 5,622,820; 5,658,764; 5,674,679; 5,674,738; 5,681,741; 5,702,901; 5,710,381; 5,733,751; 5,741,640; 5,741,676; 5,753,467; 5,756,285; 5,776,686; 5,811,295; 5,817,797; 5,827,657; 5,869,249; 5,935,522; 6,001,645; 6,015,534; 6,015,666; 6,033,854; 6,043,028; 6,077,664; 6,090,553; 6,168,918; 6,174,668; 6,174,670; 6,200,747; 6,225,093; 6,232,079; 6,261,431; 6,287,769; 6,306,593; 6,440,668; 6,468,743; 6,485,909; 6,511,805; 6,544,782; 6,566,067; 6,569,627; 6,613,560; 6,613,560 and 6,632,645; the disclosures of which are incorporated by reference in their entireties), using primer pairs that are capable of hybridizing to the proximal sequences that define or flank a polymorphic site in its double-stranded form.

To perform a cyclic polymerase mediated amplification reaction according to the present disclosure, the primers are hybridized or annealed to opposite strands of the target DNA, the temperature is then raised to permit the thermostable DNA polymerase to extend the primers and thus replicate the specific segment of DNA spanning the region between the two primers. Then the reaction is thermocycled so that at each cycle the amount of DNA representing the sequences between the two primers is doubled, and specific amplification of the ob gene DNA sequences, if present, results.

Any of a variety of polymerases can be used in the present disclosure. For thermocyclic reactions, the polymerases are thermostable polymerases such as Taq, KlenTaq, Stoffel Fragment, Deep Vent, Tth, Pfu, Vent, and UITma, each of which are readily available from commercial sources. For non-thermocyclic reactions, and in certain thermocyclic reactions, the polymerase will often be one of many polymerases commonly used in the field, and commercially available, such as DNA pol 1, Klenow fragment, T7 DNA polymerase, and T4 DNA polymerase. Guidance for the use of such polymerases can readily be found in product literature and in general molecular biology guides.

Typically, the annealing of the primers to the target DNA sequence is carried out for about 2 minutes at about 37-55° C., extension of the primer sequence by the polymerase enzyme (such as Taq polymerase) in the presence of nucleoside triphosphates is carried out for about 3 minutes at about 70-75° C., and the denaturing step to release the extended primer is carried out for about 1 minute at about 90-95° C. However, these parameters can be varied, and one of skill in the art would readily know how to adjust the temperature and time parameters of the reaction to achieve the desired results. For example, cycles may be as short as 10, 8, 6, 5, 4.5, 4, 2, 1, 0.5 minutes or less.

Also, “two temperature” techniques can be used where the annealing and extension steps may both be carried out at the same temperature, typically between about 60-65° C., thus reducing the length of each amplification cycle and resulting in a shorter assay time.

Typically, the reactions described herein are repeated until a detectable amount of product is generated. Often, such detectable amounts of product are between about 10 ng and about 100 ng, although larger quantities, e.g., 200 ng, 500 ng, 1 μg or more can also, of course, be detected. In terms of concentration, the amount of detectable product can be from about 0.01 pmol, 0.1 pmol, 1 pmol, 10 pmol, or more. Thus, the number of cycles of the reaction that are performed can be varied, the more cycles are performed, the more amplified product is produced. In certain embodiments, the reaction comprises 2, 5, 10, 15, 20, 30, 40, 50, or more cycles.

For example, the PCR reaction may be carried out using about 25-50 μl samples containing about 0.01 to 1.0 ng of template amplification sequence, about 10 to 100 pmol of each generic primer, about 1.5 units of Taq DNA polymerase (Promega Corp.), about 0.2 mM dDATP, about 0.2 mM dCTP, about 0.2 mM dGTP, about 0.2 mM dTTP, about 15 mM MgCl₂, about 10 mM Tris-HCl (pH 9.0), about 50 mM KCl, about 1 μg/ml gelatin, and about 10 μl/ml Triton X-100 (Saiki, 1988).

Those of skill in the art are aware of the variety of nucleotides available for use in the cyclic polymerase mediated reactions. Typically, the nucleotides will consist at least in part of deoxynucleotide triphosphates (dNTPs), which are readily commercially available. Parameters for optimal use of dNTPs are also known to those of skill, and are described in the literature. In addition, a large number of nucleotide derivatives are known to those of skill and can be used in the present reaction. Such derivatives include fluorescently labeled nucleotides, allowing the detection of the product including such labeled nucleotides, as described below. Also included in this group are nucleotides that allow the sequencing of nucleic acids including such nucleotides, such as chain-terminating nucleotides, dideoxynucleotides and boronated nuclease-resistant nucleotides. Commercial kits containing the reagents most typically used for these methods of DNA sequencing are available and widely used. Other nucleotide analogs include nucleotides with bromo-, iodo-, or other modifying groups, which affect numerous properties of resulting nucleic acids including their antigenicity, their replicatability, their melting temperatures, their binding properties, etc. In addition, certain nucleotides include reactive side groups, such as sulfhydryl groups, amino groups, N-hydroxysuccinimidyl groups, that allow the further modification of nucleic acids comprising them.

Resequencing of Nucleotide Sequences Associated with Polycystic Diseases

The methods of the present disclosure encompass screening of a patient's or patients' DNA for SNPs within genes having associations with one or more polycystic diseases, especially of, but not limited to, polycystic diseases of the kidney or liver. In these methods, an RNA sample may be isolated from a tissue of the patient by any method well known to those of ordinary skill in the art. Advantageously, the tissue sample is whole blood which may be obtained with least discomfort to the patient. However, any cell source from the patient is to be considered suitable if capable of providing an isolated nucleicacid sample. Preferably, the isolated nucleic acid is a messenger RNA or a genomic DNA, and the tissue sample may be, but not only, isolated from blood, a kidney or liver.

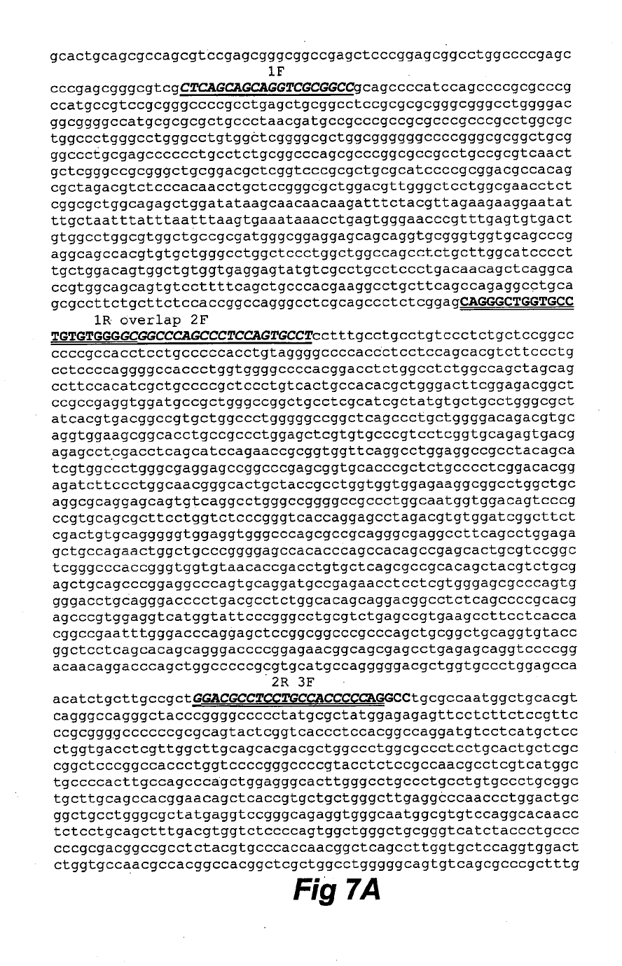

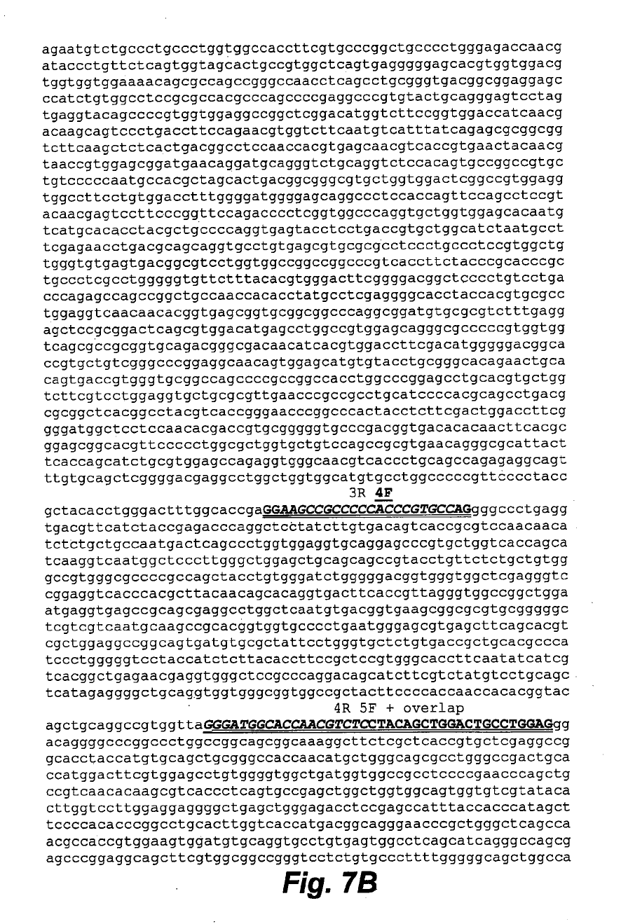

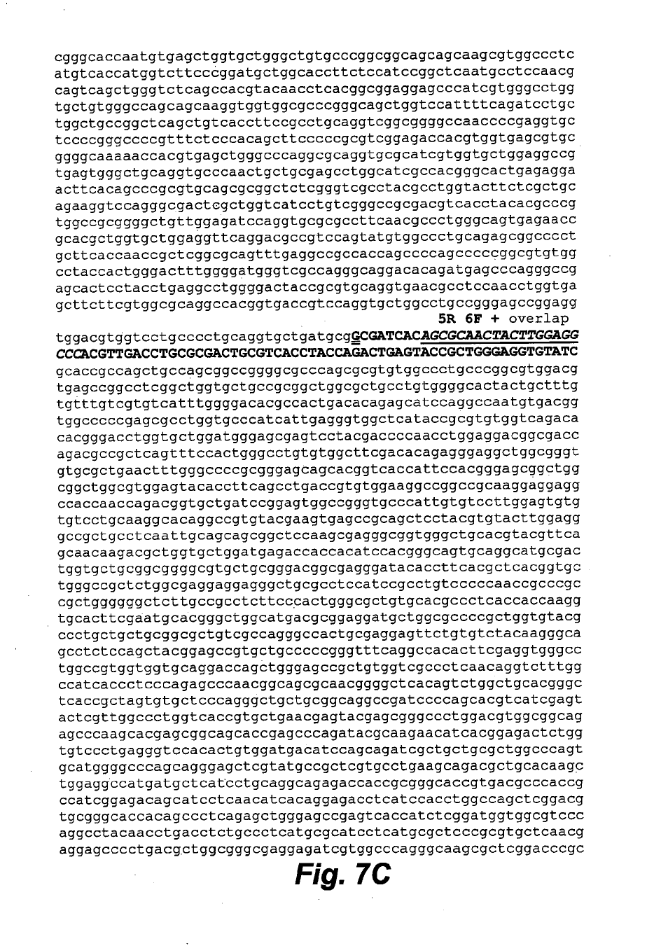

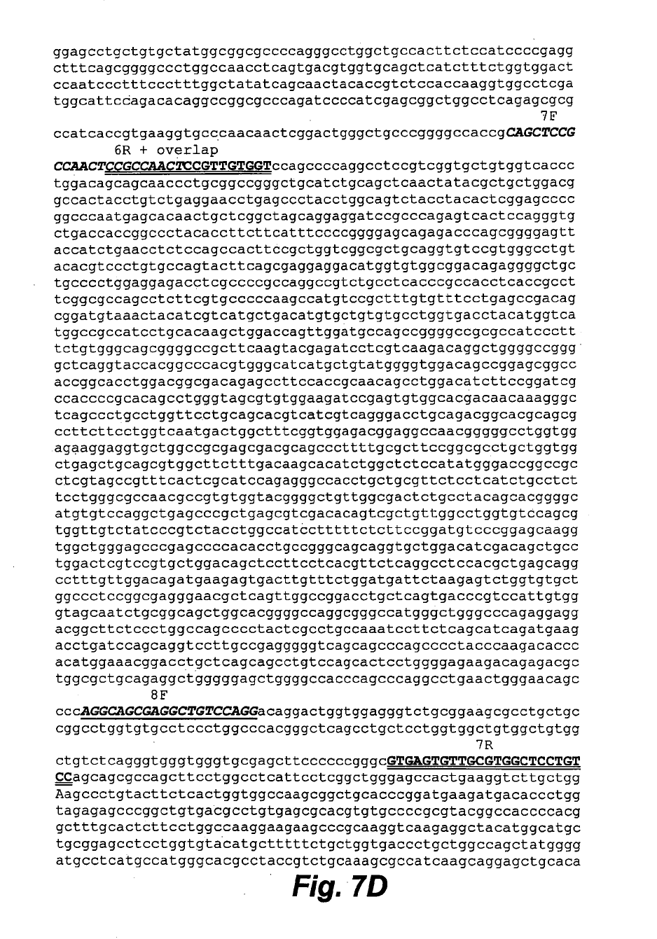

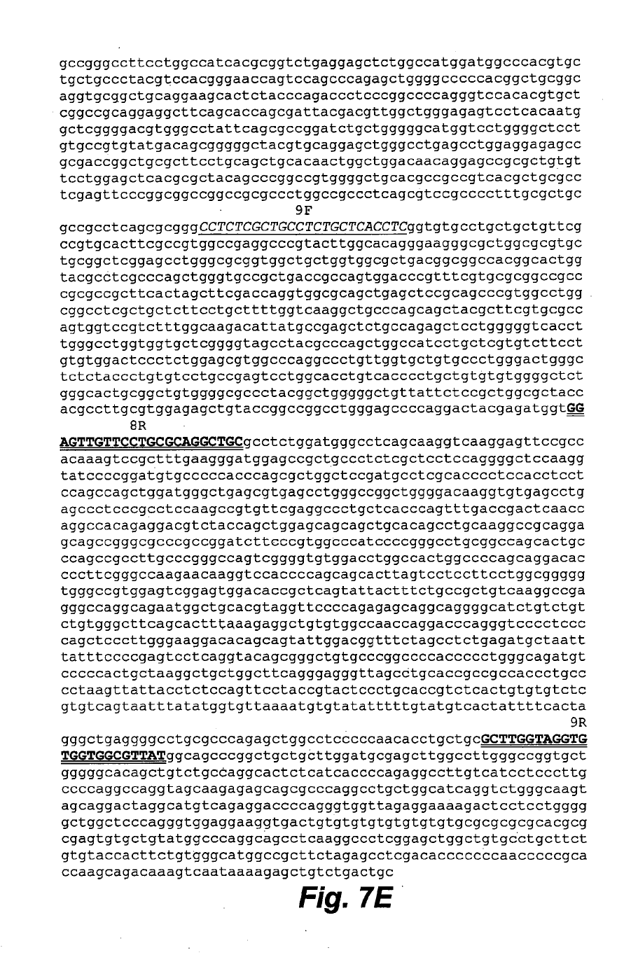

Specific regions from a heterogeneous mix of mRNAs from a patient may be amplified by RT-PCR using primers specific for the mRNA transcript of gene PKD1. The PKD1-specific primers and their locations within the nucleotide sequence of a PKD1-specific cDNA are shown in FIGS. 7A-7E, and Table 10 below. Alternatively, genomic DNA isolated, for example, from the whole blood of a patient, may be amplified using the primers, as listed in Table 10 below, specific for the genes PKD2, PKHD1, TSC1, TSC2, PRKCSH, UMOD, NPHP1, NPHP2, NPHP3, NPHP4, and SEC63 that are associated with polycystic syndromes.

The resequencing arrays according to this disclosure encompass one or more chips on which have been spot arrayed oligomers according to the methods of Nimblegen Inc, Madison, Wis. The sequences of the oligomers were derived from the genes PKD1, PKD2, PKHD1, TSC1, TSC2, PRKCSH, UMOD, NPHP1, NPHP2, NPHP3, NPHP4, and SEC63 and are about 25 bases in length. For each nucleotide position of a targeted gene eight oligomers are synthesized and spotted, each oligomer having at position 12 the nucleotide in question. Four of the oligomers are complimentary to the +strand of the gene sequence and differ solely at the base at position 12. Likewise the other four oligomers complement the −strand and also differ at the position 12. Each setoff oligomers/spots advances along the selected gene sequence by one base from the previous oligomer set.

The number of genes that may be included as a set of spots on a chip is, therefore, limited by the size of the spot and the length of the gene sequence covered by a set of oligomers. For example, for a chip capable of accommodating about 48,000 bases per array, one chip may have sufficient capacity to include the genes PKD1, PKD2, UMOD, and PRKCSH and three chips are required to cover all twelve genes of interest. With technology such as, but not limited to, the HD2 chip of Nimbelgen Inc, it is possible to include all twelve genes PKD1, PKD2, PKHD1, TSC1, TSC2, PRKCSH, UMOD, NPHP1, NPHP2, NPHP3, NPHP4, and SEC63.

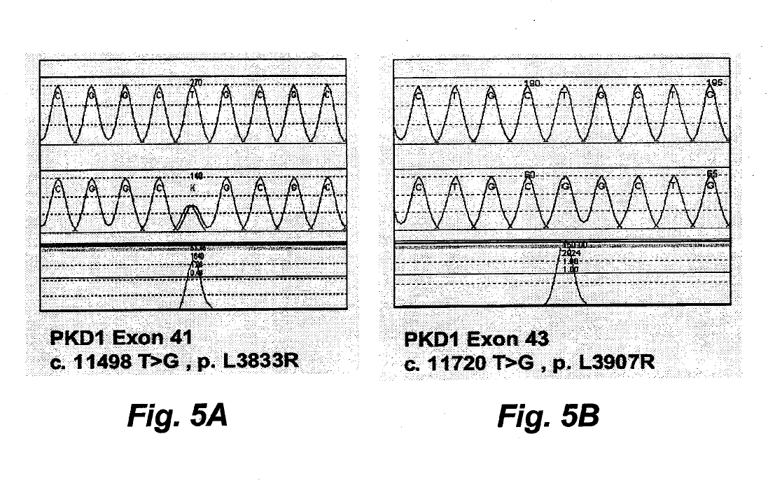

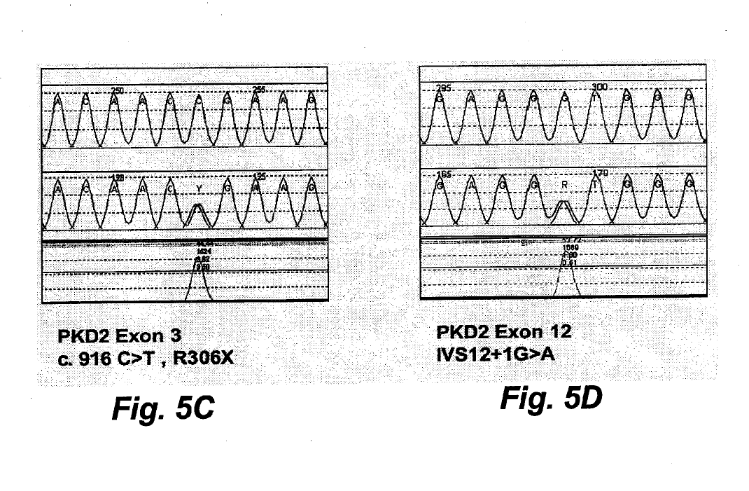

The RT-PCR products from a patient may then be hybridized to the oligomers attached to the array chip and analyzed by known fluorescent methods to determine the location of variation, if any, at a particular nucleotide position. Analysis of the data may be by using, for example, the ABACUS algorithm (Cutler et al., Genome Res. (2001) 11: 1913-1925 incorporated herein by reference in its entirety. Typical data profiles reflecting SNPs in the PDK1 gen, for example, are presented in FIGS. 5A-5D. The analytical methods used in the methods of the disclosure are capable of detecting most if not all sequence variations due to substitutions between a sample nucleic acid from a patient and a reference sequence, and then correlated to the incidence of a polycystic syndrome as described in Examples 1-7, below.

### Comparative Genomic Hybridization (CGH)

In one aspect of the disclosure, compilations, or sets, libraries or collections, of nucleic acids, the arrays and methods of the disclosure incorporate array-based comparative genomic hybridization (CGH) reactions to detect chromosomal abnormalities, e.g., contiguous gene abnormalities, in cell populations, such as tissue, e.g., biopsy or body fluid samples. CGH is a molecular cytogenetics approach that can be used to detect regions in a genome undergoing quantitative changes, e.g., gains or losses of sequence or copy numbers. For example, analysis of genomes of tumor cells or cells from a tissue undergoing polycystitis can detect a region or regions of anomaly under going gains and/or losses.

CGH reactions compare the genetic composition of test versus controls samples; e.g., whether a test sample of genomic DNA (e.g., from a cell population suspected of having one or more subpopulations comprising different, or cumulative, genetic defects) has amplified or deleted or mutated segments, as compared to a “negative” control, e.g., “normal” or “wild type” genotype, or “positive” control, e.g., a known cell or a cell with a known defect, e.g., a translocation or deletion or amplification or the like.

Making and using the compilations, or sets, libraries or collections, of nucleic acids, arrays and practicing the methods of the disclosure can incorporate all known methods and means and variations thereof for carrying out comparative genomic hybridization, see, e.g., U.S. Pat. Nos. 6,197,501; 6,159,685; 5,976,790; 5,965,362; 5,856,097; 5,830,645; 5,721,098; 5,665,549; 5,635,351; and, Diago (2001) American J. Pathol. 158:1623-1631; Theillet (2001) Bull. Cancer 88:261-268; Werner (2001) Pharmacogenomics 2: 25-36; Jain (2000) Pharmacogenomics 1: 289-307.

### Arrays, or “BioChips”

The present disclosure provides arrays, comprising the compilations, or sets, libraries or collections, of nucleic acids of the disclosure. Making and using the compilations, or sets, libraries or collections, of nucleic acids, arrays and practicing the methods of the present disclosure can incorporate any known “array,” also referred to as a “microarray” or “DNA array” or “nucleic acid array” or “biochip,” or variation thereof. Arrays are generically a plurality of “target elements,” or “spots,” each target element comprising a defined amount of one or more biological molecules, e.g., polypeptides, nucleic acid molecules, or probes, immobilized on a defined location on a substrate surface. Typically, the immobilized biological molecules are contacted with a sample for specific binding, e.g., hybridization, between molecules in the sample and the array. Immobilized nucleic acids can contain sequences from specific messages (e.g., as cDNA libraries) or genes (e.g., genomic libraries), including, e.g., substantially all or a subsection of a chromosome or substantially all of a genome, including a human genome. Other target elements can contain reference sequences, such as positive and negative controls, and the like. The target elements of the arrays may be arranged on the substrate surface at different sizes and different densities. Different target elements of the arrays can have the same molecular species, but, at different amounts, densities, sizes, labeled or unlabeled, and the like. The target element sizes and densities will depend upon a number of factors, such as the nature of the label (the immobilized molecule can also be labeled), the substrate support (it is solid, semi-solid, fibrous, capillary or porous), and the like. Each target element may comprise substantially the same nucleic acid sequences, or, a mixture of nucleic acids of different lengths and/or sequences. Thus, for example, a target element may contain more than one copy of a cloned piece of DNA, and each copy may be broken into fragments of different lengths. The length and complexity of the nucleic acid fixed onto the array surface is not critical to the disclosure. The array can comprise nucleic acids immobilized on any substrate, e.g., a solid surface (e.g., nitrocellulose, glass, quartz, fused silica, plastics and the like). See, e.g., U.S. Pat. No. 6,063,338 describing multi-well platforms comprising cycloolefin polymers for when fluorescence is to be measured.

Advantageously for the purposes of the present disclosure the array-forming methods according to Nimbelgene Inc, Madison, Wis. may be used although it is understood that any method known in the art for forming oligonucleotide arrays may be employed herein. In making and using the compilations, or sets, libraries or collections, of nucleic acids, arrays and practicing the methods of the disclosure, known arrays and methods of making and using arrays can be incorporated in whole or in part, or variations thereof, as described, for example, in U.S. Pat. Nos. 6,277,628; 6,277,489; 6,261,776; 6,258,606; 6,054,270; 6,048,695; 6,045,996; 6,022,963; 6,013,440; 5,965,452; 5,959,098; 5,856,174; 5,830,645; 5,770,456; 5,632,957; 5,556,752; 5,143,854; 5,807,522; 5,800,992; 5,744,305; 5,700,637; 5,556,752; 5,434,049; see also, e.g., WO 99/51773; WO 99/09217; WO 97/46313; WO 96/17958; see also, e.g., Johnston (1998) Curr. Biol. 8:R171-R174; Schummer (1997) Biotechniques 23:1087-1092; Kern (1997) Biotechniques 23:120-124; Solinas-Toldo (1997) Genes, Chromosomes & Cancer 20:399-407; Bowtell (1999) Nature Genetics Supp. 21:25-32. See also published U.S. Pat. Application Nos. 20010018642; 20010019827; 20010016322; 20010014449; 20010014448; 20010012537; 20010008765.

In alternative embodiments according to the present disclosure, the compilations, or sets, libraries or collections, of nucleic acids of the disclosure, and the articles of manufacture, such as arrays, of the disclosure, can comprise one, several or all of the nucleic acid segments set forth below in Tables 8 and 9.

### Substrate Surfaces

The compilations, or sets, libraries or collections, of nucleic acids, can be immobilized (directly or indirectly, covalently or by other means) to any substrate surface. The arrays of the disclosure can incorporate any substrate surface, e.g., a substrate means. The substrate surfaces can be of a rigid, semi-rigid or flexible material. The substrate surfaces can be flat or planar, be shaped as wells, raised regions, etched trenches, pores, beads, filaments, or the like. Substrates can be of any material upon which a nucleic acid (e.g., a “capture probe”) can be directly or indirectly bound. For example, suitable materials can include paper, glass (see, e.g., U.S. Pat. No. 5,843,767), ceramics, quartz or other crystalline substrates (e.g., gallium arsenide), metals, metalloids, polacryloylmorpholide, various plastics and plastic copolymers, NYLON™, TEFLON™, polyethylene, polypropylene, poly(4-methylbutene), polystyrene, polystyrene/latex, polymethacrylate, poly(ethylene terephthalate), rayon, nylon, poly(vinyl butyrate), polyvinylidene difluoride (PVDF) (see, e.g., U.S. Pat. No. 6,024,872), silicones (see, e.g., U.S. Pat. No. 6,096,817), polyformaldehyde (see, e.g., U.S. Pat. Nos. 4,355,153; 4,652,613), cellulose (see, e.g., U.S. Pat. No. 5,068,269), cellulose acetate (see, e.g., U.S. Pat. No. 6,048,457), nitrocellulose, various membranes and gels (e.g., silica aerogels, see, e.g., U.S. Pat. No. 5,795,557), paramagnetic or superparamagnetic microparticles (see, e.g., U.S. Pat. No. 5,939,261) and the like. Reactive functional groups can be, e.g., hydroxyl, carboxyl, amino groups or the like. Silane (e.g., mono- and dihydroxyalkylsilanes, aminoalkyltrialkoxysilanes, 3-aminopropyl-triethoxysilane, 3-aminopropyltrimethoxysilane) can provide a hydroxyl functional group for reaction with an amine functional group.

### Nucleic Acids and Detectable Moieties: Incorporating Labels and Scanning Arrays

In making and using the compilations, or sets, libraries or collections, of nucleic acids and arrays and practicing the methods of the disclosure, nucleic acids associated with a detectable label can be used. The detectable label can be incorporated into, associated with or conjugated to a nucleic acid. Any detectable moiety can be used. The association with the detectable moiety can be covalent or non-covalent. In another aspect, the array-immobilized nucleic acids and sample nucleic acids are differentially detectable, e.g., they have different labels and emit difference signals.

Useful labels include, e.g., ³²P, ³⁵S, ³H, ¹⁴C, ¹²⁵I, ¹³¹I; fluorescent dyes (e.g., Cy5™, Cy3™, FITC, rhodamine, lanthanide phosphors, Texas red, electron-dense reagents (e.g., gold), enzymes, e.g., as commonly used in an ELISA (e.g., horseradish peroxidase, (β-galactosidase, luciferase, alkaline phosphatase), colorimetric labels (e.g., colloidal gold), magnetic labels (e.g., DYNABEADS™), biotin, dioxigenin, or haptens and proteins for which antisera or monoclonal antibodies are available. The label can be directly incorporated into the nucleic acid to be detected, or it can be attached to a probe or antibody that hybridizes or binds to the target. In array-based CGH, fluors can be paired together; for example, one fluor labeling the control (e.g., the “nucleic acid of “known, or normal, karyotype”) and another fluor the test nucleic acid (e.g., from a polycystic liver or kidney sample or a cancer cell sample). Exemplary pairs are: rhodamine and fluorescein (see, e.g., DeRisi (1996) Nature Genetics 14:458-460); lissamine-conjugated nucleic acid analogs and fluorescein-conjugated nucleotide analogs (see, e.g., Shalon (1996) supra); SPECTRUM RED™ and SPECTRUM GREEN™ (Vysis, Downers Grove, Ill.); Cy3™ and Cy5™. Cy3™ and Cy5™ can be used together; both are fluorescent cyanine dyes produced by Amersham Life Sciences (Arlington Heights, Ill.). Cyanine and related dyes, such as merocyanine, styryl and oxonol dyes, are particularly strongly light-absorbing and highly luminescent, see, e.g., U.S. Pat. Nos. 4,337,063; 4,404,289; and 6,048,982.

Other fluorescent nucleotide analogs can be used, see, e.g., Jameson (1997) Methods Enzymol. 278:363-390; Zhu (1994) Nuc. Acids Res. 22:3418-3422. U.S. Pat. Nos. 5,652,099 and 6,268,132 also describe nucleoside analogs for incorporation into nucleic acids, e.g., DNA and/or RNA, or oligonucleotides, via either enzymatic or chemical synthesis to produce fluorescent oligonucleotides. U.S. Pat. No. 5,135,717 describes phthalocyanine and tetrabenztriazaporphyrin reagents for use as fluorescent labels.

Detectable moieties can be incorporated into sample genomic nucleic acid and, if desired, any member of the compilation of nucleic acids or array-immobilized nucleic acids, by covalent or non-covalent means, e.g., by transcription, such as by random-primer labeling using Klenow polymerase, or “nick translation,” or, amplification, or equivalent. For example, in one aspect, a nucleoside base is conjugated to a detectable moiety, such as a fluorescent dye, e.g., Cy3™ or Cy5™, and then incorporated into a sample genomic nucleic acid. Samples of genomic DNA can be incorporated with Cy3™ or Cy5™-dCTP conjugates mixed with unlabeled dCTP. Cy5™ is typically excited by the 633 nm line of HeNe laser, and emission is collected at 680 nm. See also, e.g., Bartosiewicz (2000) Archives Biochem. Biophysics 376:66-73; Schena (1996) Proc. Natl. Acad. Sci. USA 93:10614-10619; Pinkel (1998) Nature Genetics 20:207-211; Pollack (1999) Nature Genetics 23:41-46.

In another aspect, when using PCR or nick translation to label nucleic acids, modified nucleotides synthesized by coupling allylamine-dUTP to the succinimidyl-ester derivatives of the fluorescent dyes or haptenes (such as biotin or digoxigenin) are used; this method allows custom preparation of most common fluorescent nucleotides, see, e.g., Henegariu (2000) Nat. Biotechnol. 18:345-348.

In the compilation of nucleic acids, arrays and methods of the disclosure, labeling with a detectable composition (labeling with a detectable moiety) also can include a nucleic acid attached to another biological molecule, such as a nucleic acid, e.g., a nucleic acid in the form of a stem-loop structure as a “molecular beacon” or an “aptamer beacon.” Molecular beacons as detectable moieties are well known in the art; for example, Sokol (1998) Proc. Natl. Acad. Sci. USA 95:11538-11543, synthesized “molecular beacon” reporter oligodeoxynucleotides with matched fluorescent donor and acceptor chromophores on their 5′ and 3′ ends. In the absence of a complementary nucleic acid strand, the molecular beacon remains in a stem-loop conformation where fluorescence resonance energy transfer prevents signal emission. On hybridization with a complementary sequence, the stem-loop structure opens increasing the physical distance between the donor and acceptor moieties thereby reducing fluorescence resonance energy transfer and allowing a detectable signal to be emitted when the beacon is excited by light of the appropriate wavelength. See also, e.g., Antony (2001) Biochemistry 40:9387-9395, describing a molecular beacon comprised of a G-rich 18-mer triplex forming oligodeoxyribonucleotide. See also U.S. Pat. Nos. 6,277,581 and 6,235,504.

Aptamer beacons are similar to molecular beacons; see, e.g., Hamaguchi (2001) Anal. Biochem. 294:126-131; Poddar (2001) Mol. Cell. Probes 15:161-167; Kaboev (2000) Nucleic Acids Res. 28:E94. Aptamer beacons can adopt two or more conformations, one of which allows ligand binding. A fluorescence-quenching pair is used to report changes in conformation induced by ligand binding. See also, e.g., Yamamoto (2000) Genes Cells 5:389-396; Smimov (2000) Biochemistry 39:1462-1468.

### Detecting Dyes and Fluors

In addition to labeling nucleic acids with fluorescent dyes, the disclosure can be practiced using any apparatus or methods to detect “detectable labels” of a sample nucleic acid, a member of the compilation of nucleic acids, or an array-immobilized nucleic acid, or, any apparatus or methods to detect nucleic acids specifically hybridized to each other. In one aspect, devices and methods for the simultaneous detection of multiple fluorophores are used; they are well known in the art, see, e.g., U.S. Pat. Nos. 5,539,517; 6,049,380; 6,054,279; 6,055,325; and 6,294,331. Any known device or method, or variation thereof, can be used or adapted to practice the methods of the disclosure, including array reading or “scanning” devices, such as scanning and analyzing multicolor fluorescence images; see, e.g., U.S. Pat. Nos. 6,294,331; 6,261,776; 6,252,664; 6,191,425; 6,143,495; 6,140,044; 6,066,459; 5,943,129; 5,922,617; 5,880,473; and 5,846,708; 5,790,727; and, the patents cited in the discussion of arrays, herein. See also published U.S. patent applications Nos. 20010018514; and 20010007747; published international patent applications Nos. WO0146467 A; WO9960163 A; WO0009650 A; WO0026412 A; WO0042222 A; WO0047600 A; and WO0101144 A.

For example a spectrograph can image an emission spectrum onto a two-dimensional array of light detectors; a full spectrally resolved image of the array is thus obtained. Photophysics of the fluorophore, e.g., fluorescence quantum yield and photodestruction yield, and the sensitivity of the detector are read time parameters for an oligonucleotide array. With sufficient laser power and use of Cy5™ and/or Cy3™, which have lower photodestruction yields an array can be read in less than 5 seconds.

When using two or more fluors together (e.g., as in a CGH), such as Cy3™ and Cy5™, it is necessary to create a composite image of all the fluors. To acquire the two or more images, the array can be scanned either simultaneously or sequentially. Charge-coupled devices, or CCDs, are used in microarray scanning systems, including practicing the methods of the disclosure. Thus, CCDs used in the methods of the disclosure can scan and analyze multicolor fluorescence images. Color discrimination can also be based on 3-color CCD video images; these can be performed by measuring hue values. Hue values are introduced to specify colors numerically. Calculation is based on intensities of red, green and blue light (RGB) as recorded by the separate channels of the camera. The formulation used for transforming the RGB values into hue, however, simplifies the data and does not make reference to the true physical properties of light. Alternatively, spectral imaging can be used; it analyzes light as the intensity per wavelength, which is the only quantity by which to describe the color of light correctly. In addition, spectral imaging can provide spatial data, because it contains spectral information for every pixel in the image. Alternatively, a spectral image can be made using brightfield microscopy, see, e.g., U.S. Pat. No. 6,294,331.

### Data Analysis

The methods of the disclosure further comprise data analysis, which can include the steps of determining, e.g., fluorescent intensity as a function of substrate position, removing “outliers” (data deviating from a predetermined statistical distribution), or calculating the relative binding affinity of the targets from the remaining data. The resulting data can be displayed as an image with color in each region varying according to the light emission or binding affinity between targets and probes. See, e.g., U.S. Pat. Nos. 5,324,633; 5,863,504; and 6,045,996. The disclosure can also incorporate a device for detecting a labeled marker on a sample located on a support, see, e.g., U.S. Pat. No. 5,578,832.

High throughput screening with direct sequencing of the polycystic kidney 1 (PKD1) gene demonstrates significant sequence variation. In a well-defined dataset of 242 ADPKD individuals, 190 unique polymorphisms that are not disease causing have been identified. Of these, 13 occur in >10% of individuals. Data regarding the haplotypes or Tagsnps of introns and exons provide important prognostic information in the PKD1 gene. Intronic polymorphisms in the 22^{nd} intron of PKD1 are demonstrated to be associated with disease severity in ADPKD, defined as renal and cyst volume measured by MR after adjusting for age, gender, race, hypertension, and number of SNPs analyzed. Additional details are provided in the Examples.

As mentioned above, embodiments of the present disclosure include methods for screening a host for the mutation responsible for a polycystic disease, especially of the liver or kidney, and most advantageously for ADPKD. For example, a host can be screened for ADPKD by providing a genetic sample (DNA) in the form of saliva, serum, urine or other appropriate DNA-containing sample. In an embodiment, an array or other screening technique can also be used to detect if the DNA sample includes a polynucleotide sequence having intronic, exonic or promoter variation such as described in the 22^{nd} intron of PKD1. The intronic variation can be described as a change in basepair. The detection of intronic variation is an indication of increased disease severity in ADPKD, defined as renal and cyst volume measured by MR after adjusting for age, gender, race, hypertension, and number of SNPs analyzed. Therefore, genetic information regarding disease severity can be used to provide guidance for choosing specific and/or appropriate treatment options and in weighing considerations for other medical care. It should be noted that individuals that have ADPKD or have a family history of ADPKD can then be screened to identify the mutations responsible for this disorder, and to determine the potential genetic contributions to determining the severity of ADPKD in that individual. Additional details are provided in the Examples below.

The present disclosure, therefore, encompass resequencing arrays for identifying inherited cystic diseases. In particular, the resequencing and comparative genomic hybridization arrays may encompass a plurality of unique polynucleotide sequences for one or more of the following genes: polycystic kidney disease 1 (PKD1), polycystic kidney disease 2 (PKD2), polycystic kidney and hepatic disease 1, tuberous sclerosis 1, tuberous sclerosis 2, nephronophthisis 1, nephronophthisis 2, nephronophthisis 3, nephronophthisis 4, medullary cystic kidney disease type 1, medullary cystic kidney disease type 2, and autosomal dominant inherited polycystic liver disease. The unique polynucleotide sequences allow identification of one or more of the following features: SNPs, deletions, duplications, mutations, unstable repeats, and the like. The identifcation of one or more of the features of one or more of the genes mentioned above can be used to determine if a host has autosomal dominant polycystic kidney disease, other cystic diseases, what the severity of the autosomal dominant polycystic kidney disease is, treatment options for the host having autosomal dominant polycystic kidney disease, the determination of renal donor eligibility, family planning, paternity, affectation status of a variety of cystic disorders, and the like.

The unique polynucleotide sequences can be determined for each genomic region of interest (e.g., regions associated with the genes mentioned above) and downloaded from the UCSC genome browser. The sequences of the regions of interest are then provided to Nimblegen Systems Inc. for synthesis of a resequencing array, where the array includes a plurality of unique polynucleotide sequences for each gene described above. Current Nimblegen Systems Inc. arrays can resequence between 45 kb and 300 kb, depending upon the feature density.

One aspect of the disclosure encompasses arrays for the detection of genetic variation associated with a polycystic disease or a plurality of polycystic diseases comprising: a plurality of nucleic acid segments, wherein each nucleic acid segment is immobilized to a discrete and known spot on a substrate surface to form an array of nucleic acids, and each spot comprises a segment of a nucleic acid sequence associated with a polycystic disease, wherein the unique polynucleotide sequences allow identification of one or more of the following: SNPs, deletions, duplications, and mutations.

In embodiments of this aspect of the disclosure, the nucleic acid sequences associated with a polycystic disease are derived from human genes selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease).

In one embodiment of the disclosure, the nucleic acid sequences associated with a polycystic disease are selected from the group consisting of PKD1 (GenBank Accession No: NM001009944), PKD2 (GenBank Accession No: NM000297), PKHD1 (GenBank Accession No: NM138694), TSC1 (GenBank Accession No: NM000368), TSC2 (GenBank Accession No: NM000548), PRKCSH (GenBank Accession No: NM002743), UMOD (GenBank Accession No: NM003361), NPHP1 (GenBank Accession No: NM000272), NPHP2 (GenBank Accession No: NM014425), NPHP3 (GenBank Accession No: NM153240), NPHP4 (GenBank Accession No: 015102), and SEC63 (GenBank Accession No: NM007214).

In one embodiment of the disclosure, the nucleic acid segments are derived from the nucleic acid sequences shown in Table 8 or Table 9 below. In one embodiment, the nucleic acid segments are derived from the nucleic acid sequences shown in Table 8. In another embodiment, the nucleic acid segments are derived from the nucleic acid sequences shown in Table 9.

In various embodiments of the disclosure, the nucleic acid segments on the array are between about 20 and about 80 nucleotides in length.

Embodiments of the disclosure may include nucleic acid segments associated with PKD1 derived from the cDNA sequence having GenBank Accession No: NM001009944.

In the embodiments of the disclosure, the array(s) may have nucleic acid segments derived from a plurality of genes associated with polycystic diseases, and wherein the genes are selected from the group consisting of PKD1, PKD2, PKHD1, TSC1, TSC2, PRKCSH, UMOD, NPHP1, NPHP2, NPHP3, NPHP4, and SEC63.

In some embodiments, the plurality of genes comprises the group PKD1, PKD2, PRKCSH, and UMOD.

In embodiments of the disclosure, the array may be distributed on a single substrate surface.

In the embodiments, at least one nucleic acid spot may comprise a nucleic acid segment acting as a negative control, and wherein the array-immobilized genomic nucleic acid segments in a first spot are non-overlapping in sequence compared to the array-immobilized genomic nucleic acid segments in a second spot.

In other embodiments, the array-immobilized genomic nucleic acid segments in the first spot are non-overlapping in sequence compared to the array-immobilized genomic nucleic acid segments in all other genomic nucleic acid-comprising spots on the array. In some embodiments, at least one genomic nucleic acid segment may be spotted in duplicate or triplicate on the array. In one embodiment, in the array the duplicate spot or triplicate spot has a different amount of nucleic acid segments immobilized. In embodiments of the disclosure, all the genomic nucleic acid segments are spotted in duplicate or triplicate on the array. In one embodiment, at least 95% of the array-immobilized genomic nucleic acid segments comprise a label.

Another aspect of the disclosure are methods for screening a host for at polycystic disease, comprising: detecting a polynucleotide sequence having intronic and/or exonic variation a gene associated with a polycystic disease comprising contacting a nucleic acid sample isolated from a patient with an array of nucleic acids derived from a plurality of genes associated with a polycytic disease, wherein the plurality of genes are selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease). In embodiments of this aspect of the disclosure, the methods may comprise isolating a nucleic acid from a patient, synthesizing a cDNA using the isolated nucleic acid, hybridizing the cDNA to a resequencing array comprising fragments of a plurality of genes associated with polycystic diseases, identifying variations in the sequences of the cDNAs compared to the sequences of the corresponding genes attached to the array, and determining if the sequence variations are correlated to a polycystic disease, thereby identifying the patient as either having the disease or capable of having the disease.

In embodiments of the methods of the disclosure, the methods may further comprise amplifying regions of a nucleic acid sample from a patient, hybridizing the amplified nucleic acid to an array comprising a plurality of nucleotide regions of a plurality of target genes associated with at least one polycystic disease, and identifying whether the nucleic acid of the patient has an insertion or deletion within at least one of the target genes when compared to the target genes of the array, thereby determining if the sequence variations are correlated to a polycystic disease, thereby identifying the patient as either having the disease or capable of having the disease

In one embodiment of the invention, the method encompasses detection of the variation in the 22^{nd} intron of PKD1 in a biological sample from a host indicates disease severity in ADPKD, wherein disease severity is defined as renal and cyst volume measured by MR after adjusting for age, gender, race, hypertension, and number of SNPs analyzed.

In the embodiments of the methods of this aspect of the disclosure, the host is a human embryo, a human fetus, a human newborn, a human infant, or a human adult.

Another aspect of the disclosure encompasses kits for detecting a genetic variation in a gene associated with a polycystic disease comprising a resequencing array for detecting a polymorphism in a nucleic acid sequence associated with a polycystic disease are derived from human genes selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease), and instructions for the use thereof.

The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

### EXAMPLES

### Example 1

COHORT Study: The COHORT study was an ongoing prospective observational study of ADPKD individuals not yet on dialysis. Recruitment goals were to include multiple affected and unaffected family members from 300 different families. Affected individuals not yet on dialysis would be studied in standardized fashion annually over 7 years. The subjects were recruited from referring physicians, local advertisements, contact with the local Friend's Groups of the Polycystic Kidney Disease Foundation, and the national Polycystic Kidney Disease Foundation. ADPKD subjects of any age, not yet on dialysis were eligible for enrollment if they have ADPKD based on the criteria of Ravine et al. Subjects were ineligible to participate if they had undergone renal surgery, were unable to undergo MRI, had other systemic diseases, and/or were pregnant or less than six months post-partum. In addition, those deemed unable to complete the consent process or reliably participate were excluded.

This population was closely representative of the general ADPKD population and other studied ADPKD populations. There was potential study population bias in the COHORT study in that phenotyped individuals might not have been entered ESRD. However, complete pedigrees, as shown in Table 1, medical history data and blood for genetic studies were obtained on all available individuals regardless of ESRD status. Formal pedigrees were developed and the proband (CYRILLIC database) in each family was identified. The proband was defined as the first individual identified by the investigator from each identified family, and was initially invited to participate in COHORT. If the proband was not available for study then the next known available family member who was able to participate is then enrolled.

All subjects underwent standardized measurements of weight, height and blood pressure. Subjects collected two sequential 24-hour urine samples for the determination of creatinine, electrolyte and albumin excretions. Blood samples were obtained for the determination of serum creatinine, electrolyte concentrations and for lymphoblastoid transformation. Serum creatinine was used for the estimation of GFR and formed the basis of the second quantified disease severity/trait to be studied in this application. I¹²⁵ renal clearances of iothalamate were performed.

Subjects underwent extensive questionnaires related to quality of life and dietary intake. All subjects underwent, at their first visit only, a standardized MR imaging protocol.

Renal volume was measured from T1 and T2-weighted images using thresholding methodologies. This value was used to determine renal volume and formed the basis of the first quantified disease severity/trait to be studied in this application. These methods yielded reliable and accurate volumetric measurements and were validated using MR-acquired images in a variety of different organs. In addition, these measures were similar to the measures performed in the CRISP and HALT Clinical Trials Network (see below) and to the standardized measures performed in other MR-based imaging protocols of ADPKD individuals.

Subjects were studied annually in identical fashion with the exception of MR imaging. The COHORT population provided the most extensive phenotypic information available, using the most accurate and reliable measures of renal volume and function (unlike any other ADPKD population) early in ADPKD. This was an ideal study population to determine the variables that significantly contribute a disease trait of interest because they were a patient population with all ranges of renal function, followed in a prospective, observational fashion without intervention. This well studied population allowed us to find and identify the genetic contributions to disease severity in this disorder.

For the study, 206 unrelated affected individuals had been comprehensively studied. Within these 206 families, 148 same-sex sib-pairs and 134 differing-sex sib-pairs were available for study. Of these sib-pairs, 32 same-sex and 20 differing-sex sib-pairs had been completely phenotyped. In addition there were 150 available complete triads to study within these 206 families. Of the 150 available triads, 49 were studied where the parent and offspring had been completely phenotyped and blood had been obtained on every individual. These individuals were available for family based testing of genetic contributions to disease severity that would be helpful in confirming or refuting the results. One hundred and ninety-two (192) of these individuals under went complete sequencing of their PKD2 promoter and gene. Clinical characteristics of the 192 participants are shown in Table 2 below. In this table are the proposed HALT study participant characteristics:

TABLE 1
Characteristics of 192 unrelated COHORT participants stratified
by race and the proposed HALT study population

| | | COHORT | COHORT | |
|---|---|---|---|---|
| | | Non-African | African | |
| | COHORT | Americans | Americans- | HALT |
| Variable | (192) | (174) | (18) | (315) |
| Gender | | | | |
| Female | 120 (62%) | 69 (39.4%) | 4 (22.2%) | Anticipated |
| Male | 73 (38%) | 106 (60.6%) | 14 (77.8%) | 50%:50% |
| Race | | | | |
| Non-African American | 175 (90%) | NA | NA | Anticipated |
| African-American | 18 (10%) | | | 87%:13% |
| Age Range | | | | |
| (years) | 4-73 | 4-73 | 11-58 | 15-50 |
| Age | | | | |
| (years ± s.d.) | 42.37 ± 11.21 | 42.7 ± 11.2 | 39.7 ± 11.0 | Unknown |
| Mean Age | | | | |
| D x PKD (yrs ± S.D.) | 31.55 ± 10.59 | 31.5 ± 10.5 | 32.1 ± 11.5 | Unknown |
| Mean Age | | | | |
| Dx HBP(yrs ± S.D.) | 33.91 ± 9.43 | 34.1 ± 9.7 | 31.7 ± 6.8 | Unknown |
| Hypertensive | 148 (77%) | 134 (77%) | 14 (78%) | 100% |
| Normotensive | 44 (23%) | 40 (23%) | 4 (22%) | |
| SBP | | | | |
| mm Hg | 128.57 ± 12.75 | 128.3 ± 12.3 | 131.2 ± 16.8 | NA |
| DBP | | | | |
| mm Hg | 82.27 ± 9.42 | 81.9 ± 9.2 | 85.7 ± 11.4 | NA |
| MAP | | | | |
| mm Hg | 97.70 ± 9.72 | 97.4 ± 9.5 | 100.9 ± 11.8 | NA |
| Serum Creatinine | | | | |
| mg/dL | 1.6 ± 1.1 | 1.5 ± 1.1 | 1.8 ± 1.6 | NA |
| GFR | | | | |
| (ml/min/1.73 m²) | 68.3 ± 33.3 | 68.0 ± 33.1 | 71.2 ± 35.7 | >30 |
| Mean Renal Volume | 991.0 ± 979.40 | 1008.9 ± 1009.5 | 815.6 ± 602.0 | Unknown |
| Median | 758.7 | 770.0 | 624.9 | |
| Urinary Albumin Excretion | 98.2 ± 241.0 | 102.6 ± 251.8 | 56.2 ± 79.8 | Unknown |
| Median | 32.4 | 32.4 | 34.2 | |
| Reason for PKD Dx | | | | |
| Asymptomatic/Screening | 44% | 76 (43.4%) | 9 (50.0%) | Unknown |
| Method of PKD Dx | | | | |
| Ultrasound | 61% | 108 (61.7%) | 10 (55.6%) | Unknown |

### Example 2

### “Clinical” Predictors of Disease Severity in the Cohort Study

Those variables that independently contribute to serum creatinine estimates of GFR and mean renal volume were identified in the 192 unrelated ADPKD participants in COHORT (SAS System Version 8) using CORR, REG, and GENMOD procedures. Associations of categorical measures were tested by Chi-square, ANOVA, and two-tailed Student's t-test analyses, with a p-value<0.05 considered to be significant. Pearson correlation was used to examine the association between interval variables. Pair-wise Scheffée comparisons of means across risk strata for variables with a statistically significant overall F test were performed. Multivariate linear regression analyses were conducted to examine which factors contributed to the serum creatinine estimate of GFR. All linear models initially included age, PKD1 vs. PKD2 genotype, gender, race, age of diagnosis of ADPKD, history of gross hematuria, history of urinary tract infection, pregnancy number, weight, BMI, body surface area, systolic, diastolic and mean arterial blood pressure level, hypertension status, urinary albumin, sodium and potassium excretion, and dietary protein intake (measured by 24 hour urinary urea excretion) as potential covariates. A backwards elimination strategy was used to arrive at the most parsimonious predictive model. Covariate interaction terms were considered. The model best predicting serum creatinine estimate of GFR in the 192 COHORT participants is shown in Table 2:

TABLE 2
Clinical and biochemical variables that independently
contribute to the variability of serum creatinine estimate
of GFR in 192 unrelated ADPKD individuals.

| Variable | Parameter Estimate | T Value | P value |
|---|---|---|---|
| Age | −1.27 | −7.23 | <0.0001 |
| Mean Renal Volume | −31.9 | −4.02 | <0.0001 |
| Hypertension | −11.6 | −2.23 | <0.03 |
| Urinary Albumin Excretion | −12.1 | −3.34 | <0.001 |

Thirty four percent of the variability of serum creatinine estimates of GFR was accounted for in this model. Renal volume and hypertension were two important independent contributors to the variability of serum creatinine estimates of GFR as has been shown by others. Given that hypertension contributes significantly to the variability of serum creatinine estimates of GFR indicated that non-PKD related modifying genes may contribute to disease severity in ADPKD.

An identical analysis was conducted to determine the variables that contribute to the variability of the measurement of mean renal volume. The model best predicting renal volume in the 192 COHORT participants is shown in Table 3.

TABLE 3
Variables that independently contribute to the variability
of total renal volume in 192 unrelated ADPKD individuals

| Variable | Parameter Estimate | T Value | P value |
|---|---|---|---|
| Serum creatinine estimate of | −12.88 | −3.39 | <0.0002 |
| GFR | | | |
| ADPKD genotype | −9.18 | 1.86 | <0.02 |
| Gender | −3.96 | −2.80 | <0.0005 |
| Urinary Albumin excretion | −1.95 | −3.6 | <0.006 |

Sixty-three percent of the variability of mean renal volume was accounted for in this model indicating that renal volume may be a more stable and reliable measure of disease severity in ADPKD. Importantly, PKD genotype contributed significantly to the variability of the measurement of renal volume.

The relative contribution of PKD1 vs. PKD2 to renal disease severity in PKD1 and PKD2 subjects is defined as renal volume and serum creatinine estimate of GFR.

### Example 3

Sequencing of the PKD2 gene and its promoter was been completed and analyzed, and variants were verified in 192 unrelated ADPKD individuals from the COHORT study. Nineteen PKD2 families were identified (10%) consistent with the published frequencies of PKD2 vs. PKD1. The 173 unrelated individuals not demonstrating mutations in the PKD2 gene were designated as PKD1 individuals. Demographic, clinical and radiological characteristics of PKD1 and PKD2 subjects are shown in Table 4.

TABLE 4
Characteristics of PKD1 (n = 173) and PKD2 (n = 19)
Subjects in the COHORT study:

| | PKD1 subjects | PKD2 subjects | |
|---|---|---|---|
| Variable | (n = 173) | (n = 19) | P value |
| Age | | | |
| (yrs) | 43.9 ± 10.8 | 46.7 ± 11.7 | NS |
| Gender | | | |
| (M:F) | 49:66 | 9:10 | NS |
| Weight | | | |
| (kgs) | 80.7 ± 19.6 | 79.3 ± 21.2 | NS |
| Age diagnosis PKD | | | |
| (yrs) | 32.9 ± 10.5 | 39.2 ± 9.6 | 0.02 |
| Hypertension | | | |
| (%) | 85 | 72 | NS (0.10) |
| Age of diagnosis HBP | | | |
| (yrs) | 35.2 ± 9.1 | 36.1 ± 11.1 | NS |
| GFR | 63.8 ± 31.9 | 63.5 ± 31.9 | NS |
| Mean Renal Vol (mls) | 1029 ± 834 | 1308 ± 1923 | NS |
| Median Renal Vol (mls) | 808 | 612 | NS |
| Urinary albumin | | | |
| (mg/day) | 72.3 ± 129.8 | 185.4 ± 346.9 | NS |
| Log10 Albumin | 1.5 ± 0.6 | 1.6 ± 0.8 | NS |

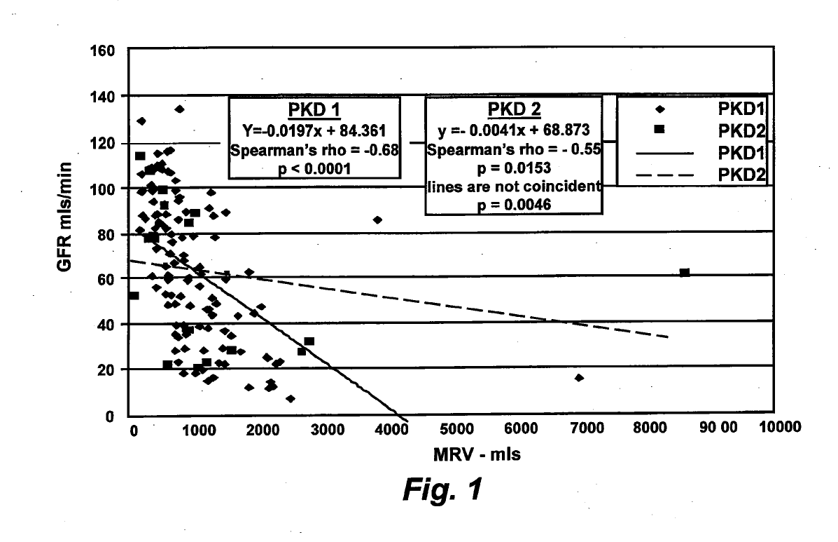

Age and renal volume relationships were similar between PKD1 and PKD2 individuals, however structure-function relationships (serum creatinine estimate of GFR vs. renal volume) differed significantly between PKD1 and PKD2 individuals, as shown in FIG. 1

Significant differences in renal volume and the relationship between renal volume and renal function between PKD1 and PKD2 individuals could be detected, indicating that genetic regulation of renal enlargement differs between PKD1 and PKD2 individuals in ADPKD.

### Example 4

### Mutations Identified in PKD2 Patients in the Cohort Study

The mutations found in the PKD2 individuals included nonsense, missense, insertions, deletions and splice site mutations, as shown in Table 5. Fifteen mutations were found in 19 families. Amino acid changes and splice site disruptions were predicted. The same mutation was present and confirmed in every affected family member and was not present in unaffected or unrelated family members, segregating with disease. The frequencies of the different types (nonsense vs. missense vs. insertion/deletion vs. splicing) are consistent with other mendellian disorders.

TABLE 5
PKD2 mutations identified in the cohort population

| | | | |
|---|---|---|---|
| | | | Previously identified |
| Name | Location | Nucleotide Change | mutations |

Nonsense

| | | | |
|---|---|---|---|
| S81X | E1 | C242A | |
| R306X | E4 | C916T | yes |
| R845X | E14 | C2599T | yes |
| R872X | E14 | C2614T | yes |

Missense

| | | |
|---|---|---|
| T265M | E3 | C794T |
| R325Q | E4 | G974A |
| M675K | E10 | T2024A |

Insertion/deletion

| | | | |
|---|---|---|---|
| 424-428delG | E1c | DelG at 424-428 | |
| 1481-1483delA | E6 | DelA at 1481-1483 | |
| 2152-2159insA | E11 | InsA at 2152-2159 | yes |
| 2152-2159delA | E11 | DelA at 2152-2159 | yes |
| 2498delG | E13 | DelG at 2498 | |

Splicing

| | | | |
|---|---|---|---|
| 1319 + 1G > A | IVS5 | G > A at 1319 + 1, | yes |
| | | alters 5′ splice donor | |
| | | consensus sequence | |
| 2019 + 1G > A | ISV9 | G > A at 2019 + 1, | |
| | | alters 5′ splice donor | |
| | | consensus sequence | |
| 2358 + 1G > A | ISV12 | G > A at 2358 + 1, | |
| | | alters 5′ splice donor | |
| | | consensus sequence | |

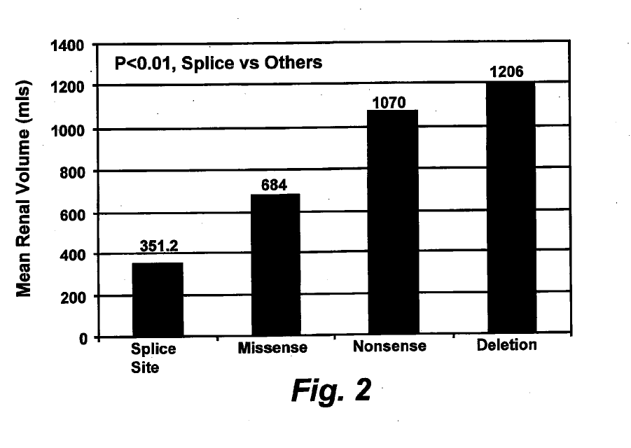

Identified PKD2 individuals were compared with regard to age, gender and renal volume based on the type of mutation identified (Table 6, FIG. 2).

TABLE 6
The relationship of mutation type and serum creatinine
estimates of GFR and renal volume in PKD2 subjects

| | Age | | MRV mean ± SD | Serum creatinine |
|---|---|---|---|---|
| Group | (mean ± SD) | Gender (%) | median | estimate of GFR |
| All | 38.32 ± 15.16 | Male 55 | 1073.57 ± 1739.17 | 81.79 ± 38.22 |
| | | Female 45 | 428.91 | |
| Splice | 44.83 ± 12.91 | Male 20 | 351.80 ± 206.16 | 71.05 ± 33.45 |
| | | Female 80 | 349.37 ** | |
| Nonsense | 37.78 ± 16.44 | Male 73 | 1070.13 ± 1060.79 | 75.05 ± 42.68 |
| | | Female 27 | 943.77 | |
| Missense | 41.50 ± 3.42 | Male 50 | 683.92 ± 390.88 | 81.04 ± 37.79 |
| | | Female 50 | 655.45 | |
| Deletion | 37.67 ± 17.25 | Male 33 | 1206.03 ± 2380.13 | 87.10 ± 37.47 |
| | | Female 67 | 978.84 | |

** P < 0.001, splices mutation vs. all others.

Gender distribution and serum creatinine estimates of GFR did not differ based on mutation type. However, those with splicing mutations were older and demonstrated significantly smaller renal volumes than the other mutation groups. Therefore in ADPKD, a hereditary disorder where age contributes significantly to disease progression, disease severity is minimized in those individuals with splicing mutations.

To determine if mutation location associates with disease severity in PKD2 individuals, nucleotide position of the identified mutations were grouped into two halves (<1,400 and >1,400 nucleotide position) of the open reading frame. Given that those with splicing mutations demonstrated significantly smaller renal volumes, they were excluded from this analysis. Serum creatinine estimates of GFR, age and gender distribution were similar between groups based on mutation location, however renal volume was significantly smaller in the more distal 3′ or >1400 nucleotide position (381 mls) compared to the 5′ end of the gene (1081 mls, P<0.005).

Mutation type and location of PKD2 contributes to measures of disease severity as defined by renal volume. These findings differ from studies attempting to determine if mutation type or location contributes to disease severity defined by age of entry into ESRD or serum creatinine concentrations>5 mg/dl in a much larger population of PKD2 individuals. These findings indicate that measures of disease severity earlier in the course of ADPKD (renal volume) that were more reliable than serum creatinine or serum creatinine estimates (supported by the lack of association with serum creatinine estimates) were important for identifying true genetic contributions to disease severity.

### Example 5

### SNP's identified in the promoter and PKD2 gene in PKD2 patients in the Cohort Study

Sequence variants (SNPs) that were not segregating with disease were Identified in the coding regions and the promoters of the PKD2 gene in PKD2 and PKD1 individuals. Fifty unrelated control subjects also underwent sequencing of the PKD2 gene and its promoter to determine the relative frequency of these polymorphisms in the general population. Each sequence variation was verified, and was also evaluated in other known affected individuals within each family to assure that it did not segregate with disease.

TABLE 7
Identification of sequence variants
(SNPs) in the PKD2 gene and promoter

| | Allele | Allele | Allele | |
|---|---|---|---|---|
| Variants: | Frequency | Frequency | Frequency | Hardy- |
| (Nucleotide | PKD2 | PKD1 | Controls | Weinberg |
| position) | (n = 19) | (n = 173) | (n = 50) | Equilibrium |
| 1-487C > T | 66:34 | 68:32 | 74:26 | Yes |
| promoter | | | | |
| 1-83G > C | 97:03 | 97:03 | 98:02 | No |
| promoter | | | | |
| G83C | 66:34 | 69:31 | 74:26 | Yes |
| Exon 1 | | | | |
| G420A | 97:03 | 94:06 | 92:08 | Yes |
| Exon 1 | | | | |
| G568 A | 100:00 | 99:01 | 98:02 | Yes |
| Exon 1 | | | | |
| IVS2 775-10 T > G | 100:00 | 99:01 | 100:00 | N/A |
| IVS3, 844-22 G > A | 34:66 | 43:57 | 53:47 | Yes |
| A1358G | 100:00 | 98:02 | 100:00 | N/A |
| G1830A | 100:00 | 99:01 | 100:00 | N/A |
| Exon 8 | | | | |
| A2814G | 100:00 | 99:01 | 100:00 | N/A |
| Exon 15 | | | | |
| T2133C | 100:00 | 99:01 | 100:00 | N/A |
| A2097C | 100:00 | 99:01 | 100:00 | N/A |
| A2814G | | | | |

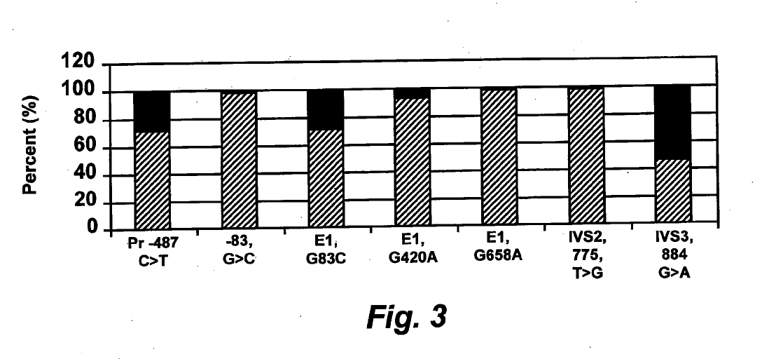

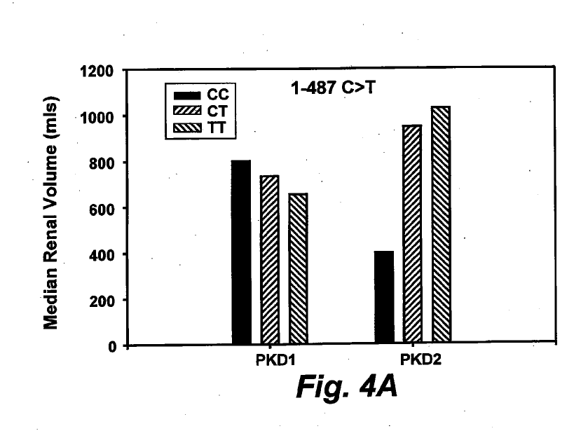

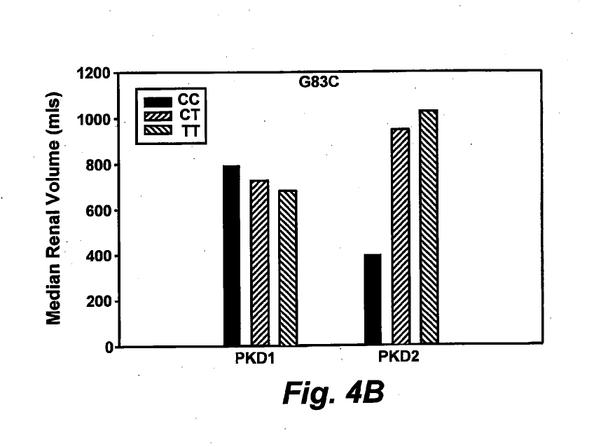

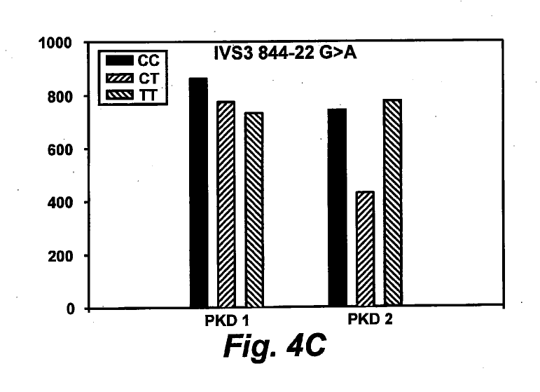

Twelve variants were found in the PKD2 gene and its promoter in PKD2 (n=19), PKD1 (n=173) and control (n=50) subjects. Seven variants were found in the 19 PKD2 individuals (FIG. 4). Haplotype frequencies were In Hardy-Weinberg equilibrium in PKD2 individuals with the exception of the 1-83G>C promoter. The two variants in the promoter region have not been previously described. A transcription element search system of this region demonstrates a c-Myb binding site that is present in the normal sequence (ctCacc) and absent in the variant sequence (ctTacc). c-Myb has a leucine zipper motif and can be an inhibitor, which may act on the activating domain of PKD2 in cis and in trans. This individual has sequence variants for both promoter SNPs. The haplotype frequencies of the common promoter variant are shown in FIG. 3. The relative frequencies of the haplotypes did not differ between PKD2 and PKD1 individuals or vs. controls.

### Example 6

### The Relationship Between Renal Volume and SNPs in PKD2 Subjects in the Cohort Study

Renal volumes in PKD2 and PKD1 individuals based on the haplotypes of the three most common polymorphisms in the PKD2 gene are presented (FIGS. 4A-4C). No differences were demonstrated in renal volume in the PKD1 individuals. However, renal volume increased in PKD2 individuals (P<0.08) with regard to the promoter 1-487C>T and the G83C polymorphisms. Defined haplotypes distributed identically for both polymorphisms within PKD2 and PKD1 subjects.

Data indicates that the number of polymorphisms in the PKD2 gene and its promoter are relatively small and that there are three common polymorphisms, two of which segregate together. These findings suggest that there may be functional sequence variants within the PKD2 gene that are not disease causing but modify disease severity.

The data provided in this application indicate that genotype, mutation type, and sequence variation of genes responsible for the development of cystic phenotypes may play a role in disease severity. This information suggests that a rapid, reliable, inexpensive form for genetic testing can be developed through the resequencing arrays described in this application. This information will provide a clinical molecular approach to diagnose and treat patients with ADPKD as well as potentially other renal cystic disorders.

### Example 7

TABLE 8
Polycystic Associated Genes and relevant Genbank Accession Nos.

| | hg18 | | +/− | Range according to |
|---|---|---|---|---|
| Gene | Ref Gene | chr | strand | UCSC site* |
| pkd1 | NM_001009944 | 16 | − | 2078712-2125900 |
| pkd2 | NM_000297 | 4 | + | 89147844-89217952 |
| pkhd1 | NM_138694 | 6 | − | 51588104-52060382 |
| tsc1 | NM_000368 | 9 | − | 134756558-134809841 |
| tsc2 | NM_000548 | 16 | + | 2037991-2078713 |
| nphp1 | NM_000272 | 2 | − | 110237195-110319883 |
| nphp2 | NM_014425 | 9 | + | 101901332102103247 |
| nphp3 | NM_153240 | 3 | − | 133882144-133923966 |
| nphp4 | NM_015102 | 1 | − | 5845457-5975118 |
| umod | NM_003361 | 16 | − | 20251875-20271538 |
| prkcsh | NM_002743 | 19 | + | 11407269-11422780 |
| sec63 | NM_007214 | 6 | − | 108298216-108386086 |

TABLE 9
Regions Amplified by PCR for Hybridization
with Resequencing Array Experiments

| Name of Region | Chr | Start^{A} | Stop^{A} | Exon Start^{B} | Exon Stop^{B} |
|---|---|---|---|---|---|
| UMOD-01-Emory | 16 | 20271391 | 20271617 | 20269473 | 20269662 |
| UMOD-02-Emory | 16 | 20269385 | 20269738 | 20269473 | 20269662 |
| UMOD-03-Emory | 16 | 20267169 | 20268126 | 20267259 | 20268035 |
| UMOD-04-Emory | 16 | 20266899 | 20267315 | 20267046 | 20267153 |
| UMOD-05-Emory | 16 | 20264862 | 20265273 | 20264949 | 20265157 |
| UMOD-06-Emory | 16 | 20262768 | 20263109 | 20262847 | 20262995 |
| UMOD-07-Emory | 16 | 20259842 | 20260310 | 20259914 | 20260159 |
| UMOD-08-Emory | 16 | 20255989 | 20256362 | 20256114 | 20256276 |
| UMOD-09-Emory | 16 | 20255367 | 20255682 | 20255469 | 20255550 |
| UMOD-10-Emory | 16 | 20254207 | 20254461 | 20254305 | 20254343 |
| UMOD-11-Emory | 16 | 20251789 | 20251875 | 20251875 | 20252198 |
| TSC1-1-Emory | 9 | 134809568 | 134809994 | 134809751 | 134809841 |
| TSC1-2-Emory | 9 | 134800183 | 134800400 | 134800241 | 134800303 |
| TSC1-3-Emory | 9 | 134793900 | 134794246 | 134793975 | 134794160 |
| TSC1-4-Emory | 9 | 134792318 | 134792589 | 134792409 | 134792512 |
| TSC1-5-Emory | 9 | 134790710 | 134791041 | 134790795 | 134790947 |
| TSC1-6-Emory | 9 | 134788461 | 134788791 | 134788556 | 134788700 |
| TSC1-7-Emory | 9 | 134786960 | 134787267 | 134787027 | 134787181 |
| TSC1-8-Emory | 9 | 134786495 | 134786714 | 134786571 | 134786644 |
| TSC1-9-Emory | 9 | 134777387 | 134777765 | 134777490 | 134777665 |
| TSC1-10-Emory | 9 | 134776561 | 134776830 | 134776661 | 134776776 |
| TSC1-11-Emory | 9 | 134776132 | 134776391 | 134776210 | 134776321 |
| TSC1-12-Emory | 9 | 134775693 | 134776018 | 134775779 | 134775900 |
| TSC1-13-Emory | 9 | 134772412 | 134772671 | 134772509 | 134772578 |
| TSC1-14-Emory | 9 | 134771862 | 134772150 | 134771939 | 134772043 |
| TSC1-15-Emory | 9 | 134770694 | 134771414 | 134770789 | 134771347 |
| TSC1-16-Emory | 9 | 134769520 | 134769765 | 134769619 | 134769662 |
| TSC1-17-Emory | 9 | 134768792 | 134769127 | 134768859 | 134769025 |
| TSC1-18-Emory | 9 | 134767706 | 134768070 | 134767813 | 134767995 |
| TSC1-19-Emory | 9 | 134766693 | 134767016 | 134766797 | 134766907 |
| TSC1-20-Emory | 9 | 134765821 | 134766117 | 134765923 | 134766045 |
| TSC1-21-22-Emory | 9 | 134762317 | 134762916 | 134762631 | 134762553 |
| TSC1-23-Emory | 9 | 134756493 | 134762065 | 134761443 | 134761962 |
| PKRCSH-1-Emory | 19 | 11407149 | 11407639 | 11407269 | 11407527 |
| PKRCSH-2-Emory | 19 | 11407786 | 11408089 | 11407862 | 11408017 |
| PKRCSH-3-Emory | 19 | 11408137 | 11408414 | 11408210 | 11408326 |
| PKRCSH-4-5-Emory | 19 | 11409618 | 11410049 | 11409697 | 11409945 |
| PKRCSH-6-Emory | 19 | 11412972 | 11413273 | 11413055 | 11413172 |
| PKRCSH-7-Emory | 19 | 11414080 | 11414414 | 11414201 | 11414330 |
| PKRCSH-8-Emory | 19 | 11417107 | 11417378 | 11417204 | 11417288 |
| PKRCSH-9-Emory | 19 | 11417960 | 11418212 | 11418087 | 11418165 |
| PKRCSH-10-Emory | 19 | 11418843 | 11419056 | 11418889 | 11418975 |
| PKRCSH-11-12-Emory | 19 | 11419210 | 11419690 | 11419254 | 11419604 |
| PKRCSH-13-Emory | 19 | 11419931 | 11420202 | 11420037 | 11420106 |
| PKRCSH-14-Emory | 19 | 11420262 | 11420577 | 11420355 | 11420444 |
| PKRCSH-15-16-Emory | 19 | 11420610 | 11421118 | 11420729 | 11420990 |
| PKRCSH-17-Emory | 19 | 11420920 | 11421339 | 11421081 | 11421227 |
| PKRCSH-18-Emory | 19 | 11422319 | 11422920 | | |
| TSC2-1-Emory | 16 | 2037446 | 2038469 | 2037991 | 2038067 |
| TSC2-2-Emory | 16 | 2038480 | 2038834 | 2038589 | 2038755 |
| TSC2-3-Emory | 16 | 2040330 | 2040578 | 2040402 | 2040488 |
| TSC2-4-Emory | 16 | 2043196 | 2043632 | 2043344 | 2043454 |
| TSC2-5-Emory | 16 | 2044146 | 2044508 | 2044298 | 2044442 |
| TSC2-6-Emory | 16 | 2045298 | 2045589 | 2045404 | 2045521 |
| TSC2-7-Emory | 16 | 2046092 | 2046296 | 2046198 | 2046246 |
| TSC2-8-Emory | 16 | 2046443 | 2046856 | 2046646 | 2046771 |
| TSC2-9-Emory | 16 | 2046946 | 2047388 | 2047107 | 2047180 |
| TSC2-10-Emory | 16 | 2048395 | 2048994 | 2048749 | 2048875 |
| TSC2-11-Emory | 16 | 2050248 | 2051035 | 2050672 | 2050815 |
| TSC2-12-Emory | 16 | 2051810 | 2052106 | 2051873 | 2052010 |
| TSC2-13-Emory | 16 | 2052221 | 2053066 | 2052499 | 2052602 |
| TSC2-14-Emory | 16 | 2052749 | 2053216 | 2052974 | 2053055 |
| TSC2-15-Emory | 16 | 2054202 | 2054522 | 2054274 | 2054429 |
| TSC2-16-Emory | 16 | 2055439 | 2055720 | 2055521 | 2055637 |
| TSC2-17-Emory | 16 | 2060338 | 2060781 | 2060458 | 2060580 |
| TSC2-18-Emory | 16 | 2061145 | 2061735 | 2061512 | 2061618 |
| TSC2-19-Emory | 16 | 2061599 | 2062265 | 2061786 | 2061936 |
| TSC2-20-Emory | 16 | 2062163 | 2062675 | 2062243 | 2062365 |
| TSC2-21-Emory | 16 | 2062651 | 2063114 | 2062851 | 2062985 |
| TSC2-22-Emory | 16 | 2064083 | 2064623 | 2064202 | 2064391 |
| TSC2-23-Emory | 16 | 2065605 | 2066089 | 2065801 | 2065894 |
| TSC2-24-Emory | 16 | 2065848 | 2066483 | 2066070 | 2066172 |
| TSC2-25-Emory | 16 | 2066161 | 2066685 | 2066493 | 2066587 |
| TSC2-26-Emory | 16 | 2067366 | 2067891 | 2067600 | 2067728 |
| TSC2-27-28-Emory | 16 | 2068541 | 2069594 | 2069034 | 2069430 |
| TSC2-29-Emory | 16 | 2069331 | 2069910 | 2069559 | 2069671 |
| TSC2-30-Emory | 16 | 2070098 | 2070489 | 2070167 | 2070379 |
| TSC2-31-Emory | 16 | 2071463 | 2072019 | 2071597 | 2071800 |
| TSC2-32-Emory | 16 | 2072222 | 2072662 | 2072438 | 2072506 |
| TSC2-33-Emory | 16 | 2073556 | 2073935 | 2073697 | 2073818 |
| TSC2-34-Emory | 16 | 2074024 | 2074961 | 2074230 | 2074717 |
| TSC2-35-36-Emory | 16 | 2074691 | 2075459 | 2074953 | 2075324 |
| TSC2-37-Emory | 16 | 2076065 | 2076524 | 2076195 | 2076381 |
| TSC2-38-Emory | 16 | 2076363 | 2077111 | 2076734 | 2076873 |
| TSC2-39-41-Emory | 16 | 2077741 | 2078459 | 2077865 | 2078327 |
| TSC2-42-Emory | 16 | 2078271 | 2078813 | 2078448 | 2078612 |
| PKD1-1-Emory | 16 | 2125171 | 2126335 | 2125477 | 2125691 |
| PKD1-2-3-Emory | 16 | 2109011 | 2109850 | 2109309 | 2109187 |
| PKD1-4-Emory | 16 | 2108461 | 2108899 | 2108678 | 2108847 |
| PKD1-5-6-Emory | 16 | 2107323 | 2108552 | 2107793 | 2107674 |
| PKD1-7-8-Emory | 16 | 2106410 | 2107648 | 2106835 | 2106646 |
| PKD1-9-Emory | 16 | 2105882 | 2106394 | 2105994 | 2106120 |
| PKD1-10-Emory | 16 | 2105339 | 2105864 | 2105380 | 2105627 |
| PKD1-11-Emory | 16 | 2103980 | 2105073 | 2104172 | 2104927 |
| PKD1-12-Emory | 16 | 2102923 | 2103526 | 2103163 | 2103294 |
| PKD1-13-14-Emory | 16 | 2101842 | 2103087 | 2102790 | 2102475 |
| PKD1-15-Emory | 16 | 2098185 | 2102219 | 2098254 | 2101873 |
| PKD1-16-Emory | 16 | 2097736 | 2098267 | 2097885 | 2098034 |
| PKD1-17-18-Emory | 16 | 2096205 | 2097003 | 2096807 | 2096679 |
| PKD1-19-20-Emory | 16 | 2095824 | 2096422 | 2096093 | 2096026 |
| PKD1-21-Emory | 16 | 2095155 | 2095616 | 2095324 | 2095476 |
| PKD1-22-Emory | 16 | 2094399 | 2094796 | 2094500 | 2094644 |
| PKD1-23-Emory | 16 | 2093176 | 2093930 | 2093268 | 2093897 |
| PKD1-24-Emory | 16 | 2092757 | 2093114 | 2092816 | 2092972 |
| PKD1-25-26-Emory | 16 | 2092007 | 2092776 | 2092383 | 2092258 |
| PKD1-27-28-Emory | 16 | 2090060 | 2090643 | 2090398 | 2090311 |
| PKD1-29-30-Emory | 16 | 2089496 | 2090170 | 2089863 | 2089772 |
| PKD1-31-32-Emory | 16 | 2087623 | 2088134 | 2087870 | 2087782 |
| PKD1-33-34-Emory | 16 | 2087016 | 2087600 | 2087321 | 2087243 |
| PKD1-35-7-Emory | 16 | 2083466 | 2084280 | 2084094 | 2083740 |
| PKD1-38-Emory | 16 | 2082861 | 2083247 | 2082956 | 2083095 |
| PKD1-39-Emory | 16 | 2082367 | 2082678 | 2082482 | 2082594 |
| PKD1-40-Emory | 16 | 2081988 | 2082329 | 2082049 | 2082190 |
| PKD1-41-Emory | 16 | 2081422 | 2082002 | 2081783 | 2081908 |
| PKD1-42-Emory | 16 | 2080950 | 2082015 | 2081425 | 2081599 |
| PKD1-43-44-Emory | 16 | 2080625 | 2081441 | 2080886 | 2080810 |
| PKD1-45-Emory | 16 | 2080167 | 2080765 | 2080287 | 2080592 |
| PKD1-46-Emory | 16 | 2078644 | 2080350 | 2079729 | 2080196 |
| PKD2-1-Emory | 4 | 89147463 | 89148741 | 89147910 | 89148504 |
| PKD2-2-Emory | 4 | 89159519 | 89159868 | 89159634 | 89159747 |
| PKD2-3-Emory | 4 | 89176262 | 89176671 | 89176396 | 89176529 |
| PKD2-4-Emory | 4 | 89178284 | 89178746 | 89178427 | 89178677 |
| PKD2-5-Emory | 4 | 89183293 | 89183743 | 89183409 | 89183633 |
| PKD2-6-Emory | 4 | 89186749 | 89187140 | 89186818 | 89187046 |
| PKD2-7-Emory | 4 | 89192035 | 89192446 | 89192167 | 89192334 |
| PKD2-8-Emory | 4 | 89195703 | 89196536 | 89196262 | 89196443 |
| PKD2-9-Emory | 4 | 89198094 | 89198507 | 89198159 | 89198279 |
| PKD2-10-Emory | 4 | 89201954 | 89202346 | 89202082 | 89202180 |
| PKD2-11-Emory | 4 | 89205410 | 89205865 | 89205550 | 89205671 |
| PKD2-12-Emory | 4 | 89205867 | 89206200 | 89205938 | 89206055 |
| PKD2-13-Emory | 4 | 89208005 | 89208316 | 89208074 | 89208237 |
| PKD2-14-Emory | 4 | 89214764 | 89215372 | 89214988 | 89215135 |
| PKD2-15-Emory | 4 | 89215537 | 89218102 | 89215634 | 89215870 |
| NPHP1-1-Emory | 2 | 110319634 | 110319974 | 110319766 | 110319883 |
| NPHP1-2-Emory | 2 | 110316229 | 110316417 | 110316287 | 110316360 |
| NPHP1-3-Emory | 2 | 110294393 | 110294650 | 110294490 | 110294550 |
| NPHP1-4-Emory | 2 | 110293159 | 110293546 | 110293289 | 110293413 |
| NPHP1-5-Emory | 2 | 110284586 | 110284936 | 110284672 | 110284864 |
| NPHP1-6-Emory | 2 | 110283145 | 110283602 | 110283318 | 110283419 |
| NPHP1-7-Emory | 2 | 110279809 | 110280262 | 110279918 | 110280021 |
| NPHP1-8-Emory | 2 | 110279310 | 110279688 | 110279386 | 110279596 |
| NPHP1-9-Emory | 2 | 110277760 | 110278062 | 110277914 | 110278001 |
| NPHP1-10-Emory | 2 | 110276396 | 110276660 | 110276469 | 110276563 |
| NPHP1-11-Emory | 2 | 110274804 | 110275202 | 110274993 | 110275121 |
| NPHP1-12-Emory | 2 | 110264956 | 110265233 | 110265048 | 110265122 |
| NPHP1-13-Emory | 2 | 110262650 | 110263375 | 110262782 | 110262892 |
| NPHP1-14-Emory | 2 | 110261534 | 110261971 | 110261619 | 110261701 |
| NPHP1-15-Emory | 2 | 110259284 | 110259605 | 110259359 | 110259435 |
| NPHP1-16-Emory | 2 | 110258346 | 110258614 | 110258408 | 110258507 |
| NPHP1-17-Emory | 2 | 110246449 | 110246874 | 110246545 | 110246657 |
| NPHP1-18-Emory | 2 | 110243906 | 110244314 | 110244052 | 110244125 |
| NPHP1-19-Emory | 2 | 110240435 | 110240771 | 110240503 | 110240547 |
| NPHP1-20-Emory | 2 | 110237125 | 110239026 | 110238657 | 110238929 |
| NPHP2-1-Emory | 9 | 101901204 | 101901735 | 101901332 | 101901519 |
| NPHP2-2-Emory | 9 | 101906530 | 101907032 | 101906625 | 101906730 |
| NPHP2-3-Emory | 9 | 101928218 | 101928731 | 101928486 | 101928652 |
| NPHP2-4-Emory | 9 | 102027939 | 102028433 | 102028165 | 102028338 |
| NPHP2-5-Emory | 9 | 102031680 | 102032068 | 102031763 | 102031930 |
| NPHP2-6-Emory | 9 | 102042008 | 102042414 | 102042163 | 102042343 |
| NPHP2-7-Emory | 9 | 102044558 | 102044981 | 102044673 | 102044782 |
| NPHP2-8-Emory | 9 | 102048533 | 102049158 | 102048719 | 102048890 |
| NPHP2-9-Emory | 9 | 102054008 | 102054655 | 102054386 | 102054541 |
| NPHP2-10-Emory | 9 | 102054683 | 102055383 | 102055010 | 102055239 |
| NPHP2-11-Emory | 9 | 102066740 | 102067202 | 102066925 | 102067031 |
| NPHP2-12-Emory | 9 | 102074734 | 102075309 | 102074967 | 102075179 |
| NPHP2-13-Emory | 9 | 102086314 | 102086820 | 102086423 | 102086706 |
| NPHP2-14-Emory | 9 | 102094315 | 102095265 | 102094429 | 102095146 |
| NPHP2-15-Emory | 9 | 102098897 | 102099368 | 102099020 | 102099249 |
| NPHP2-16-Emory | 9 | 102099907 | 102100273 | 102100039 | 102100113 |
| NPHP2-17-Emory | 9 | 102102486 | 102103512 | 102102671 | 102102777 |
| NPHP3-1-Emory | 3 | 133923364 | 133924602 | 133923497 | 133923889 |
| NPHP3-2-Emory | 3 | 133921117 | 133921516 | 133921239 | 133921364 |
| NPHP3-3-Emory | 3 | 133920367 | 133920816 | 133920528 | 133920678 |
| NPHP3-4-Emory | 3 | 133918118 | 133918641 | 133918291 | 133918443 |
| NPHP3-5-Emory | 3 | 133916422 | 133916890 | 133916619 | 133916752 |
| NPHP3-6-Emory | 3 | 133914593 | 133915093 | 133914660 | 133914820 |
| NPHP3-7-Emory | 3 | 133909458 | 133909866 | 133909635 | 133909791 |
| NPHP3-8-Emory | 3 | 133907096 | 133907416 | 133907274 | 133907348 |
| NPHP3-9-Emory | 3 | 133905594 | 133906046 | 133905732 | 133905905 |
| NPHP3-10-Emory | 3 | 133902881 | 133903138 | 133902964 | 133903067 |
| NPHP3-11-12-Emory | 3 | 133901377 | 133902105 | 133901868 | 133901595 |
| NPHP3-13-Emory | 3 | 133900767 | 133901183 | 133900887 | 133900984 |
| NPHP3-14-Emory | 3 | 133898640 | 133899000 | 133898794 | 133898896 |
| NPHP3-15-Emory | 3 | 133898163 | 133898419 | 133898265 | 133898347 |
| NPHP3-16-Emory | 3 | 133896219 | 133896716 | 133896361 | 133896499 |
| NPHP3-17-Emory | 3 | 133893414 | 133894416 | 133894188 | 133894352 |
| NPHP3-18-Emory | 3 | 133892578 | 133892891 | 133892726 | 133892820 |
| NPHP3-19-Emory | 3 | 133891844 | 133892348 | 133892062 | 133892184 |
| NPHP3-20-21-Emory | 3 | 133890055 | 133890921 | 133890608 | 133890425 |
| NPHP3-22-Emory | 3 | 133888615 | 133889063 | 133888685 | 133888760 |
| NPHP3-23-Emory | 3 | 133887496 | 133888108 | 133887794 | 133887921 |
| NPHP3-24-Emory | 3 | 133885886 | 133886417 | 133886088 | 133886328 |
| NPHP3-25-Emory | 3 | 133884762 | 133885196 | 133884933 | 133885058 |
| NPHP3-26-Emory | 3 | 133884025 | 133884588 | 133884237 | 133884352 |
| NPHP3-27-Emory | 3 | 133881721 | 133883764 | 133883444 | 133883624 |
| NPHP4-1-Emory | 1 | 5973823 | 5975263 | 5974891 | 5975118 |
| NPHP4-2-Emory | 1 | 5968728 | 5969128 | 5968802 | 5968936 |
| NPHP4-3-Emory | 1 | 5960691 | 5961298 | 5960917 | 5961060 |
| NPHP4-4-Emory | 1 | 5951337 | 5952146 | 5951734 | 5951906 |
| NPHP4-5-Emory | 1 | 5949642 | 5950245 | 5949946 | 5950010 |
| NPHP4-6-Emory | 1 | 5944260 | 5944682 | 5944441 | 5944596 |
| NPHP4-7-Emory | 1 | 5935101 | 5935650 | 5935347 | 5935483 |
| NPHP4-8-Emory | 1 | 5930623 | 5931046 | 5930717 | 5930898 |
| NPHP4-9-Emory | 1 | 5929670 | 5929964 | 5929751 | 5929877 |
| NPHP4-10-Emory | 1 | 5915573 | 5916086 | 5915794 | 5915976 |
| NPHP4-11-Emory | 1 | 5910169 | 5910506 | 5910296 | 5910434 |
| NPHP4-12-Emory | 1 | 5891743 | 5892054 | 5891799 | 5891860 |
| NPHP4-13-Emory | 1 | 5889669 | 5890080 | 5889762 | 5889869 |
| NPHP4-14-15-Emory | 1 | 5887825 | 5888535 | 5888279 | 5888130 |
| NPHP4-16-Emory | 1 | 5887131 | 5887701 | 5887264 | 5887451 |
| NPHP4-17-Emory | 1 | 5873241 | 5873755 | 5873515 | 5873675 |
| NPHP4-18-Emory | 1 | 5869711 | 5870502 | 5869933 | 5870113 |
| NPHP4-19-Emory | 1 | 5862560 | 5862964 | 5862761 | 5862886 |
| NPHP4-20-Emory | 1 | 5859636 | 5860097 | 5859740 | 5859945 |
| NPHP4-21-22-Emory | 1 | 5857044 | 5858020 | 5857521 | 5857304 |
| NPHP4-23-Emory | 1 | 5855682 | 5856316 | 5855899 | 5855982 |
| NPHP4-24-Emory | 1 | 5850183 | 5850798 | 5850387 | 5850543 |
| NPHP4-25-Emory | 1 | 5849582 | 5849851 | 5849677 | 5849762 |
| NPHP4-26-Emory | 1 | 5848673 | 5849194 | 5849020 | 5849105 |
| NPHP4-27-Emory | 1 | 5847568 | 5848256 | 5847749 | 5847920 |
| NPHP4-28-29-Emory | 1 | 5846442 | 5847322 | 5846985 | 5846680 |
| NPHP4-30-Emory | 1 | 5845039 | 5846307 | 5845912 | 5846052 |
| SEC63-1-Emory | 6 | 108385581 | 108386459 | 52055935 | 52056012 |
| SEC63-2-Emory | 6 | 108357217 | 108357507 | 108357312 | 108357411 |
| SEC63-3-Emory | 6 | 108352524 | 108352948 | 108352715 | 108352829 |
| SEC63-4-Emory | 6 | 108349373 | 108350148 | 108349694 | 108349806 |
| SEC63-5-6-Emory | 6 | 108340528 | 108341416 | 108341263 | 108340671 |
| SEC63-7-Emory | 6 | 108339135 | 108339506 | 108339243 | 108339293 |
| SEC63-8-Emory | 6 | 108336579 | 108337074 | 108336824 | 108336932 |
| SEC63-9-10-Emory | 6 | 108334181 | 108334755 | 108334580 | 108334477 |
| SEC63-11-Emory | 6 | 108332463 | 108332689 | 108332526 | 108332618 |
| SEC63-12-Emory | 6 | 108330584 | 108330965 | 108330741 | 108330895 |
| SEC63-13-Emory | 6 | 108329035 | 108329464 | 108329267 | 108329414 |
| SEC63-14-Emory | 6 | 108325278 | 108325798 | 108325546 | 108325628 |
| SEC63-15-16-Emory | 6 | 108321298 | 108321926 | 108321735 | 108321552 |
| SEC63-17-Emory | 6 | 108310700 | 108311106 | 108310885 | 108311043 |
| SEC63-18-Emory | 6 | 108308767 | 108309354 | 108309046 | 108309147 |
| SEC63-19-Emory | 6 | 108304390 | 108304683 | 108304461 | 108304559 |
| SEC63-20-Emory | 6 | 108300430 | 108300899 | 108300705 | 108300809 |
| SEC63-21-Emory | 6 | 108298107 | 108300060 | 108298216 | 108299744 |

^{A}Nucleotide positions within the sequences PKD1 (GenBank Accession No: NM001009944), PKD2 (GenBank Accession No: NM000297), PKHD1 (GenBank Accession No: NM138694), TSC1 (GenBank Accession No: NM000368), TSC2 (GenBank Accession No: NM000548), PRKCSH (GenBank Accession No: NM002743), UMOD (GenBank Accession No: NM003361), NPHP1 (GenBank Accession No: NM000272), NPHP2 (GenBank Accession No: NM014425), NPHP3 (GenBank Accession No: NM153240), NPHP4 (GenBank Accession No: 015102), and SEC63 (GenBank Accession No: NM007214) of regions amplified by RT-PCR using the primers according to SEQ ID NOs: 1-590 as shown in Table 10. FIGS. 7A-7E show tan mRNA sequence (SEQ ID NO: 591) of PKD1 with the positions of the forward and reverse primers indicated. The amplified sequences included between about 50 and about 100 nucleotide positions 5′ ad 3′ of each exon to allow for optimization of the primer positions as well as allowing for detection of sequence variation in introns. Where intronic regions were small two or three exons with their intervening introns were included I a single amplicon.
^{B}Exon start and stop positions within the sequences: PKD1 (GenBank Accession No: NM001009944), PKD2 (GenBank Accession No: NM000297), PKHD1 (GenBank Accession No: NM138694), TSC1 (GenBank Accession No: NM000368), TSC2 (GenBank Accession No: NM000548), PRKCSH (GenBank Accession No: NM002743), UMOD (GenBank Accession No: NM003361), NPHP1 (GenBank Accession No: NM000272), NPHP2 (GenBank Accession No: NM014425), NPHP3 (GenBank Accession No: NM153240), NPHP4 (GenBank Accession No: 015102), and SEC63 (GenBank Accession No: NM007214).

TABLE 10

Primers used to PCR Amplify Regions of Genes
Associated with Polycystic Diseases for use in
Resequencng Array Analysis

| | | |
|---|---|---|
| SEQ | | |
| ID NO | Primer | Sequence (5′-3′) |

| | | |
|---|---|---|
| 1. | PKD1-1F | CTCAGCAGCAGGTCGCGGCC |
| 2. | PKD1-1R | AGGCACTGGAGGGCTGGGCCGC |
| 3. | PKD1-2F | CAGGGCTGGTGCCTGTGTGGGGC |
| 4. | PKD1-2R | GGCCTGGGGGTGGCAAGAGGCGTC |
| 5. | PKD1-3F | GGACGCCTCCTGCCACCCCC |
| 6. | PKD1-3R | CTGGCACGGGTGGGGGCGGCTTCC |
| 7. | PKD1-4F | AAGCCGCCCCCACCCGTGCCA |
| 8. | PKD1-4R | CTCCAGGCAGTCCAGCTGTAGGAGAC |
| 9. | PKD1-5F | GGGATGGCACCAACGTCTC |
| 10. | PKD1-5R | CCTCCAAGTAGTTGCGCTGTGATCGC |
| 11. | PKD1-6F | AGCGCAACTACTTGGAGGCCC |
| 12. | PKD1-6R | ACCACAACGGAGTTGGCGG |
| 13. | PKD1-7F | CAGCTCCGCCAACTCCGCCAACT |
| 14. | PKD1-7R | GGACAGGAGCCACGCAACACTCAC |
| 15. | PKD1-8F | AGGCAGCGAGGCTGTCCAGG |
| 16. | PKD1-8R | GCAGCCTGCGCAGGAACAACTCC |
| 17. | PKD1-9F | CCTCTCGCTGCCTCTGCTCACCTC |
| 18. | PKD1-9R | ATAACGCCACCACACCTACCAAGC |
| 19. | UMOD-1F | TGTAAAACGACGGCCAGTCAGAACTAGAGACTAATTGGAGGAGAGAT |
| 20. | UMOD-2F | TGTAAAACGACGGCCAGTTACAATCAAAGCACTCCTTCCAGC |
| 21. | UMOD-3F | TGTAAAACGACGGCCAGTATAATGAGTTCCCTGGAGAATGAG |
| 22. | UMOD-4F | TGTAAAACGACGGCCAGTGCTACTACGTCTACAACCTGACAGCGC |
| 23. | UMOD-5F | TGTAAAACGACGGCCAGTCTATGCTGAGCACTTCCAGATG |
| 24. | UMOD-6F | TGTAAAACGACGGCCAGTGGCTCACAAGTAGCCAGACAT |
| 25. | UMOD-7F | TGTAAAACGACGGCCAGTTTGCAAAGCAACAGTTGGTG |
| 26. | UMOD-8F | TGTAAAACGACGGCCAGTGTGACAGAGCAATATTTGAATCCA |
| 27. | UMOD-9F | TGTAAAACGACGGCCAGTTATACAGGTCTCCTAACAACTTCTGCCT |
| 28. | UMOD-10F | TGTAAAACGACGGCCAGTGGTTTTGAAGAGATCAGTCTGGC |
| 29. | UMOD-11F | TGTAAAACGACGGCCAGTCAGAGAGGGTGTCCTCTTCTGAT |
| 30. | UMOD-1R | CAGGAAACAGCTATGACCAGAATAATGACTCAAATCCAGGTCTGAC |
| 31. | UMOD-2R | CAGGAAACAGCTATGACCCTCTGACAGGTGCTACATTGCTTC |
| 32. | UMOD-3R | CAGGAAACAGCTATGACCGACAGACAGACAATCAATAAGGACG |
| 33. | UMOD-4R | CAGGAAACAGCTATGACCATTAGTGGATCTTCTGTTTTCACTCAGGT |
| 34. | UMOD-5R | CAGGAAACAGCTATGACCCCCAAAGCTTCTATAACTAGGAAGTGA |
| 35. | UMOD-6R | CAGGAAACAGCTATGACCCAGTTGACAGGGAAGCTCATG |
| 36. | UMOD-7R | CAGGAAACAGCTATGACCTTCCTCCATCCAAGTCCAAAGA |
| 37. | UMOD-8R | CAGGAAACAGCTATGACCCATCTTATTGCTCATTCTATCCCTC |
| 38. | UMOD-9R | CAGGAAACAGCTATGACCTCAGAGCTCAGTAAGGTGCCAA |
| 39. | UMOD-10R | CAGGAAACAGCTATGACCCCCTTATAGAGTTGCTATGAAGCATTACA |
| 40. | UMOD-11R | CAGGAAACAGCTATGACCACCGTAGGATCCTTAGCACCATACATA |
| 41. | PRKCSH-1F | TGTAAAACGACGGCCAGTTCACGTGCTCATTCCGTTTC |
| 42. | PRKCSH-2F | TGTAAAACGACGGCCAGTCCTGGAAGCGATGATGGAGGAAT |
| 43. | PRKCSH-3F | TGTAAAACGACGGCCAGTATGGGAGGACAGAGGTGGTATTT |
| 44. | PRKCSH-4-5F | TGTAAAACGACGGCCAGTGGGCTCTTATCTGTGGATGGAT |
| 45. | PRKCSH-6F | TGTAAAACGACGGCCAGTCTGGATTGAGCTATTTTGGAAGAG |
| 46. | PRKCSH-7F | TGTAAAACGACGGCCAGTAGCTTGGTGTGTGTTTTGGAA |
| 47. | PRKCSH-8F | TGTAAAACGACGGCCAGTATATAGTAGGCGCTTGGTGGCA |
| 48. | PRKCSH-9F | TGTAAAACGACGGCCAGTCCTTGAGGTCCTGAAGCAAGTT |
| 49. | PRKCSH-10F | TGTAAAACGACGGCCAGTGGACACGTGGTGGCCTAGATCTT |
| 50. | PRKCSH-11-12F | TGTAAAACGACGGCCAGTTGGACCCTGAGTCCACAACA |
| 51. | PRKCSH-13F | TGTAAAACGACGGCCAGTAGAGCAAAATGAGGGTATGGGA |
| 52. | PRKCSH-14F | TGTAAAACGACGGCCAGTACCATTGCTCAGCCAGACCCTCCT |
| 53. | PRKCSH-15-16F | TGTAAAACGACGGCCAGTTTGGTCATTGGCGTTGGAGGTAC |
| 54. | PRKCSH-17F | TGTAAAACGACGGCCAGTACGACAAGTTCAGTGCCATGAA |
| 55. | PRKCSH-18F | TGTAAAACGACGGCCAGTAATAGACAAGGTCTCCAGGCTGGT |
| 56. | PRKCSH-1R | CAGGAAACAGCTATGACCGCCAACAGACCAAAGGGATTA |
| 57. | PRKCSH-2R | CAGGAAACAGCTATGACCTGCCTATCCCTAAGGCCCAAT |
| 58. | PRKCSH-3R | CAGGAAACAGCTATGACCCAGAGGTAGTATCTTGGTCACACAGA |
| 59. | PRKCSH-4-5R | CAGGAAACAGCTATGACCAACCCGATACAGAAAAGCAGAAGA |
| 60. | PRKCSH-6R | CAGGAAACAGCTATGACCAGAACAGCAGTCAGGGGCAAA |
| 61. | PRKCSH-7R | CAGGAAACAGCTATGACCAACAGATAATGAGCGGGAGACT |
| 62. | PRKCSH-8R | CAGGAAACAGCTATGACCAGGATCTGGCTGGTTTCTAGAGG |
| 63. | PRKCSH-9R | CAGGAAACAGCTATGACCGGGCAATGCTCCCTAGAAGT |
| 64. | PRKCSH-10R | CAGGAAACAGCTATGACCAACCAGAGGCAGCTCCTTTGT |
| 65. | PRKCSH-11-12R | CAGGAAACAGCTATGACCTAAGCTCAGGATCTTCCCTCGA |
| 66. | PRKCSH-13R | CAGGAAACAGCTATGACCCTGTGGTTGCCTCAGTGATTC |
| 67. | PRKCSH-14R | CAGGAAACAGCTATGACCTCAATATGGAAGGCAGCACTCTC |
| 68. | PRKCSH-15-16R | CAGGAAACAGCTATGACCCTGGTAACCATGGTCTCTTTC |
| 69. | PRKCSH-17R | CAGGAAACAGCTATGACCACAGGTTGATAGAGTGGCCATGT |
| 70. | PRKCSH-18R | CAGGAAACAGCTATGACCCACCTGGTATCTTCAGGAGTGATC |
| 71. | PKD2-1FV2 | TGTAAAACGACGGCCAGTTTCCACTTGGAACGCGGACT |
| 72. | PKD2-2F | TGTAAAACGACGGCCAGTGGAGAATCTCCCTTATAGGTGAACTT |
| 73. | PKD2-3F | TGTAAAACGACGGCCAGTAAGGGTGAGAGAAGACCTTGTGT |
| 74. | PKD2-4F | TGTAAAACGACGGCCAGTAATCTCTGTGACAACAAAACTCATTCTTA |
| 75. | PKD2-5F | TGTAAAACGACGGCCAGTCCAGCTTGATAGGCCTTAATACATAC |
| 76. | PKD2-6F | TGTAAAACGACGGCCAGTGACATCCATTCCTGGCTGTATT |
| 77. | PKD2-7F | TGTAAAACGACGGCCAGTAATGACATCGGGTAAGTATAATGGTG |
| 78. | PKD2-8F | TGTAAAACGACGGCCAGTCAGAATCTTGCCATATTGCCC |
| 79. | PKD2-9F | TGTAAAACGACGGCCAGTAATGTTGCATCAACTAGTGGACATT |
| 80. | PKD2-10F | TGTAAAACGACGGCCAGTTATGTCTTCATAAAGCACTCAGATTAGG |
| 81. | PKD2-11F | TGTAAAACGACGGCCAGTTCTTCATTCATCCAGCACGTACTT |
| 82. | PKD2-12F | TGTAAAACGACGGCCAGTTGATGTCTCTGTGTTGAGGGTG |
| 83. | PKD2-13F | TGTAAAACGACGGCCAGTAAGTCCTTGGTGAGGCTTCTGT |
| 84. | PKD2-14F | TGTAAAACGACGGCCAGTCTTAAGACTTCTGATACGCGCTG |
| 85. | PKD2-15aF | TGTAAAACGACGGCCAGTTCTCCAGCCTTACCAAACTACAGAT |
| 86. | PKD2-15bF | TGTAAAACGACGGCCAGTACACAGGAGAATTGGAAGGAGC |
| 87. | PKD2-15cF | TGTAAAACGACGGCCAGTCTTCATGATGTGTATTGAGCGG |
| 88. | PKD2-1RV2 | CAGGAAACAGCTATGACCAAGAGCAGTGGAATTCCGC |
| 89. | PKD2-2R | CAGGAAACAGCTATGACCAGGTAAGAAAATAACTTCCCAGTTG |
| 90. | PKD2-3R | CAGGAAACAGCTATGACCCTTCTATCTACTCACCATAACTTACGTCT |
| 91. | PKD2-4R | CAGGAAACAGCTATGACCATGAATGGTGGGAGTTAGAGAATA |
| 92. | PKD2-5R | CAGGAAACAGCTATGACCTGGCATCCTCATGTAGCTAACTG |
| 93. | PKD2-6R | CAGGAAACAGCTATGACCGAATATCAAGATCCACAATGCTGAG |
| 94. | PKD2-7R | CAGGAAACAGCTATGACCAGCTTTGGCTGGTCACTTGAA |
| 95. | PKD2-8R | CAGGAAACAGCTATGACCGGTGGTCATATAGCAACCTCATATG |
| 96. | PKD2-9R | CAGGAAACAGCTATGACCTGAATAGACACATATACATGGATCAATG |
| 97. | PKD2-10R | CAGGAAACAGCTATGACCATCAAGACTCCAAGATAGGGAACAT |
| 98. | PKD2-11R | CAGGAAACAGCTATGACCAATGCAGGAGGAAAGGAGAAAT |
| 99. | PKD2-12R | CAGGAAACAGCTATGACCACTAACACATAAACCGACTGAGAGAGA |
| 100. | PKD2-13R | CAGGAAACAGCTATGACCAATTCAGAGAGATGAGGGAACTGC |
| 101. | PKD2-14R | CAGGAAACAGCTATGACCAGGGTTAGACAATATGACTACATTGATGT |
| 102. | PKD2-15aR | CAGGAAACAGCTATGACCCGTCATACCTGACCGAGTACTATATTC |
| 103. | PKD2-15bR | CAGGAAACAGCTATGACCGTACCTGAATTGTGTAGCTCGTGTAAT |
| 104. | PKD2-15cR | CAGGAAACAGCTATGACCTTGGCTGATACTGTCTAATGTATGAAC |
| 105. | TSC1-1FV2 | TGTAAAACGACGGCCAGTGTCCAACCCACATCGTCAGTTAT |
| 106. | TSC1-2F | TGTAAAACGACGGCCAGTGATAGAGGAGGAAGAAGCTTGTGC |
| 107. | TSC1-3F | TGTAAAACGACGGCCAGTGTGCATTAGTTTGTCTTGCAGGTA |
| 108. | TSC1-4F | TGTAAAACGACGGCCAGTGTGACAGGAAGCTGTGTAAGGTAAA |
| 109. | TSC1-5F | TGTAAAACGACGGCCAGTAGACTTGAGAGATTGGAGCACAT |
| 110. | TSC1-6F | TGTAAAACGACGGCCAGTTCAGTGTTTAGAGCCTCTTCATGTACT |
| 111. | TSC1-7F | TGTAAAACGACGGCCAGTTGCTGGCAGCCACTTGTTTATA |
| 112. | TSC1-8F | TGTAAAACGACGGCCAGTCTAATATTCCATCATTTGGATGTTCC |
| 113. | TSC1-9F | TGTAAAACGACGGCCAGTCTTGCTATCAGAGTTCCGTGGCT |
| 114. | TSC1-10F | TGTAAAACGACGGCCAGTCAGAATAACCTAAAACCACACACTAACC |
| 115. | TSC1-11F | TGTAAAACGACGGCCAGTCATGGATGTAAACCTCGTGGATG |
| 116. | TSC1-12F | TGTAAAACGACGGCCAGTCCCAGAAAGTTAACTCTAGCAGCTT |
| 117. | TSC1-13F | TGTAAAACGACGGCCAGTGCACTCGGCTGACCTTTAAACTA |
| 118. | TSC1-14F | TGTAAAACGACGGCCAGTCAGAGCATGAAGAGTTATTACAGACATATTC |
| 119. | TSC1-15F | TGTAAAACGACGGCCAGTAAACTGCCTAGTCTTTCCCAGGT |
| 120. | TSC1-16F | TGTAAAACGACGGCCAGTTTGACCACAAGGAAGTGATCTAACT |
| 121. | TSC1-17F | TGTAAAACGACGGCCAGTTTAAAGAATTGTGTTTGTTAAGCTAACAAC |
| 122. | TSC1-18F | TGTAAAACGACGGCCAGTGAAATGTTCGCAGTGTGTGTTAAA |
| 123. | TSC1-19F | TGTAAAACGACGGCCAGTAGCCGTTGAGCTAAGGCATT |
| 124. | TSC1-20F | TGTAAAACGACGGCCAGTCCCTGTTTAATGACGTCTATGTGC |
| 125. | TSC1-21F | TGTAAAACGACGGCCAGTGCCTTCTCAGTCCTTCTTACATTGT |
| 126. | TSC1-23aF | TGTAAAACGACGGCCAGTGGAGTTCAGTGTCAGTGTGAGTGA |
| 127. | TSC1-23bF | TGTAAAACGACGGCCAGTGTGAATGCACGTTTCAAAGCTT |
| 128. | TSC1-23cF | TGTAAAACGACGGCCAGTAGCATGAGGAACTGCACCTTT |
| 129. | TSC1-23dF | TGTAAAACGACGGCCAGTCAAAGGAAAGCTTAAAACCCAATAC |
| 130. | TSC1-23eFV2 | TGTAAAACGACGGCCAGTCCGTTGACAAGGCTCTGCTATA |
| 131. | TSC1-23fF | TGTAAAACGACGGCCAGTTATCTGTTTACATCCAGAGTTCTGTGAC |
| 132. | TSC1-1RV2 | CAGGAAACAGCTATGACCAGCCGGAGATAGCGTGTAATAAG |
| 133. | TSC1-2R | CAGGAAACAGCTATGACCCATGGGCAAGATAATTCCCTC |
| 134. | TSC1-3R | CAGGAAACAGCTATGACCAGCAGGATTCTAGTGGCTCTAAAGTC |
| 135. | TSC1-4R | CAGGAAACAGCTATGACCTAAGCTCAGGACAAGTTGCACAG |
| 136. | TSCC15R | CAGGAAACAGCTATGACCTCTAGCTTCCTTGCTTTAAGTTGC |
| 137. | TSC1-6R | CAGGAAACAGCTATGACCGTCTACATGTCCATTCCTTAGTACAGCA |
| 138. | TSC1-7R | CAGGAAACAGCTATGACCAAAGGTATAAATGCAGCCTATCTAAACA |
| 139. | TSC1-8R | CAGGAAACAGCTATGACCCAACAGGGATTACCTCCTAGATCA |
| 140. | TSCC19R | CAGGAAACAGCTATGACCGAACTGAACTAAGTCTTACTCCAGAAAAGA |
| 141. | TSC1-10R | CAGGAAACAGCTATGACCAGCAGTGTGAAATTTTCCCAAC |
| 142. | TSC1-11R | CAGGAAACAGCTATGACCAGATCTAAAAGAGAGCTCCTCCTGC |
| 143. | TSC1-12R | CAGGAAACAGCTATGACCTCTGGCATAATTAGGCTTCTCAAAG |
| 144. | TSC1-13R | CAGGAAACAGCTATGACCCCAGAATTTCCTTGTTTCCATTTAAC |
| 145. | TSC1-14R | CAGGAAACAGCTATGACCCAATGGCACAAAATCCCAGAT |
| 146. | TSC1-15R | CAGGAAACAGCTATGACCAGTGTGAAGAATGATTCTTGTTCCTC |
| 147. | TSC1-16R | CAGGAAACAGCTATGACCAGATCTGTTTCCCAGAGGGCA |
| 148. | TSC1-17R | CAGGAAACAGCTATGACCTAAGCTATCATGCTGACCCAAAAC |
| 149. | TSC1-18R | CAGGAAACAGCTATGACCTTAGTAAAGCTGAACAAGTCAAGGACA |
| 150. | TSC1-19R | CAGGAAACAGCTATGACCCCATGACACAGACACTCAAGTAATCTA |
| 151. | TSC1-20R | CAGGAAACAGCTATGACCGGAAATAAGTCATCAAGCCATTCTCTA |
| 152. | TSC1-22R | CAGGAAACAGCTATGACCACACCACGTGACACAGTCCTTAT |
| 153. | TSC1-23aR | CAGGAAACAGCTATGACCGCATTCAGTCAGCTGTCCAAAG |
| 154. | TSC1-23bR | CAGGAAACAGCTATGACCACAAGAGGCGTATGCACACAA |
| 155. | TSC1-23cR | CAGGAAACAGCTATGACCTAAGTTTGTTCACGTTTTCCTTTTCTA |
| 156. | TSC1-23dR | CAGGAAACAGCTATGACCCATCTTTCACAACTTCTCCATCTAAGA |
| 157. | TSC1-23eRV2 | CAGGAAACAGCTATGACCTTGTAGCTACAGCTACTCTTCCCTCA |
| 158. | TSC1-23fR | CAGGAAACAGCTATGACCTCCCCTGCTTGACCTGTAAG |
| 159. | TSC2-1FV2 | TGTAAAACGACGGCCAGTACAGAGTGGTGGGAAAGGAA |
| 160. | TSC2-2F | TGTAAAACGACGGCCAGTAAAGGTTATGCCCACCAGAGAC |
| 161. | TSC2-3F | TGTAAAACGACGGCCAGTGGTTTGTGACTTGCAGTTAAGGAG |
| 162. | TSC2-4F | TGTAAAACGACGGCCAGTCACAGGAGATACGAGCTTTGGA |
| 163. | TSC2-5F | TGTAAAACGACGGCCAGTTGATGCTGCAGACCTGTCTCTT |
| 164. | TSC2-6F | TGTAAAACGACGGCCAGTTTTCTGGCAGTGACGGGTTT |
| 165. | TSC2-7F | TGTAAAACGACGGCCAGTGATGAGCCATGCGTGTTATTG |
| 166. | TSC2-8F | TGTAAAACGACGGCCAGTATGACAGCATCAATGACCCACA |
| 167. | TSC2-9F | TGTAAAACGACGGCCAGTATTTTGAGAACCCTGCTGCCT |
| 168. | TSC2-10F | TGTAAAACGACGGCCAGTTCTTGGCTGTGATTGGAGGA |
| 169. | TSC2-11F | TGTAAAACGACGGCCAGTTATAGTGATGAGCTGCGGTGTG |
| 170. | TSC2-12F | TGTAAAACGACGGCCAGTCTCTGGTGCCAAGTCCATGT |
| 171. | TSC2-13F | TGTAAAACGACGGCCAGTTGTGTGGAGCAAGCTTCCAT |
| 172. | TSC2-14F | TGTAAAACGACGGCCAGTTAGCTTGCTTTCCAGTCCAGC |
| 173. | TSC2-15F | TGTAAAACGACGGCCAGTAGGAATTGGAAGTGTCACGAGAT |
| 174. | TSC2-16F | TGTAAAACGACGGCCAGTGGTGTTTGTGGTAGAAAGTGTTCTC |
| 175. | TSC2-17F | TGTAAAACGACGGCCAGTTGTGTTTTAAAGCACGCACTCT |
| 176. | TSC2-18F | TGTAAAACGACGGCCAGTTCAGCCTGTCGATGGAAGAA |
| 177. | TSC2-19F | TGTAAAACGACGGCCAGTTACTGCGTCTGCGACTACATGTAC |
| 178. | TSC2-20F | TGTAAAACGACGGCCAGTAAGCAGAGCCTCAGATGCTA |
| 179. | TSC2-21F | TGTAAAACGACGGCCAGTACCTCACATTCCTGGTGTGTTACTT |
| 180. | TSC2-22F | TGTAAAACGACGGCCAGTATTCAGGGACTTGCTAAGCCTC |
| 181. | TSC2-23F | TGTAAAACGACGGCCAGTAATTGGCCCAGAAGCTGTGGTT |
| 182. | TSC2-24F | TGTAAAACGACGGCCAGTTATGCCAGTGTGTTCGCCAT |
| 183. | TSC2-25F | TGTAAAACGACGGCCAGTTTCATCACTAAGGTGGGCTCA |
| 184. | TSC2-26F | TGTAAAACGACGGCCAGTGCCTTACTTGTTCTCAGTCATGTTTAC |
| 185. | TSC2-27-28F | TGTAAAACGACGGCCAGTGAATGAACTCCCATAAGCCTCTTC |
| 186. | TSC2-29F | TGTAAAACGACGGCCAGTTTGGGAACAAGCTTGTCACTGT |
| 187. | TSC2-30F | TGTAAAACGACGGCCAGTAATCAGCTTGAGGCTGGTGGT |
| 188. | TSC2-31F | TGTAAAACGACGGCCAGTGACATCGTGGTCCTGAGGATT |
| 189. | TSC2-32FV2 | TGTAAAACGACGGCCAGTTTAGCGGCCTAGGACGTCTATT |
| 190. | TSC2-33F | TGTAAAACGACGGCCAGTATGGCAGCAGTAAGCAGAGC |
| 191. | TSC2-34F | TGTAAAACGACGGCCAGTGGATGCTGATACCTCTGCTCA |
| 192. | TSC2-35-36F | TGTAAAACGACGGCCAGTAGAGAAAGTGCCAGGCATCAA |
| 193. | TSC2-37F | TGTAAAACGACGGCCAGTAATGGATGGTCTTGTCTGCCT |
| 194. | TSC2-38F | TGTAAAACGACGGCCAGTCACGATGACATCATGCAAGGTA |
| 195. | TSC2-39-41F | TGTAAAACGACGGCCAGTAAAGTTCAGGGGCAGATGCT |
| 196. | TSC2-42F | TGTAAAACGACGGCCAGTATCTACCCCTCCAAGTGGATTG |
| 197. | TSC2-1RV2 | CAGGAAACAGCTATGACCTCCCTGGGAGAACTCAACTACAG |
| 198. | TSC2-2R | CAGGAAACAGCTATGACCACAGAACCTGGTGCAAGACCA |
| 199. | TSC2-3R | CAGGAAACAGCTATGACCTCAGCTGTCAACCATGTTCCTAA |
| 200. | TSC2-4R | CAGGAAACAGCTATGACCTCACACAGACCTCATGACACCA |
| 201. | TSC2-5R | CAGGAAACAGCTATGACCCCTTCCCATCCAGGTTACACTT |
| 202. | TSC2-6R | CAGGAAACAGCTATGACCTCAACTTTATTCACTGCGGAGC |
| 203. | TSC2-7R | CAGGAAACAGCTATGACCCCCAGAAACCAGGGTGAAAT |
| 204. | TSC2-8R | CAGGAAACAGCTATGACCAGACAACCATTCATGGGAGACA |
| 205. | TSC2-9R | CAGGAAACAGCTATGACCTGTGGATATTCTGTTGAACTGACAGA |
| 206. | TSC2-10RV2 | CAGGAAACAGCTATGACCCAAGCAGAAAGAGCAGAACTCCT |
| 207. | TSC2-11RV2 | CAGGAAACAGCTATGACCCATATTCCTGTCTGGGGCCTAA |
| 208. | TSC2-12R | CAGGAAACAGCTATGACCCTTGGCTTCTGAGGCTCAGAAA |
| 209. | TSC2-13RV2 | CAGGAAACAGCTATGACCTGGACACGCACCTCATAGAACT |
| 210. | TSC2-14R | CAGGAAACAGCTATGACCAATGAACAGGGGTAAACAGACCA |
| 211. | TSC2-15R | CAGGAAACAGCTATGACCTCACTCGAAGAGGAGGACAGA |
| 212. | TSC2-16R | CAGGAAACAGCTATGACCCAGACTCCAACACAACGCAGAT |
| 213. | TSC2-17R | CAGGAAACAGCTATGACCAAGCCACAGATGTGTGGACTG |
| 214. | TSC2-18R | CAGGAAACAGCTATGACCAACAGACTTGGCTCTTCCCAA |
| 215. | TSC2-19RV2 | CAGGAAACAGCTATGACCTTCAGCACCTTCCAGTCAGACT |
| 216. | TSC2-20R | CAGGAAACAGCTATGACCAAGTAACACACCAGGAATGTCAGGT |
| 217. | TSC2-21R | CAGGAAACAGCTATGACCAAGCAGAGCCAACTCACTCATC |
| 218. | TSC2-22R | CAGGAAACAGCTATGACCTTCTTCAAGGAGGAGCGTTCACAT |
| 219. | TSC2-23R | CAGGAAACAGCTATGACCACACGATGTACTGATTAAACCTGAGAT |
| 220. | TSC2-24R | CAGGAAACAGCTATGACCTGAGCACACCCAGACAGTGA |
| 221. | TSC2-25R | CAGGAAACAGCTATGACCATTTCCACTCACTGACTTGGAGG |
| 222. | TSC2-26R | CAGGAAACAGCTATGACCACAGAATGCAACCTTTCCACC |
| 223. | TSC2-27-28R | CAGGAAACAGCTATGACCTCCTTGGTCTGTCTCACATGCA |
| 224. | TSC2-29R | CAGGAAACAGCTATGACCTGAAAACCCGCAGGAAACAC |
| 225. | TSC2-30R | CAGGAAACAGCTATGACCAGTTACCCCCAAATATCCCAAGA |
| 226. | TSC2-31R | CAGGAAACAGCTATGACCTACTGCTTCTGAAGCTGCCAG |
| 227. | TSC2-32RV2 | CAGGAAACAGCTATGACCACATTCTGCACAGACGTCCTCAT |
| 228. | TSC2-33R | CAGGAAACAGCTATGACCAACATCTCCCCCAAGTTCAGA |
| 229. | TSC2-34R | CAGGAAACAGCTATGACCAACACGAAACTGCACAGGGA |
| 230. | TSC2-35-36R | CAGGAAACAGCTATGACCAATGAGCACTTCATGCTGTAGGG |
| 231. | TSC2-37R | CAGGAAACAGCTATGACCTGTTAGGCTCGGAACCTGAG |
| 232. | TSC2-38R | CAGGAAACAGCTATGACCCAGTCTGCACTTGCCAGTTACTC |
| 233. | TSC2-39-41R | CAGGAAACAGCTATGACCTTCCTCGCAGATCTGAAGGC |
| 234. | TSC2-42R | CAGGAAACAGCTATGACCTTCTGTGTACCACTTCTGTGGG |
| 235. | NPHP1-1F | TGTAAAACGACGGCCAGTAAGAGAACATTTGACCCTTCCC |
| 236. | NPHP1-2F | TGTAAAACGACGGCCAGTTTCTTTCCTAAGGCGATATGGTATTT |
| 237. | NPHP1-3F | TGTAAAACGACGGCCAGTTAATTGCCTTGCCTGCTCAA |
| 238. | NPHP1-4F | TGTAAAACGACGGCCAGTTCCCTAAGATAGGTGTAATGTCACACT |
| 239. | NPHP1-5F | TGTAAAACGACGGCCAGTGAAGTTACACTCATAGCTGGTCTGTTC |
| 240. | NPHP1-6F | TGTAAAACGACGGCCAGTGGTGAGTTAGGCAGAATACATAGGG |
| 241. | NPHP1-7F | TGTAAAACGACGGCCAGTGCAAAGTTATTAACCATGTGTTGAAAAT |
| 242. | NPHP1-8FV2 | TGTAAAACGACGGCCAGTATGGAGACAACTTGTACCTGGAGA |
| 243. | NPHP1-9F | TGTAAAACGACGGCCAGTGTATTATAGAGATGCAGAAACATGACTGAA |
| 244. | NPHP1-10F | TGTAAAACGACGGCCAGTGGAAGTGCCTGTACTCTAGTTCATAGC |
| 245. | NPHP1-11F | TGTAAAACGACGGCCAGTTTCATAAGCCGAATTCACAAAAGA |
| 246. | NPHP1-12F | TGTAAAACGACGGCCAGTCCTTGCCATCTTCCTCACTTAGT |
| 247. | NPHP1-13F | TGTAAAACGACGGCCAGTTACTAACAAATAGGGCTGAAACCCT |
| 248. | NPHP1-14F | TGTAAAACGACGGCCAGTCAAGAGACAATGGCAGCAGTTG |
| 249. | NPHP1-15F | TGTAAAACGACGGCCAGTTTGCCCAGATAGTACCTCATGGA |
| 250. | NPHP1-16F | TGTAAAACGACGGCCAGTCAATTCAGCACTACTGGGTGGTATAT |
| 251. | NPHP1-17F | TGTAAAACGACGGCCAGTACACAGGGTTGAGACTCGAAAGT |
| 252. | NPHP1-18F | TGTAAAACGACGGCCAGTATATGGGTATAGGGGCAAATGAAG |
| 253. | NPHP1-19F | TGTAAAACGACGGCCAGTTATCATGGGCTTCTACGGCAT |
| 254. | NPHP1-20aF | TGTAAAACGACGGCCAGTTCCATCCTACCTCTTAGGTGGCTT |
| 255. | NPHP1-20bF | TGTAAAACGACGGCCAGTTGAGAAAGTTGTATCACTTAATTCAGTCTG |
| 256. | NPHP1-1R | CAGGAAACAGCTATGACCTACAACCTGGGAAGGTAAGTAGGTT |
| 257. | NPHP1-2R | CAGGAAACAGCTATGACCTATGCATTGAAATGTAAGTGCGG |
| 258. | NPHP1-3R | CAGGAAACAGCTATGACCAAACCCAGGAACTTACCAACTTG |
| 259. | NPHP1-4R | CAGGAAACAGCTATGACCTTAGTTGACTGATTCTATTGTTAGTCTCAT |
| 260. | NPHP1-5R | CAGGAAACAGCTATGACCTAATACAGGTGTACAGGCAGAGTTTTC |
| 261. | NPHP1-6R | CAGGAAACAGCTATGACCCCCAGGACCATTAATACACAATGTT |
| 262. | NPHP1-7R | CAGGAAACAGCTATGACCGGTACAAGTTGTCTCCATTTCAAGA |
| 263. | NPHP1-8RV2 | CAGGAAACAGCTATGACCCAGGATCAATGAGAATGTTTCCAAG |
| 264. | NPHP1-9R | CAGGAAACAGCTATGACCCACTGTCATAGGAAGGATGAGGAA |
| 265. | NPHP1-10R | CAGGAAACAGCTATGACCATGTTGTTTGTCTAATTGCAACTATGAC |
| 266. | NPHP1-11R | CAGGAAACAGCTATGACCCCATGTAAGTACTGTTTAACCTGTATCTCA |
| 267. | NPHP1-12R | CAGGAAACAGCTATGACCATCTGTTCCCACATACTCTGTGCTAT |
| 268. | NPHP1-13R | CAGGAAACAGCTATGACCCATTCTCATTCCTCAAGGGATTAA |
| 269. | NPHP1-14R | CAGGAAACAGCTATGACCCATAGAACAAACCTGAGGTATCAAGAG |
| 270. | NPHP1-15R | CAGGAAACAGCTATGACCAGAATGTAGCTACCTCTCAGATGCTT |
| 271. | NPHP1-16R | CAGGAAACAGCTATGACCGAGTAGGTCACCAAGTGCTGAA |
| 272. | NPHP1-17R | CAGGAAACAGCTATGACCTCACAACCAGAAACAGAAGATACAAG |
| 273. | NPHP1-18R | CAGGAAACAGCTATGACCGAGGACTGAGTTACCTAGACAATGGATA |
| 274. | NPHP1-19R | CAGGAAACAGCTATGACCGATTAGAATAGGCAAGCAAACACC |
| 275. | NPHP1-20aR | CAGGAAACAGCTATGACCTCTCCAGTGCCTGAAAGTTTCTT |
| 276. | NPHP1-20bR | CAGGAAACAGCTATGACCCCCAGTTCTCACTTGTCACATTT |
| 277. | NPHP2-1F | TGTAAAACGACGGCCAGTACGTCGTCCGTCATCTAGAACTT |
| 278. | NPHP2-2F | TGTAAAACGACGGCCAGTCACTTGGAACTGATGAGACAGGTT |
| 279. | NPHP2-3FV2 | TGTAAAACGACGGCCAGTCAATGGTAATATCTACTTCTTAGGACAAG |
| 280. | NPHP2-4F | TGTAAAACGACGGCCAGTGGCCAGCCACTATGTAAATTATATTC |
| 281. | NPHP2-5F | TGTAAAACGACGGCCAGTTATAACAGTGCCTGTCCCACAATA |
| 282. | NPHP2-6F | TGTAAAACGACGGCCAGTGCTGCAGTGAGCTGTGATCAT |
| 283. | NPHP2-7F | TGTAAAACGACGGCCAGTCCGTTGTGAATGCTGTATTATGTTAG |
| 284. | NPHP2-8F | TGTAAAACGACGGCCAGTACAGAGGATTGTTATCTTCGATGG |
| 285. | NPHP2-9F | TGTAAAACGACGGCCAGTGGCAGAATTGTGTACATCATTTAAATC |
| 286. | NPHP2-10F | TGTAAAACGACGGCCAGTACCTCAAGTTCTACTCCTAGCTCCAC |
| 287. | NPHP2-11F | TGTAAAACGACGGCCAGTGTGTTAATTATGAGCTCTTGGATCAAA |
| 288. | NPHP2-12F | TGTAAAACGACGGCCAGTAACTGACATGGTTAGCAGCACAA |
| 289. | NPHP2-13F | TGTAAAACGACGGCCAGTAATATCTCCTGTGATGTAGTAGCTCCTC |
| 290. | NPHP2-14F | TGTAAAACGACGGCCAGTCTGCCACTATTATGGTGATGATATAGG |
| 291. | NPHP2-15F | TGTAAAACGACGGCCAGTAGCTTGAATGAACCTACCAGGAAT |
| 292. | NPHP2-16F | TGTAAAACGACGGCCAGTTCCACACCATACCTAACTTATCTTGAC |
| 293. | NPHP2-17F | TGTAAAACGACGGCCAGTCCCATATCTTGAGACTGCAGGA |
| 294. | NPHP2-1R | CAGGAAACAGCTATGACCGGATAAGTCATTGACTCATTCAACTGA |
| 295. | NPHP2-2R | CAGGAAACAGCTATGACCACTGTTTCATTCGAGATCTGTTAACATA |
| 296. | NPHP2-3RV2 | CAGGAAACAGCTATGACCTGTCCATTGCATAGTTCCACTAATC |
| 297. | NPHP2-4R | CAGGAAACAGCTATGACCGTGGTAATTCAGGCCTTCTTCCT |
| 298. | NPHP2-5R | CAGGAAACAGCTATGACCGGATGAGTCCATATGTCTGTTGTATTC |
| 299. | NPHP2-6R | CAGGAAACAGCTATGACCGGAAGGGAAGGCACAGAAATATT |
| 300. | NPHP2-7R | CAGGAAACAGCTATGACCATCATTAGAGTGAATTAGGTGTAGGAGTG |
| 301. | NPHP2-8R | CAGGAAACAGCTATGACCCATAATCATGTCTAAGGAGCAACCA |
| 302. | NPHP2-9R | CAGGAAACAGCTATGACCCTTCATCCTTGTACTTGTGCAGCT |
| 303. | NPHP2-10R | CAGGAAACAGCTATGACCTGGACAAATAATAGTCATGATTAATAGATG |
| 304. | NPHP2-11R | CAGGAAACAGCTATGACCGTGATCGTGCATGCCTGTAAT |
| 305. | NPHP2-12R | CAGGAAACAGCTATGACCGGTTGCAGGGACCAACAGTAAT |
| 306. | NPHP2-13R | CAGGAAACAGCTATGACCGCGGTCCTAGGTGCTAATATAACAAT |
| 307. | NPHP2-14R | CAGGAAACAGCTATGACCAATTGGCCTTACCATGCCAC |
| 308. | NPHP2-15R | CAGGAAACAGCTATGACCTGCACCAACCTAATTTATCTGAATG |
| 309. | NPHP2-16R | CAGGAAACAGCTATGACCGGAGACAGATGTTGGCTACAGTAATAAT |
| 310. | NPHP2-17R | CAGGAAACAGCTATGACCATCCTTGATACTGTAATACGGCTGTT |
| 311. | NPHP3-1FV2 | TGTAAAACGACGGCCAGTTATGTCGGAGCACCACTCCA |
| 312. | NPHP3-2F | TGTAAAACGACGGCCAGTCAACATGAAGTTCCTGATAATTGGTA |
| 313. | NPHP3-3F | TGTAAAACGACGGCCAGTGACATTCACCCTATGAAAGAGG |
| 314. | NPHP3-4F | TGTAAAACGACGGCCAGTTGAGATGATAACCAGAATTATGTTAATCAG |
| 315. | NPHP3-5F | TGTAAAACGACGGCCAGTTACTCTAGAAGGTATGGCAGTATTAACATG |
| 316. | NPHP3-6F | TGTAAAACGACGGCCAGTCCTAATACTGTCTCCTGTTGTTCTAGCT |
| 317. | NPHP3-7F | TGTAAAACGACGGCCAGTGGCACTTAGGTTGATTAACTAACTGC |
| 318. | NPHP3-8F | TGTAAAACGACGGCCAGTAAGTATTTACCACCACTTCCTTCTGA |
| 319. | NPHP3-9F | TGTAAAACGACGGCCAGTTTCTTGTAGGTATTATACAAAGGCTGTATG |
| 320. | NPHP3-10F | TGTAAAACGACGGCCAGTTCAGAAGTTGACTCTTCAGTAGTCTCAG |
| 321. | NPHP3-11F | TGTAAAACGACGGCCAGTAGTAACTGACCACCTGATTGCTCA |
| 322. | NPHP3-13F | TGTAAAACGACGGCCAGTCGTGTCCAGAGTTCAGATTGGT |
| 323. | NPHP3-14F | TGTAAAACGACGGCCAGTAGTATAAAGTGTTAATTCCTGTGGTGGA |
| 324. | NPHP3-15F | TGTAAAACGACGGCCAGTGGTAGTAAAGACCGCTTAATTCCAG |
| 325. | NPHP3-16F | TGTAAAACGACGGCCAGTCAGCATGTTTATTGCACTGAATTAA |
| 326. | NPHP3-17F | TGTAAAACGACGGCCAGTTTAATGGCCGTTAGTTACTTATACAGGT |
| 327. | NPHP3-18F | TGTAAAACGACGGCCAGTTGCAAATCTCTTGTTAGATGTACAGTG |
| 328. | NPHP3-19F | TGTAAAACGACGGCCAGTTGGTAAAGTCTCTGATTTTGACCTAACTT |
| 329. | NPHP3-20F | TGTAAAACGACGGCCAGTCCTCATTACAGAGTACTCGCCTACTAA |
| 330. | NPHP3-22F | TGTAAAACGACGGCCAGTGATGATCAGATGTCAGCTACTTAAAGG |
| 331. | NPHP3-23F | TGTAAAACGACGGCCAGTGAATGTGTTGCCATGTGGAAAT |
| 332. | NPHP3-24F | TGTAAAACGACGGCCAGTGATGAGTCAGTTCTCCACTTAATTTAGG |
| 333. | NPHP3-25F | TGTAAAACGACGGCCAGTTAAGCTGATAGGAAATGCTTCTGAG |
| 334. | NPHP3-26F | TGTAAAACGACGGCCAGTTGTGCTTACAGTATTGGATTATGGTC |
| 335. | NPHP3-27aF | TGTAAAACGACGGCCAGTGTCTGCTTGAGTGAATACACTGGA |
| 336. | NPHP3-27bF | TGTAAAACGACGGCCAGTTCAACAAGAGCTGGCAGAGTAGTTA |
| 337. | NPHP3-1R | CAGGAAACAGCTATGACCCGAAGAGAATATGGCCTCTCA |
| 338. | NPHP3-2R | CAGGAAACAGCTATGACCCAACTTTCCTGAATCCTACATGACTTAC |
| 339. | NPHP3-3R | CAGGAAACAGCTATGACCTTAGCAGCTGACAGAGAGAACACA |
| 340. | NPHP3-4R | CAGGAAACAGCTATGACCAACCTCATCCTTCCTTGTTAGTTACAG |
| 341. | NPHP3-5R | CAGGAAACAGCTATGACCCTCTCAATTCACCACCTTTCTTTACA |
| 342. | NPHP3-6R | CAGGAAACAGCTATGACCTATTTGGCAAACTCAATTCTATTTACAG |
| 343. | NPHP3-7R | CAGGAAACAGCTATGACCCGAGGTTCTTCACAATCAATGAG |
| 344. | NPHP3-8R | CAGGAAACAGCTATGACCCATGGTCCTAGTAATACTAAGAACATACCAC |
| 345. | NPHP3-9R | CAGGAAACAGCTATGACCTACAACATGGATAATCAAGCCATG |
| 346. | NPHP3-10R | CAGGAAACAGCTATGACCAAGGCAGGCATGCAATACATT |
| 347. | NPHP3-12R | CAGGAAACAGCTATGACCAATGCCTGCTCTAGCTATTACTGAAT |
| 348. | NPHP3-13R | CAGGAAACAGCTATGACCCCCATCCTCACTGCAAGTTACA |
| 349. | NPHP3-14R | CAGGAAACAGCTATGACCCATTAGTTTAAGAGGCAATACATTTACCA |
| 350. | NPHP3-15R | CAGGAAACAGCTATGACCAACAGACTGGTGTAGTGATCAGTTCTC |
| 351. | NPHP3-16R | CAGGAAACAGCTATGACCACAAGCACACTATGGCTATCAGC |
| 352. | NPHP3-17R | CAGGAAACAGCTATGACCTAGATAGGCATTAATCCATGAAAAGG |
| 353. | NPHP3-18R | CAGGAAACAGCTATGACCTGACATTAACAGAATAGGGAGAGGAT |
| 354. | NPHP3-19R | CAGGAAACAGCTATGACCTCCAGCTCTGATTTCATAAAGCA |
| 355. | NPHP3-21R | CAGGAAACAGCTATGACCTTACCACATGAAGACTAGGCACAG |
| 356. | NPHP3-22R | CAGGAAACAGCTATGACCGGGTGTATGCATTTATGATGCTC |
| 357. | NPHP3-23R | CAGGAAACAGCTATGACCAATAGCTTGAATGGGAGGTGGA |
| 358. | NPHP3-24R | CAGGAAACAGCTATGACCGAATCAAGAATCAATGTAACCAGTTCA |
| 359. | NPHP3-25R | CAGGAAACAGCTATGACCGGACCTTCATACAAGTCTAACTTCAATAGT |
| 360. | NPHP3-26R | CAGGAAACAGCTATGACCATGATGCATACATATGCTCCTCTG |
| 361. | NPHP3-27aR | CAGGAAACAGCTATGACCTGGAATGAACTGGCACAATCTC |
| 362. | NPHP3-27bR | CAGGAAACAGCTATGACCAACTACTGAGCAGCAAGTATTGACAA |
| 363. | NPHP4-1FV3 | TGTAAAACGACGGCCAGTAGCAGCATCTTCACCTCGTG |
| 364. | NPHP4-2F | TGTAAAACGACGGCCAGTCCAGCAACAAAGTCCACTCTTCT |
| 365. | NPHP4-3F | TGTAAAACGACGGCCAGTAGAAGCCTGTGTCTGTTCCAAG |
| 366. | NPHP4-4F | TGTAAAACGACGGCCAGTGTTGTTGGGTGCTCTGGAATAA |
| 367. | NPHP4-5F | TGTAAAACGACGGCCAGTTCAATTCTCAGGCTGCCTTG |
| 368. | NPHP4-6F | TGTAAAACGACGGCCAGTCTAACATTCTCTGTTAATTGGCTGG |
| 369. | NPHP4-7FV3 | TGTAAAACGACGGCCAGTGTTTGCAGATGGTTCAAGGTAAC |
| 370. | NPHP4-8F | TGTAAAACGACGGCCAGTGCACTCATCTTGACTAAGCATCATC |
| 371. | NPHP4-9F | TGTAAAACGACGGCCAGTTTGACTGTTCTGACAGTGGTCGA |
| 372. | NPHP4-10F | TGTAAAACGACGGCCAGTTGCTACACTGAGCTCTCGTTGAA |
| 373. | NPHP4-11F | TGTAAAACGACGGCCAGTTCCTGGTTGGATCGTTCTGATA |
| 374. | NPHP4-12F | TGTAAAACGACGGCCAGTGGCTCTAGATAGACAGCGACACTT |
| 375. | NPHP4-13F | TGTAAAACGACGGCCAGTCATGGAATCACCTCTCTGTCATTA |
| 376. | NPHP4-14-15 | TGTAAAACGACGGCCAGTCCTCCAGAGGCAATTAATCGA |
| 377. | NPHP4-16F | TGTAAAACGACGGCCAGTCAGGTCTTAGATCTTAGTGTAGCTCCA |
| 378. | NPHP4-17F | TGTAAAACGACGGCCAGTCAGAGCTGAAATCTCTTCCAAGTG |
| 379. | NPHP4-18F | TGTAAAACGACGGCCAGTACACGCTTGGCTAAGAGTCCTT |
| 380. | NPHP4-19F | TGTAAAACGACGGCCAGTGCTTATGTGGTGGGTTGATCTGT |
| 381. | NPHP4-20F | TGTAAAACGACGGCCAGTTCAGAACTCTGCAGATTGGAGCT |
| 382. | NPHP4-21-22F | TGTAAAACGACGGCCAGTTGAAGAGTCTCTCAGGAATAGGCA |
| 383. | NPHP4-23F | TGTAAAACGACGGCCAGTATCGCTTAAGGTGGACTTGAGAT |
| 384. | NPHP4-24F | TGTAAAACGACGGCCAGTAATAATGGCAGTGTGGCTGCT |
| 385. | NPHP4-25F | TGTAAAACGACGGCCAGTTCCTGTCCTATAGTGTGTAATGTGTGG |
| 386. | NPHP4-26F | TGTAAAACGACGGCCAGTTCGCTGCGTGTATTAGTCACAGA |
| 387. | NPHP4-27F | TGTAAAACGACGGCCAGTGACACTTGTCCAGGATGTGTGTT |
| 388. | NPHP4-28-29F | TGTAAAACGACGGCCAGTACAGTCATGTCAGGGTTGGTTGT |
| 389. | NPHP4-30F | TGTAAAACGACGGCCAGTTTCATGGTAATGTTAGACAGCTCA |
| 390. | NPHP4-1RV3 | CAGGAAACAGCTATGACCTAATGCCTGAGACCCAGATGCCTT |
| 391. | NPHP4-2R | CAGGAAACAGCTATGACCATCCATCTGTTAACTGGAAGCCT |
| 392. | NPHP4-3R | CAGGAAACAGCTATGACCCAGAGCAGAGCTCTCTCATCTGTT |
| 393. | NPHP4-4R | CAGGAAACAGCTATGACCCTTCTACTGCCACCATAAGACGA |
| 394. | NPHP4-5R | CAGGAAACAGCTATGACCGGTGACAGAGAGCTACTACTTCATCTG |
| 395. | NPHP4-6R | CAGGAAACAGCTATGACCAACTAGACTGCCATTCCATCCTC |
| 396. | NPHP4-7RV3 | CAGGAAACAGCTATGACCTAACATCTCAGGCCAACAGCA |
| 397. | NPHP4-8R | CAGGAAACAGCTATGACCTGGGTGAGTCAACACCTGACAT |
| 398. | NPHP4-9R | CAGGAAACAGCTATGACCAAGCATTCATGCCCACTACATT |
| 399. | NPHP4-0R | CAGGAAACAGCTATGACCCAGGAAATCAGTATGTGAACAGCA |
| 400. | NPHP4-11R | CAGGAAACAGCTATGACCATGCAATCTACGACGATTATCTTACA |
| 401. | NPHP4-12R | CAGGAAACAGCTATGACCCTTGCAAGTAATTGACTCTGGAATTC |
| 402. | NPHP4-13R | CAGGAAACAGCTATGACCTAACTAAGGACAGGCACAGTGCA |
| 403. | NPHP4-14-15R | CAGGAAACAGCTATGACCAATCTAGTAAGACCTCAGCACAGACAGT |
| 404. | NPHP4-16R | CAGGAAACAGCTATGACCCTGGTCACCGTATGATTCTAATGTT |
| 405. | NPHP4-17R | CAGGAAACAGCTATGACCTGGTAGGTCAGTTTGCAGGAGA |
| 406. | NPHP4-18R | CAGGAAACAGCTATGACCATGACCTCTAACCCCAATCAGAA |
| 407. | NPHP4-19R | CAGGAAACAGCTATGACCACCTCTCACACGCCATTCAT |
| 408. | NPHP4-20R | CAGGAAACAGCTATGACCGGAGGAAGGTAAGAGAGAATCATGT |
| 409. | NPHP4-21-22R | CAGGAAACAGCTATGACCGGAGACTGGAAGCATTCTCAATT |
| 410. | NPHP4-23R | CAGGAAACAGCTATGACCGCATTTCCGACCAGATACCAT |
| 411. | NPHP4-24R | CAGGAAACAGCTATGACCAATGCGCACCTAGTCATCTCA |
| 412. | NPHP4-25R | CAGGAAACAGCTATGACCAATGAAGAGGATCCCAGGATACC |
| 413. | NPHP4-26R | CAGGAAACAGCTATGACCAGCTTCATTCATGCTGTTCAGC |
| 414. | NPHP4-27R | CAGGAAACAGCTATGACCCCACAATGGCACATCTAACGAA |
| 415. | NPHP4-28-29R | CAGGAAACAGCTATGACCTGATTTGAGGAACTCGCTCCTAA |
| 416. | NPHP4-30R | CAGGAAACAGCTATGACCCTGCAACTACAGTGCCAGTGAA |
| 417. | PKHD1-1F | TGTAAAACGACGGCCAGTTTCGGGATGAAGAGTGAGAGACT |
| 418. | PKHD1-2F | TGTAAAACGACGGCCAGTTGGTGGCTCCATTTGAAGAC |
| 419. | PKHD1-3F | TGTAAAACGACGGCCAGTTGGTGATTCTGAGGCAGGTTA |
| 420. | PKHD1-4F | TGTAAAACGACGGCCAGTCACACTGTCCTGTGTCAATGACA |
| 421. | PKHD1-5F | TGTAAAACGACGGCCAGTTGCTGAAGGACCCAGTTCTTA |
| 422. | PKHD1-6F | TGTAAAACGACGGCCAGTGAACTAGACAGATGTGAGGGTGACAT |
| 423. | PKHD1-7F | TGTAAAACGACGGCCAGTTGACCTGCTTTGCCATATTGAG |
| 424. | PKHD1-8F | TGTAAAACGACGGCCAGTGTGTGAAAGCATGAGCCATGA |
| 425. | PKHD1-9FV2 | TGTAAAACGACGGCCAGTGTCAGATCTTCTGGTAGTGAGTTGTC |
| 426. | PKHD1-10F | TGTAAAACGACGGCCAGTTTATGAAAGCAATGGCCTGG |
| 427. | PKHD1-11F | TGTAAAACGACGGCCAGTATAGAGGTTAGTTCCCAATCTTCCT |
| 428. | PKHD1-12F | TGTAAAACGACGGCCAGTGCTGATACCATGAATGATTCCAC |
| 429. | PKHD1-13F | TGTAAAACGACGGCCAGTGTGACAACTTTCGCTATTCCATC |
| 430. | PKHD1-14F | TGTAAAACGACGGCCAGTAACTACTCTATCTGGCTCTAGGTTGACT |
| 431. | PKHD1-15F | TGTAAAACGACGGCCAGTTGTTGGTTCAGTGATTCAGGC |
| 432. | PKHD1-16F | TGTAAAACGACGGCCAGTCTTGATAGTAGCAGTTCAGACACTTAGTG |
| 433. | PKHD1-17-18F | TGTAAAACGACGGCCAGTATAGCAAGTTGAGGAGGAATGTCC |
| 434. | PKHD1-19F | TGTAAAACGACGGCCAGTAAGTCTTCTTGTGCCAACAACTT |
| 435. | PKHD1-20F | TGTAAAACGACGGCCAGTGATGTGGACTCCTCACTACGTATTG |
| 436. | PKHD1-21F | TGTAAAACGACGGCCAGTGCATGTCATGGATGAATGATTG |
| 437. | PKHD1-22F | TGTAAAACGACGGCCAGTGCAGCAGATAAGTAGGAATCTATGCT |
| 438. | PKHD1-23F | TGTAAAACGACGGCCAGTGATTCTCACATCGAGTGGTCCT |
| 439. | PKHD1-24F | TGTAAAACGACGGCCAGTGTATGTATCGTGTTATCCTTGAGGATG |
| 440. | PKHD1-25F | TGTAAAACGACGGCCAGTTGATTAGACGAGATTAGATTTCGGT |
| 441. | PKHD1-26F | TGTAAAACGACGGCCAGTGAATAAGAATTAGCGAATCATGAACAC |
| 442. | PKHD1-27F | TGTAAAACGACGGCCAGTATTCAGCATTCAGCTCCTTGAAT |
| 443. | PKHD1-28F | TGTAAAACGACGGCCAGTTCTGCCTGTATGGTTGGTGAT |
| 444. | PKHD1-29F | TGTAAAACGACGGCCAGTACTTGCCTACTAGTCCAAGCACTTAT |
| 445. | PKHD1-30-31F | TGTTAAACGACGGCCAGTTTAGAATTGAATAGATGGTTGAGCC |
| 446. | PKHD1-32aF | TGTAAAACGACGGCCAGTATTGAGGTTTCACTAACACATGCC |
| 447. | PKHD1-32bF | TGTAAAACGACGGCCAGTTCATAAGGGAAGAGGCAAGTCC |
| 448. | PKHD1-33F | TGTAAAACGACGGCCAGTAGTTGTGCGGATTCTGAGGAT |
| 449. | PKHD1-34F | TGTAAAACGACGGCCAGTGGAACTTCATTTGTGAAACCGA |
| 450. | PKHD1-35F | TGTAAAACGACGGCCAGTCACAAGCTAATGGCTTGCAAT |
| 451. | PKHD1-36F | TGTAAAACGACGGCCAGTGAGGATAGATCTGAGCACTTAGGAAG |
| 452. | PKHD1-37F | TGTAAAACGACGGCCAGTAGCAGCAGAGAATAGTAATAGCTAACCT |
| 453. | PKHD1-38F | TGTAAAACGACGGCCAGTTAGTGCTTACCTATCCTGAAGCTTG |
| 454. | PKHD1-39F | TGTAAAACGACGGCCAGTATTCCTAGTAAGATTTGGAGTGATGTC |
| 455. | PKHD1-40F | TGTAAAACGACGGCCAGTTGTCTGGAAGCATGTTCTACATG |
| 456. | PKHD1-41F | TGTAAAACGACGGCCAGTGGAGAATGTCTTTAGCTACAGTGTAGG |
| 457. | PKHD1-42-43F | TGTAAAACGACGGCCAGTGAAGTAGTGTTGCAGCATCTCTTGT |
| 458. | PKHD1-44F | TGTAAAACGACGGCCAGTTCCAGCAACCTTATCATACATGG |
| 459. | PKHD1-45F | TGTAAAACGACGGCCAGTCACAGATTCCATCTACCTTCATTCTC |
| 460. | PKHD1-46F | TGTAAAACGACGGCCAGTGATGCCTATACTGACATTGATGGAC |
| 461. | PKHD1-47F | TGTAAAACGACGGCCAGTTTGTCATATGTGTGATTGGCAA |
| 462. | PKHD1-48F | TGTAAAACGACGGCCAGTATCCTAAGACCATCACTCCAGTGA |
| 463. | PKHD1-49F | TGTAAAACGACGGCCAGTGCCTAAGACATATGTGGAGAGAATG |
| 464. | PKHD1-50F | TGTAAAACGACGGCCAGTAACTACTCCATCTGCGTTCTCTG |
| 465. | PKHD1-51F | TGTAAAACGACGGCCAGTTGGCTTCCTTAGAACATATGGCTA |
| 466. | PKHD1-52F | TGTAAAACGACGGCCAGTCAGAAGTGAAGGTAATCTAAGGATTGA |
| 467. | PKHD1-53F | TGTAAAACGACGGCCAGTTAGATAACACTGTACACAGCTCCCAA |
| 468. | PKHD1-54F | TGTAAAACGACGGCCAGTCTACTCTTATTTCATCTGCATGACCAT |
| 469. | PKHD1-55F | TGTAAAACGACGGCCAGTTTGGAGTCACGTAAGAGTGGAA |
| 470. | PKHD1-56F | TGTAAAACGACGGCCAGTGGATATGTTGGTCACAGTGGATT |
| 471. | PKHD1-57F | TGTAAAACGACGGCCAGTAAGCAGACCTTAATGTTGGTAGAACT |
| 472. | PKHD1-58F | TGTAAAACGACGGCCAGTAATACACAGAATCGTTAAACTTGGC |
| 473. | PKHD1-59F | TGTAAAACGACGGCCAGTGGCTATCCTGGATAGCTTTAACTAACT |
| 474. | PKHD1-60F | TGTAAAACGACGGCCAGTATGTTCAGTTGTTATGAGAGGAACAC |
| 475. | PKHD1-61F | TGTAAAACGACGGCCAGTGGATGCAATGTGGAAAGCAT |
| 476. | PKHD1-62F | TGTAAAACGACGGCCAGTGCACTCTCAGTATCTGGCACAATTA |
| 477. | PKHD1-63F | TGTAAAACGACGGCCAGTTCACTGGTAATAATGGATTGTGGA |
| 478. | PKHD1-64F | TGTAAAACGACGGCCAGTCCAACTTGTCTTGCAATAATTTCCT |
| 479. | PKHD1-65F | TGTAAAACGACGGCCAGTGAAGAACCTGATGGATTAGGTAACCT |
| 480. | PKHD1-66F | TGTAAAACGACGGCCAGTTGTGTTATTGTTGGAATCTTGTGATT |
| 481. | PKHD1-67F | TGTAAAACGACGGCCAGTCCATAAAGTTGGTGGTCAGTATATAGG |
| 482. | PKHD1-68aF | TGTAAAACGACGGCCAGTATCTTGTCAGAAATGCTAAGTATGCA |
| 483. | PKHD1-68bF | TGTAAAACGACGGCCAGTCAGTGATTCTCTCTGTTAGTAGCTGG |
| 484. | PKHD1-68cF | TGTAAAACGACGGCCAGTAGAGTTAGCTGCCAGCTCTGTTATT |
| 485. | PKHD1-1R | CAGGAAACAGCTATGACCGAACGTTAACAAGAGATACAACACCTAGA |
| 486. | PKHD1-2R | CAGGAAACAGCTATGACCATAGTTCTCAAGGTAACCTATTGTGTTCT |
| 487. | PKHD1-3R | CAGGAAACAGCTATGACCAGAAGTTGGTCAGTCTGTTCGTC |
| 488. | PKHD1-4R | CAGGAAACAGCTATGACCATACTCTCATCCTCCGTTAAGTTCTAGAC |
| 489. | PKHD1-5R | CAGGAAACAGCTATGACCAGACACGCTGGCTCATTTACAAT |
| 490. | PKHD1-6R | CAGGAAACAGCTATGACCACTCACCTAGGTTTGCAACAAGC |
| 491. | PKHD1-7R | CAGGAAACAGCTATGACCAGCAATTCTGTGCCAACTGCT |
| 492. | PKHD1-8R | CAGGAAACAGCTATGACCGTGTTGTATCCATGTGGACGAAC |
| 493. | PKHD1-9RV2 | CAGGAAACAGCTATGACCCTTCGAGTTAGATGGAGCACCA |
| 494. | PKHD1-10R | CAGGAAACAGCTATGACCACACAACTTCATTCACCCAGGTA |
| 495. | PKHD1-11R | CAGGAAACAGCTATGACCCAACATTGAGTGAGGCACAAG |
| 496. | PKHD1-12R | CAGGAAACAGCTATGACCCCTCATGCCATACAGACATATAATCTC |
| 497. | PKHD1-13R | CAGGAAACAGCTATGACCGAGAGCCTTGACAATGGTATCATG |
| 498. | PKHD1-14R | CAGGAAACAGCTATGACCCTTATCTGTCTCCTAGCCTCACCTA |
| 499. | PKHD1-15R | CAGGAAACAGCTATGACCTTCTTCATGGGTATGGGACTG |
| 500. | PKHD1-16R | CAGGAAACAGCTATGACCTTGACAGCAAGGTTATAATGACCC |
| 501. | PKHD1-17-18R | CAGGAAACAGCTATGACCTCAGCCACTCAGTGTCCAAAT |
| 502. | PKHD1-19R | CAGGAAACAGCTATGACCTTGAATCCAGAGAGCAATACCAATA |
| 503. | PKHD1-20R | CAGGAAACAGCTATGACCATATAAGACCATTAGTGCCTGAGGTG |
| 504. | PKHD1-21R | CAGGAAACAGCTATGACCGGAGTAAGAATACAGACACCAGAAGTAAG |
| 505. | PKHD1-22R | CAGGAAACAGCTATGACCCTGCATTCTCAAGATTGAGAACATT |
| 506. | PKHD1-23R | CAGGAAACAGCTATGACCTATTATCACCTGTCTGACAACCTCC |
| 507. | PKHD1-24R | CAGGAAACAGCTATGACCAGAATTTCTCCAGGGCAGCA |
| 508. | PKHD1-25R | CAGGAAACAGCTATGACCATCAGTGAGGAGTGAGTTAGACTTGA |
| 509. | PKHD1-26R | CAGGAAACAGCTATGACCCACTCAACCTCTGCCTAATGAACTA |
| 510. | PKHD1-27R | CAGGAAACAGCTATGACCACAGAAGGACTAGATTCCTATCAGCA |
| 511. | PKHD1-28R | CAGGAAACAGCTATGACCGATGTTAATTACAAGCTCCATTGGT |
| 512. | PKHD1-29R | CAGGAAACAGCTATGACCTGATTCGATGATGGCTAAGATGA |
| 513. | PKHD1-30-31R | CAGGAAACAGCTATGACCTCTGACCTCACTGGCAAATTAATC |
| 514. | PKHD1-32aR | CAGGAAACAGCTATGACCTAATCAGCACAGTGGTCAGAGAC |
| 515. | PKHD1-32bR | CAGGAAACAGCTATGACCCTTCCATCAGGCAGATTGTGTTA |
| 516. | PKHD1-33R | CAGGAAACAGCTATGACCTAACAGGTGGCCTCAGATTCTAAC |
| 517. | PKHD1-34R | CAGGAAACAGCTATGACCCTACACTCTCTGATGGCTCCATC |
| 518. | PKHD1-35R | CAGGAAACAGCTATGACCTGTGCATTAGACCAGCTTCTCAA |
| 519. | PKHD1-36RV2 | CAGGAAACAGCTATGACCCCTCTGACCACTTCTTCCTTTACATAG |
| 520. | PKHD1-37R | CAGGAAACAGCTATGACCCATGCTCTAACTGACCTGGTTG |
| 521. | PKHD1-38R | CAGGAAACAGCTATGACCCCAATACAGTTAAGATCTCATCTTCTTC |
| 522. | PKHD1-39R | CAGGAAACAGCTATGACCCAACCACAGCAATGCCATCTA |
| 523. | PKHD1-40R | CAGGAAACAGCTATGACCTTCCTAAGCCTACCTTAGACCAGAAT |
| 524. | PKHD1-41R | CAGGAAACAGCTATGACCAGTAAGCCAATCAGTGATGACTACAT |
| 525. | PKHD1-42-43R | CAGGAAACAGCTATGACCCCTCTCAGTTCTGGTCTTCCTG |
| 526. | PKHD1-44R | CAGGAAACAGCTATGACCAGTGCTCTCATTGTGAGCATTCTA |
| 527. | PKHD1-45R | CAGGAAACAGCTATGACCCCTGGATTAGTGACTAGGAATTTGT |
| 528. | PKHD1-46R | CAGGAAACAGCTATGACCACTTAGGCACATATTAGTGAATCACATAC |
| 529. | PKHD1-47R | CAGGAAACAGCTATGACCGGAGAACCTCCAGGATGTCTTT |
| 530. | PKHD1-48R | CAGGAAACAGCTATGACCACTACCATACACTCATGATTCAGCA |
| 531. | PKHD1-49R | CAGGAAACAGCTATGACCCAATAACGAGATAACCTGCTCCTC |
| 532. | PKHD1-50R | CAGGAAACAGCTATGACCGTCTGGAATTGAAGGGTGATTG |
| 533. | PKHD1-51R | CAGGAAACAGCTATGACCATTAACAGTATGACAAGGTGGAATTTG |
| 534. | PKHD1-52R | CAGGAAACAGCTATGACCAACATAATCAGATCTGGCTGGGT |
| 535. | PKHD1-53R | CAGGAAACAGCTATGACCACTCTGTTAAGCAACCTGCTTGAT |
| 536. | PKHD1-54R | CAGGAAACAGCTATGACCTACTCACAAGAGAGCTGGTAAGTGAA |
| 537. | PKHD1-55R | CAGGAAACAGCTATGACCTTCTTTACTGCCTCCAATGCAT |
| 538. | PKHD1-56R | CAGGAAACAGCTATGACCCCTCTGAATGGCAATCAGATC |
| 539. | PKHD1-57R | CAGGAAACAGCTATGACCCACTGATAATTAAGCACAGATTAGGACTG |
| 540. | PKHD1-58R | CAGGAAACAGCTATGACCCATTGTGGCTATCAATACTCAGCAG |
| 541. | PKHD1-59R | CAGGAAACAGCTATGACCATCACATGGCTGAGTCCAGATT |
| 542. | PKHD1-60R | CAGGAAACAGCTATGACCCAGATTAGCACAGACTCCAACTCTAG |
| 543. | PKHD1-61R | CAGGAAACAGCTATGACCACCTGCCTTGACAACTCACATT |
| 544. | PKHD1-62R | CAGGAAACAGCTATGACCTGCAACATATGTCAATATGGACCT |
| 545. | PKHD1-63R | CAGGAAACAGCTATGACCGTGAAAGTACTCAGAAGCTCTAAGTGC |
| 546. | PKHD1-64R | CAGGAAACAGCTATGACCCAGTCCATGATACTATACCAAACAAGG |
| 547. | PKHD1-65R | CAGGAAACAGCTATGACCTCAAGCTTAATGATACAGTCAAGTGAAT |
| 548. | PKHD1-66R | CAGGAAACAGCTATGACCATTACTTAAGATTAGGCAATCCTTGTCTC |
| 549. | PKHD1-67R | CAGGAAACAGCTATGACCTGGTGAATAGCTGAGTGAACCAG |
| 550. | PKHD1-68aR | CAGGAAACAGCTATGACCAATGTATCAATACCAGGTGAGCCTT |
| 551. | PKHD1-68bR | CAGGAAACAGCTATGACCACTGGTCTTGTGACACATAGAGGATAA |
| 552. | PKHD1-68cR | CAGGAAACAGCTATGACCGGACTGATAAGAGATAATGTATGGACAAT |
| 553. | SEC63-1F | TGTAAAACGACGGCCAGTAATTAATCCAGAGGGCAGGACAG |
| 554. | SEC63-2F | TGTAAAACGACGGCCAGTTAAGCGTGGTAATGAAGGTTAGTTAAC |
| 555. | SEC63-3F | TGTAAAACGACGGCCAGTGAGTCAGTAGCATAGTGATATGGTACTACTG |
| 556. | SEC63-4F | TGTAAAACGACGGCCAGTATTACAGGCTGTGCCTGGCCTA |
| 557. | SEC63-5F | TGTAAAACGACGGCCAGTATGAGTTGGTTGGCTAATGGAG |
| 558. | SEC63-7F | TGTAAAACGACGGCCAGTTATGTAACCCATGTGTACTGCAGGT |
| 559. | SEC63-8F | TGTAAAACGACGGCCAGTCAGGCTGGTCTCAAACTCCT |
| 560. | SEC63-9F | TGTAAAACGACGGCCAGTTCAAGTGAATTAAGTATCTCAGGAGG |
| 561. | SEC63-11F | TGTAAAACGACGGCCAGTGGCCACAGTGATAAAGATGCTT |
| 562. | SEC63-12F | TGTAAAACGACGGCCAGTGTGATGAATTGTATACTCCTGAACATG |
| 563. | SEC63-13F | TGTAAAACGACGGCCAGTAAGCTTTGTGAGTTAGGGAATTATGTAT |
| 564. | SEC63-14F | TGTAAAACGACGGCCAGTGAGAGCCTTATACAGAGTAGTCAATCAGT |
| 565. | SEC63-15F | TGTAAAACGACGGCCAGTACGTCTCCTTCTTTGTCAATTGTAGC |
| 566. | SEC63-17F | TGTAAAACGACGGCCAGTGATTCAGATTGATATGTTCTCATTGAGATA |
| 567. | SEC63-18F | TGTAAAACGACGGCCAGTCGGCTATGTAGTTGATACTACAGTGGT |
| 568. | SEC63-19F | TGTAAAACGACGGCCAGTTTGTACCAAGCAGTTTGTCAGTG |
| 569. | SEC63-20F | TGTAAAACGACGGCCAGTGGCTGTTAAATACTGTGGTCTAGGAAT |
| 570. | SEC63-21aF | TGTAAAACGACGGCCAGTGATATGACTCAGTGTTCTTGCTCAAGA |
| 571. | SEC63-21bF | TGTAAAACGACGGCCAGTCAAGTTGATAATCTCTTGATAAGCTCTG |
| 572. | SEC63-1R | CAGGAAACAGCTATGACCACAATGAAGGGAGGTGGAGAAG |
| 573. | SEC63-2R | CAGGAAACAGCTATGACCGACACAATGACTTATTCATCATTACACG |
| 574. | SEC63-3R | CAGGAAACAGCTATGACCATTATTAATAACATAACAATCAACAGTTATAGC |
| 575. | SEC63-4R | CAGGAAACAGCTATGACCTGGAGTATTACTGTCATCGAAGTTGG |
| 576. | SEC63-6R | CAGGAAACAGCTATGACCGTTCTTCTTGTATTACCAAGACAGATTG |
| 577. | SEC63-7R | CAGGAAACAGCTATGACCGGATCAATGGGTTATATTCTAACATACA |
| 578. | SEC63-8R | CAGGAAACAGCTATGACCTGCACGCATAAGGATTATGGTA |
| 579. | SEC63-10R | CAGGAAACAGCTATGACCCCATCAGAACAATGAGCCAA |
| 580. | SEC63-11R | CAGGAAACAGCTATGACCAAGTACAATCTGCATATGCTTGCA |
| 581. | SEC63-12R | CAGGAAACAGCTATGACCATGTTAACAGAACCACCTGAGAGAA |
| 582. | SEC63-13R | CAGGAAACAGCTATGACCCAGACTTCATCCCATTATGAGGATAAT |
| 583. | SEC63-14R | CAGGAAACAGCTATGACCCACAGCTCAAGAACTATATCCACATTAC |
| 584. | SEC63-16R | CAGGAAACAGCTATGACCGAAGCTGTACACGTAAGACTTGAACA |
| 585. | SEC63-17R | CAGGAAACAGCTATGACCTCTGTATAACCTTGACTACCATTCCTTA |
| 586. | SEC63-18R | CAGGAAACAGCTATGACCCACCATTACACATAACACTCAGTAATCAG |
| 587. | SEC63-19R | CAGGAAACAGCTATGACCGATATATGAAGCAGCATGATGGTG |
| 588. | SEC63-20R | CAGGAAACAGCTATGACCAAGAACCCATTTGCTGAGGC |
| 589. | SEC63-21aR | CAGGAAACAGCTATGACCATCCTGCATTGATCTGCTAAGATAGA |
| 590. | SEC63-21bR | CAGGAAACAGCTATGACCTCTCACTAAACTGGTGATTGAGGTTATAG |

### Example 8

TABLE 11
Location of Sequences within the database sequences¹ used to design
the 40-80-mer oligonucleotides for forming the CGH arrays

| | UCSC Genome | | | |
|---|---|---|---|---|
| | Browser | | | |
| | hg18 | | +/− | Range according to |
| Gene | Ref Gene | chr | Strand | UCSC site* |
| pkd1 | NM_001009944 | 16 | − | 2078712-2125900 |
| pkd2 | NM_000297 | 4 | + | 89147844-89217952 |
| pkhd1 | NM_138694 | 6 | − | 51588104-52060382 |
| tsc1 | NM_000368 | 9 | − | 134756558-134809841 |
| tsc2 | NM_000548 | 16 | + | 2037991-2078713 |
| nphp1 | NM_000272 | 2 | − | 110237195-110319883 |
| nphp2 | NM_014425 | 9 | + | 101901332102103247 |
| nphp3 | NM_153240 | 3 | − | 133882144-133923966 |
| nphp4 | NM_015102 | 1 | − | 5845457-5975118 |
| umod | NM_003361 | 16 | − | 20251875-20271538 |
| prkcsh | NM_002743 | 19 | + | 11407269-11422780 |
| sec63 | NM_007214 | 6 | − | 108298216-108386086 |

¹PKD1 (GenBank Accession No: NM001009944), PKD2 (GenBank Accession No: NM000297), PKHD1 (GenBank Accession No: NM138694), TSC1 (GenBank Accession No: NM000368), TSC2 (GenBank Accession No: NM000548), PRKCSH (GenBank Accession No: NM002743), UMOD (GenBank Accession No: NM003361), NPHP1 (GenBank Accession No: NM000272), NPHP2 (GenBank Accession No: NM014425), NPHP3 (GenBank Accession No: NM153240), NPHP4 (GenBank Accession No: 015102), and SEC63 (GenBank Accession No: NM007214).

### Example 9

For the probes designed for attachment to the CGH arrays, spacing was measured start-to-start and the mean probe spacing for exons was 1 bp, (median 2 bps), while for introns mean spacing was 9 bps. Mean probe spacing for background coverage was 4052 bps. The design consisted of probes unique to the HG18 genomic sequence (source: UCSC Genome Browser).

Each new patient sample is studied by PCR amplification of exons from genes associated with polycystic diseases followed by sequencing analysis of the entire coding region. For any familial cases, the entire coding sequence was analyzed on one affected individual first. If a mutation is found for the proband, only the specific familial mutation (one exon or PCR product) is tested by sequencing for rest of the family member(s). Positive results are confirmed by sequencing analysis starting with the original blood in order to assure reproducibility/reliability.

### Preparation of Stock PCR Primers Solutions

Each primer is delivered as lyophilized powder. Primer solutions were prepared to 100 μM stock concentration: Working stocks are made by aliquoting into 80 μl of TE, 10 μl of 100 μM Forward and 10 ml of 100 μM Reverse primer into labeled strip tubes and freeze.

Once primers have been thawed, they are stable in the fridge for 1 week. Primers are not refrozen.

### Reagents, Supplies and Equipment

### PCR Reagents and Supplies:

Faststart Polymerase, Roche, Cat#2032953; PCR primers: The lyophilized oligonucleotide is stable in the freezer for at least 1-3 years. The oligonucleotide dissolved in TE is stable for at least 1 year in the freezer or 1 week in the fridge. Oligonucleotide will degrade significantly once it undergo more than 5 freeze/thaw cycles.

### Reagents and Supplies:

Klenow Fragment; Cy3 labeled random 9-mers, Trilink Biotech Cat#N46-0001-50; Cy5 labeled random 9-mers, Trilink Biotech Cat#N46-0002-50; Male Genomic DNA, Promega, Cat#PR-G1471; Female Genomic DNA, Promega, Cat#PR-G1521; 0.5M EDTA; Absolute Ethanol; 100 mM dNTP's; 1M Tris HCl pH7.4; 1M MgCl₂; Beta-Mercaptethanol; 5M NaCl; Isopropanol; Cy3 and Cy5 CPK6 50mers; Nimblegen Hybridization Kit, Nimblegen, Cat#KIT005-02; PCR primers, Trilink; Primer stability: The lyophilized oligonucleotide is stable in the freezer for at least 1-3 years. Oligonucleotide will degrade significantly once it undergo more than 5 freeze/thaw cycles.

### PCR Set Up

A WT and water control should be included for each exon or primer pair. The water control should give no amplified product; Dilute genomic DNA to be tested to 25 ng/μl with HPLC water; Vortex to mix well.

| | |
|---|---|
| 1× | 27× |

| | | | | |
|---|---|---|---|---|
| dH₂O | 39.6 | μl | 1069.2 | μl |
| 10 × PCR buffer + Mg²⁺ | 5 | μl | 135 | μl |
| dNTP | 1 | μl | 27 | μl |
| Forward primer (10 μM) | 1 | μl | 27 | μl |
| Reverse primer (10 μM) | 1 | μl | 27 | μl |
| Faststart Taq (5 U/ml) | 0.4 | μl | 10.8 | μl |
| DNA (25 mg/ml) | 2 | μl | 54 | μl |
| Total | 50 | μl | 1350 | μl |

### Program: Stepdown

Step 1: 95° C., 5 mins; Step 2: 95° C., 1 min; Step 3: 60° C., 1 min, −0.5° C./cycle×10; Step 4: 72° C., 1 min; Step 5: 94° C., 1 min; Step 6: 55° C., 1 min, ×25; Step 7: 72° C., 1 min; Step 8: 72° C., 7 mins; Step 9: 4° C., hold

### Array Setup—Labeling and Hybridization

The methods were according to Nimblegen Inc CGH protocols. Patient samples are labeled with Cy3 dye. Combine 1 mg in 40 ml of pooled. PCR product with 40 ml of Cy3 labeled 9 mer wobble primers. Two reactions are done for each patient as the efficiency of 9 mer wobble primers are reduced when using PCR products as template. Denature sample in a PCR machine for 10 minutes at 98° C. Cool on wet ice for 1 minute. Add 20 ml of Klenow reaction master mix (1× concentration: HPLC Water, 8 ml; 50×dNTP Mix, 10 ml; Klenow (50 U/ml, 2 ml) to each tube. Incubate in PCR machine for 2 hours at 37° C. Stop Klenow reaction by addition of 10 ul of 0.5M EDTA and precipitate the labeled DNA using 5M NaCl 11.5 ml Isopropanol, 11 ml. Vortex each sample gently and place in the dark at room temperature for 10 minutes; centrifuge at maximum (min 12,000 g) for 10 minutes; rinse pallet with 500 ul of ice cold 80% ethanol. Centrifuge at maximum for 2 minutes; remove supernatant and speed vacuum on low heat for 5 minutes or until dry. Rehydrate dried pallet with 20 ul HPLC water. Resuspend with gentle flicking. Measure OD₂₆₀ using 1 ul of product on the nanodrop. Use 5 μg of patient. Dry content in a speed vacuum on low heat until dry. Once products are dry resuspend product with the following: Cy labeled combined sample: 11.2 ml; 2× Hybridization Buffer, 19.5 ml; Hybridization Component A, 7.8 ml; Cy 3 CPK6 50 mer Oligo, 50 nM, 0.4 ml.

Denature at 95° C. for 5 mins and load on array with Maui SL lid attached. Incubate sealed array in the Maui hybridization station set at 42° C., mixing motion B for 16 to 20 hours.

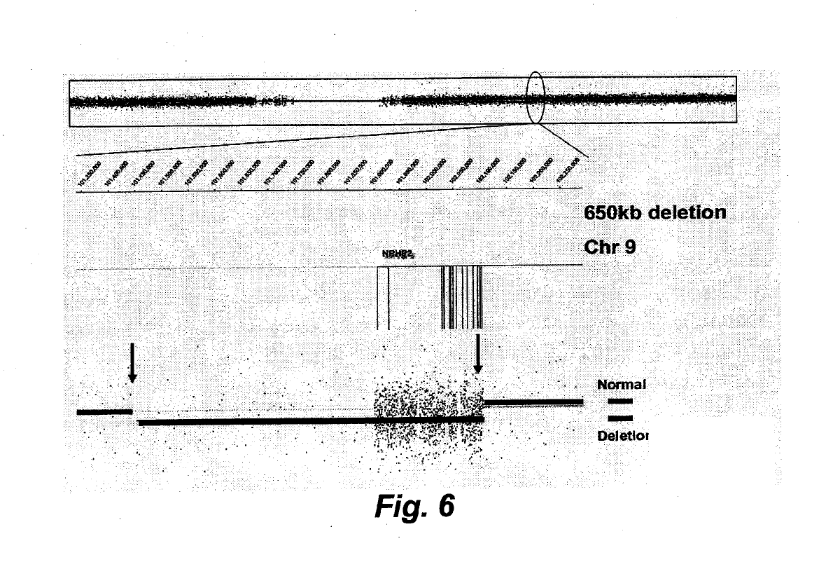

After incubation, array is disassembled and washed three times with: Water, 225 ml; ×10 wash buffer (Nimbelgen), 25 ml; 1M DTT, 25 ml by pealing off SL Lids while slide is in the assembly jig and immerse in wash, transfer to slide rack in 2nd wash and incubate with agitation for 2 mins, transfer to wash 2 and incubate with agitation for 1 min; transfer to wash 3 and incubate with agitation for 15 secs, spin dry in array drying unit for 1 min and store dried array in dark desiccator and proceed to scan immediately. A typical array scan is shown, for example, in FIG. 6.

### Scanning

The Nimblegen quick guide to scanning and Nimblegen Scanning protocol and data analysis using Nimblescan v2 were followed, after which scanning images were subject to ABACUS analysis.

What is claimed is:

1. An array for the detection of genetic variation associated with a polycystic disease or a plurality of polycystic diseases comprising: a plurality of nucleic acid segments, wherein each nucleic acid segment is immobilized to a discrete and known spot on a substrate surface to form an array of nucleic acids, and each spot comprises a segment of a nucleic acid sequence associated with a polycystic disease, wherein the unique polynucleotide sequences allow identification of one or more of the following: SNPs, deletions, duplications, and mutations.

2. The array of claim 1, wherein the nucleic acid sequences associated with a polycystic disease are derived from human genes selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease).

3. The array of claim 2, wherein the nucleic acid sequences associated with a polycystic disease are selected from the group consisting of PKD1 (GenBank Accession No: NM001009944), PKD2 (GenBank Accession No: NM000297), PKHD1 (GenBank Accession No: NM138694), TSC1 (GenBank Accession No: NM000368), TSC2 (GenBank Accession No: NM000548), PRKCSH (GenBank Accession No: NM002743), UMOD (GenBank Accession No: NM003361), NPHP1 (GenBank Accession No: NM000272), NPHP2 (GenBank Accession No: NM014425), NPHP3 (GenBank Accession No: NM153240), NPHP4 (GenBank Accession No: 015102), and SEC63 (GenBank Accession No: NM007214).

4. The array of claim 3, wherein the nucleic acid segments are derived from the nucleic acid sequences shown in Table 8 or Table 9.

5. The array of claim 3, wherein the nucleic acid segments are derived from the nucleic acid sequences shown in Table 8.

6. The array of claim 3, wherein the nucleic acid segments are derived from the nucleic acid sequences shown in Table 9.

7. The array of claim 1, wherein the nucleic acid segments are between about 20 and about 80 nucleotides in length.

8. The array of claim 1, wherein the nucleic acid segments associated with PKD1 were derived from the cDNA sequence having GenBank Accession No: NM001009944.

9. The array of claim 1, wherein the array has nucleic acid segments derived from a plurality of genes associated with polycystic diseases, and wherein the genes are selected from the group consisting of PKD1 cDNA, PKD2, PKHD1, TSC1, TSC2, PRKCSH, UMOD, NPHP1, NPHP2, NPHP3, NPHP4, and SEC63.

10. The array of claim 7, wherein the plurality of genes comprises the group PKD1, PKD2, PRKCSH, and UMOD.

11. The array of claim 1, wherein the array is distributed on a single substrate surface.

12. The array of claim 1, further comprising at least one spot comprising a nucleic acid segment acting as a negative control.

13. The array of claim 1, wherein the array-immobilized genomic nucleic acid segments in a first spot are non-overlapping in sequence compared to the array-immobilized genomic nucleic acid segments in a second spot.

14. The array of claim 4, wherein the array-immobilized genomic nucleic acid segments in the first spot are non-overlapping in sequence compared to the array-immobilized genomic nucleic acid segments in all other genomic nucleic acid-comprising spots on the array.

15. The array of claim 1, wherein at least one genomic nucleic acid segment is spotted in duplicate or triplicate on the array.

16. The array of claim 1, wherein the duplicate spot or triplicate spot has a different amount of nucleic acid segments immobilized.

17. The array of claim 6, wherein all the genomic nucleic acid segments are spotted in duplicate or triplicate on the array.

18. The array of claim 1, wherein at least 95% of the array-immobilized genomic nucleic acid segments comprise a label.

19. A method for screening a host for at polycystic disease, comprising: detecting a polynucleotide sequence having intronic and/or exonic variation in a gene associated with a polycystic disease comprising contacting a nucleic acid sample isolated from a patient with an array of nucleic acids derived from a plurality of genes associated with a polycytic disease, wherein the plurality of genes are selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease).

20. The method according to claim 19, comprising:
isolating a nucleic acid from a patient;
synthesizing a cDNA using the isolated nucleic acid;
hybridizing the cDNA to a resequencing array comprising fragments of a plurality of genes associated with polycystic diseases;
identifying variations in the sequences of the cDNAs compared to the sequences of the corresponding genes attached to the array; and
determining if the sequence variations are correlated to a polycystic disease, thereby identifying the patient as either having the disease or capable of having the disease.

21. The method according to claim 19, further comprising:
amplifying regions of a nucleic acid sample from a patient;
hybridizing the amplified nucleic acid to an array comprising a plurality of nucleotide regions of a plurality of target genes associated with at least one polycystic disease; and
identifying whether the nucleic acid of the patient has an insertion or deletion within at least one of the target genes when compared to the target genes of the array, thereby determining if the sequence variations are correlated to a polycystic disease, thereby identifying the patient as either having the disease or capable of having the disease.

22. The method according to claim 19, wherein detection of the variation in the 22^{nd} intron of PKD1 in a biological sample from a host indicates disease severity in ADPKD, wherein disease severity is defined as renal and cyst volume measured by MR after adjusting for age, gender, race, hypertension, and number of SNPs analyzed.

23. The method of claim 1, wherein the host is a human embryo, a human fetus, a human newborn, a human infant, or a human adult.

24. A kit for detecting a genetic variation in a gene associated with a polycystic disease comprising a resequencing array for detecting a polymorphism in a nucleic acid sequence associated with a polycystic disease are derived from human genes selected from the group consisting of PKD1 (polycystic kidney disease 1), PKD2 (polycystic kidney disease 2), PKHD1 (polycystic kidney and hepatic disease 1), TSC1 (tuberous sclerosis 1), TSC2 (tuberous sclerosis 2), NPHP1 (nephronophthisis 1), NPHP2 (nephronophthisis 2), NPHP3 (nephronophthisis 3), NPHP4 (nephronophthisis 4), PRKCSH (medullary cystic kidney disease type 1), UMOD (autosomal dominant medullary cystic kidney disease type 2), and SEC63 (autosomal dominant inherited polycystic liver disease), and instructions for the use thereof.


SEQUENCE LISTING (591 sequences)

SEQ ID NO: 1 - DNA, 20 bp, Artificial Sequence
  Primer Sequence PKD1-1F
ctcagcagcaggtcgcggcc

SEQ ID NO: 2 - DNA, 22 bp, Artificial Sequence
  Primer Sequence PKD1-1R
aggcactggagggctgggccgc

SEQ ID NO: 3 - DNA, 23 bp, Artificial Sequence
  Primer Sequence PKD1-2F
cagggctggtgcctgtgtggggc

SEQ ID NO: 4 - DNA, 24 bp, Artificial Sequence
  Primer Sequence PKD1-2R
ggcctgggggtggcaagaggcgtc

SEQ ID NO: 5 - DNA, 20 bp, Artificial Sequence
  Primer Sequence PKD1-3F
ggacgcctcctgccaccccc

SEQ ID NO: 6 - DNA, 24 bp, Artificial Sequence
  Primer Sequence PKD1-3R
ctggcacgggtgggggcggcttcc

SEQ ID NO: 7 - DNA, 21 bp, Artificial Sequence
  Primer Sequence PKD1-4F
aagccgcccccacccgtgcca

SEQ ID NO: 8 - DNA, 26 bp, Artificial Sequence
  Primer Sequence PKD1-4R
ctccaggcagtccagctgtaggagac

SEQ ID NO: 9 - DNA, 19 bp, Artificial Sequence
  Primer Sequence PKD1-5F
gggatggcaccaacgtctc

SEQ ID NO: 10 - DNA, 26 bp, Artificial Sequence
  Primer Sequence PKD1-5R
cctccaagtagttgcgctgtgatcgc

SEQ ID NO: 11 - DNA, 21 bp, Artificial Sequence
  Primer Sequence PKD1-6F
agcgcaactacttggaggccc

SEQ ID NO: 12 - DNA, 19 bp, Artificial Sequence
  Primer Sequence PKD1-6R
accacaacggagttggcgg

SEQ ID NO: 13 - DNA, 23 bp, Artificial Sequence
  Primer Sequence PKD1-7F
cagctccgccaactccgccaact

SEQ ID NO: 14 - DNA, 24 bp, Artificial Sequence
  Primer Sequence PKD1-7R
ggacaggagccacgcaacactcac

SEQ ID NO: 15 - DNA, 20 bp, Artificial Sequence
  Primer Sequence PKD1-8F
aggcagcgaggctgtccagg

SEQ ID NO: 16 - DNA, 23 bp, Artificial Sequence
  Primer Sequence PKD1-8R
gcagcctgcgcaggaacaactcc

SEQ ID NO: 17 - DNA, 24 bp, Artificial Sequence
  Primer Sequence PKD1-9F
cctctcgctgcctctgctcacctc

SEQ ID NO: 18 - DNA, 24 bp, Artificial Sequence
  Primer Sequence PKD1-9R
ataacgccaccacacctaccaagc

SEQ ID NO: 19 - DNA, 44 bp, Artificial Sequence
  Primer Sequence UMOD-1F
tgtaaaacgacggccagtcagaactagagactaattggaggaga

SEQ ID NO: 20 - DNA, 42 bp, Artificial Sequence
  Primer Sequence UMOD-2F
tgtaaaacgacggccagttacaatcaaagcactccttccagc

SEQ ID NO: 21 - DNA, 42 bp, Artificial Sequence
  Primer Sequence UMOD-3F
tgtaaaacgacggccagtataatgagttccctggagaatgag

SEQ ID NO: 22 - DNA, 44 bp, Artificial Sequence
  Primer Sequence UMOD-4F
tgtaaaacgacggccagtgctactacgtctacaacctgacagcg

SEQ ID NO: 23 - DNA, 40 bp, Artificial Sequence
  Primer Sequence UMOD-5F
tgtaaaacgacggccagtctatgctgagcacttccagatg

SEQ ID NO: 24 - DNA, 39 bp, Artificial Sequence
  Primer Sequence UMOD-6F
tgtaaaacgacggccagtggctcacaagtagccagacat

SEQ ID NO: 25 - DNA, 38 bp, Artificial Sequence
  Primer Sequence UMOD-7F
tgtaaaacgacggccagtttgcaaagcaacagttggtg

SEQ ID NO: 26 - DNA, 42 bp, Artificial Sequence
  Primer Sequence UMOD-8F
tgtaaaacgacggccagtgtgacagagcaatatttgaatcca

SEQ ID NO: 27 - DNA, 46 bp, Artificial Sequence
  Primer Sequence UMOD-9F
tgtaaaacgacggccagttatacaggtctcctaacaacttctgcct

SEQ ID NO: 28 - DNA, 41 bp, Artificial Sequence
  Primer Sequence UMOD-10F
tgtaaaacgacggccagtggttttgaagagatcagtctggc

SEQ ID NO: 29 - DNA, 41 bp, Artificial Sequence
  Primer Sequence UMOD-11F
tgtaaaacgacggccagtcagagagggtgtcctcttctgat

SEQ ID NO: 30 - DNA, 44 bp, Artificial Sequence
  Primer Sequence UMOD-1R
caggaaacagctatgaccagaataatgactcaaatccaggtctg

SEQ ID NO: 31 - DNA, 42 bp, Artificial Sequence
  Primer Sequence UMOD-2R
caggaaacagctatgaccctctgacaggtgctacattgcttc

SEQ ID NO: 32 - DNA, 43 bp, Artificial Sequence
  Primer Sequence UMOD-3R
caggaaacagctatgaccgacagacagacaatcaataaggacg

SEQ ID NO: 33 - DNA, 47 bp, Artificial Sequence
  Primer Sequence UMOD-4R
caggaaacagctatgaccattagtggatcttctgttttcactcaggt

SEQ ID NO: 34 - DNA, 45 bp, Artificial Sequence
  Primer Sequence UMOD-5R
caggaaacagctatgacccccaaagcttctataactaggaagtga

SEQ ID NO: 35 - DNA, 39 bp, Artificial Sequence
  Primer Sequence UMOD-6R
caggaaacagctatgacccagttgacagggaagctcatg

SEQ ID NO: 36 - DNA, 40 bp, Artificial Sequence
  Primer Sequence UMOD-7R
caggaaacagctatgaccttcctccatccaagtccaaaga

SEQ ID NO: 37 - DNA, 43 bp, Artificial Sequence
  Primer Sequence UMOD-8R
caggaaacagctatgacccatcttattgctcattctatccctc

SEQ ID NO: 38 - DNA, 40 bp, Artificial Sequence
  Primer Sequence UMOD-9R
caggaaacagctatgacctcagagctcagtaaggtgccaa

SEQ ID NO: 39 - DNA, 47 bp, Artificial Sequence
  Primer Sequence UMOD-10R
caggaaacagctatgacccccttatagagttgctatgaagcattaca

SEQ ID NO: 40 - DNA, 45 bp, Artificial Sequence
  Primer Sequence UMOD-11R
caggaaacagctatgaccaccgtaggatccttagcaccatacata

SEQ ID NO: 41 - DNA, 38 bp, Artificial Sequence
  Primer Sequence PRKCSH-1F
tgtaaaacgacggccagttcacgtgctcattccgtttc

SEQ ID NO: 42 - DNA, 41 bp, Artificial Sequence
  Primer Sequence PRKCSH-2F
tgtaaaacgacggccagtcctggaagcgatgatggaggaat

SEQ ID NO: 43 - DNA, 41 bp, Artificial Sequence
  Primer Sequence PRKCSH-3F
tgtaaaacgacggccagtatgggaggacagaggtggtattt

SEQ ID NO: 44 - DNA, 40 bp, Artificial Sequence
  Primer Sequence PRKCSH-4-5F
tgtaaaacgacggccagtgggctcttatctgtggatggat

SEQ ID NO: 45 - DNA, 42 bp, Artificial Sequence
  Primer Sequence PRKCSH-6F
tgtaaaacgacggccagtctggattgagctattttggaagag

SEQ ID NO: 46 - DNA, 39 bp, Artificial Sequence
  Primer Sequence PRKCSH-7F
tgtaaaacgacggccagtagcttggtgtgtgttttggaa

SEQ ID NO: 47 - DNA, 40 bp, Artificial Sequence
  Primer Sequence PRKCSH-8F
tgtaaaacgacggccagtatatagtaggcgcttggtggca

SEQ ID NO: 48 - DNA, 40 bp, Artificial Sequence
  Primer Sequence PRKCSH-9F
tgtaaaacgacggccagtccttgaggtcctgaagcaagtt

SEQ ID NO: 49 - DNA, 41 bp, Artificial Sequence
  Primer Sequence PRKCSH-10F
tgtaaaacgacggccagtggacacgtggtggcctagatctt

SEQ ID NO: 50 - DNA, 38 bp, Artificial Sequence
  Primer Sequence PRKCSH-11-12F
tgtaaaacgacggccagttggaccctgagtccacaaca

SEQ ID NO: 51 - DNA, 40 bp, Artificial Sequence
  Primer Sequence PRKCSH-13F
tgtaaaacgacggccagtagagcaaaatgagggtatggga

SEQ ID NO: 52 - DNA, 42 bp, Artificial Sequence
  Primer Sequence PRKCSH-14F
tgtaaaacgacggccagtaccattgctcagccagaccctcct

SEQ ID NO: 53 - DNA, 41 bp, Artificial Sequence
  Primer Sequence PRKCSH-15-16F
tgtaaaacgacggccagtttggtcattggcgttggaggtac

SEQ ID NO: 54 - DNA, 40 bp, Artificial Sequence
  Primer Sequence PRKCSH-17F
tgtaaaacgacggccagtacgacaagttcagtgccatgaa

SEQ ID NO: 55 - DNA, 39 bp, Artificial Sequence
  Primer Sequence PRKCSH-18F
tgtaaaacgacggccagtaatagacaaggtctccaggct

SEQ ID NO: 56 - DNA, 39 bp, Artificial Sequence
  Primer Sequence PRKCSH-1R
caggaaacagctatgaccgccaacagaccaaagggatta

SEQ ID NO: 57 - DNA, 39 bp, Artificial Sequence
  Primer Sequence PRKCSH-2R
caggaaacagctatgacctgcctatccctaaggcccaat

SEQ ID NO: 58 - DNA, 44 bp, Artificial Sequence
  Primer Sequence PRKCSH-3R
caggaaacagctatgacccagaggtagtatcttggtcacacaga

SEQ ID NO: 59 - DNA, 42 bp, Artificial Sequence
  Primer Sequence PRKCSH-4-5R
caggaaacagctatgaccaacccgatacagaaaagcagaaga

SEQ ID NO: 60 - DNA, 39 bp, Artificial Sequence
  Primer Sequence PRKCSH-6R
caggaaacagctatgaccagaacagcagtcaggggcaaa

SEQ ID NO: 61 - DNA, 40 bp, Artificial Sequence
  Primer Sequence PRKCSH-7R
caggaaacagctatgaccaacagataatgagcgggagact

SEQ ID NO: 62 - DNA, 41 bp, Artificial Sequence
  Primer Sequence PRKCSH-8R
caggaaacagctatgaccaggatctggctggtttctagagg

SEQ ID NO: 63 - DNA, 38 bp, Artificial Sequence
  Primer Sequence PRKCSH-9R
caggaaacagctatgaccgggcaatgctccctagaagt

SEQ ID NO: 64 - DNA, 39 bp, Artificial Sequence
  Primer Sequence PRKCSH-10R
caggaaacagctatgaccaaccagaggcagctcctttgt

SEQ ID NO: 65 - DNA, 40 bp, Artificial Sequence
  Primer Sequence PRKCSH-11-12R
caggaaacagctatgacctaagctcaggatcttccctcga

SEQ ID NO: 66 - DNA, 39 bp, Artificial Sequence
  Primer Sequence PRKCSH-13R
caggaaacagctatgaccctgtggttgcctcagtgattc

SEQ ID NO: 67 - DNA, 41 bp, Artificial Sequence
  Primer Sequence PRKCSH-14R
caggaaacagctatgacctcaatatggaaggcagcactctc

SEQ ID NO: 68 - DNA, 39 bp, Artificial Sequence
  Primer Sequence PRKCSH-15-16R
caggaaacagctatgaccctggtaaccatggtctctttc

SEQ ID NO: 69 - DNA, 41 bp, Artificial Sequence
  Primer Sequence PRKCSH-17R
caggaaacagctatgaccacaggttgatagagtggccatgt

SEQ ID NO: 70 - DNA, 42 bp, Artificial Sequence
  Primer Sequence PRKCSH-18R
caggaaacagctatgacccacctggtatcttcaggagtgatc

SEQ ID NO: 71 - DNA, 38 bp, Artificial Sequence
  Primer Sequence PKD2-1FV2
tgtaaaacgacggccagtttccacttggaacgcggact

SEQ ID NO: 72 - DNA, 44 bp, Artificial Sequence
  Primer Sequence PKD2-2F
tgtaaaacgacggccagtggagaatctcccttataggtgaactt

SEQ ID NO: 73 - DNA, 41 bp, Artificial Sequence
  Primer Sequence PKD2-3F
tgtaaaacgacggccagtaagggtgagagaagaccttgtgt

SEQ ID NO: 74 - DNA, 47 bp, Artificial Sequence
  Primer Sequence PKD2-4F
tgtaaaacgacggccagtaatctctgtgacaacaaaactcattctta

SEQ ID NO: 75 - DNA, 44 bp, Artificial Sequence
  Primer Sequence PKD2-5F
tgtaaaacgacggccagtccagcttgataggccttaatacatac

SEQ ID NO: 76 - DNA, 40 bp, Artificial Sequence
  Primer Sequence PKD2-6F
tgtaaaacgacggccagtgacatccattcctggctgtatt

SEQ ID NO: 77 - DNA, 44 bp, Artificial Sequence
  Primer Sequence PKD2-7F
tgtaaaacgacggccagtaatgacatcgggtaagtataatggtg

SEQ ID NO: 78 - DNA, 39 bp, Artificial Sequence
  Primer Sequence PKD2-8F
tgtaaaacgacggccagtcagaatcttgccatattgccc

SEQ ID NO: 79 - DNA, 43 bp, Artificial Sequence
  Primer Sequence PKD2-9F
tgtaaaacgacggccagtaatgttgcatcaactagtggacatt

SEQ ID NO: 80 - DNA, 46 bp, Artificial Sequence
  Primer Sequence PKD2-10F
tgtaaaacgacggccagttatgtcttcataaagcactcagattagg

SEQ ID NO: 81 - DNA, 42 bp, Artificial Sequence
  Primer Sequence PKD2-11F
tgtaaaacgacggccagttcttcattcatccagcacgtactt

SEQ ID NO: 82 - DNA, 40 bp, Artificial Sequence
  Primer Sequence PKD2-12F
tgtaaaacgacggccagttgatgtctctgtgttgagggtg

SEQ ID NO: 83 - DNA, 40 bp, Artificial Sequence
  Primer Sequence PKD2-13F
tgtaaaacgacggccagtaagtccttggtgaggcttctgt

SEQ ID NO: 84 - DNA, 41 bp, Artificial Sequence
  Primer Sequence PKD2-14F
tgtaaaacgacggccagtcttaagacttctgatacgcgctg

SEQ ID NO: 85 - DNA, 43 bp, Artificial Sequence
  Primer Sequence PKD2-15aF
tgtaaaacgacggccagttctccagccttaccaaactacagat

SEQ ID NO: 86 - DNA, 40 bp, Artificial Sequence
  Primer Sequence PKD2-15bF
tgtaaaacgacggccagtacacaggagaattggaaggagc

SEQ ID NO: 87 - DNA, 40 bp, Artificial Sequence
  Primer Sequence PKD2-15cF
tgtaaaacgacggccagtcttcatgatgtgtattgagcgg

SEQ ID NO: 88 - DNA, 37 bp, Artificial Sequence
  Primer Sequence PKD2-1RV2
caggaaacagctatgaccaagagcagtggaattccgc

SEQ ID NO: 89 - DNA, 43 bp, Artificial Sequence
  Primer Sequence PKD2-2R
caggaaacagctatgaccaggtaagaaaataacttcccagttg

SEQ ID NO: 90 - DNA, 47 bp, Artificial Sequence
  Primer Sequence PKD2-3R
caggaaacagctatgacccttctatctactcaccataacttacgtct

SEQ ID NO: 91 - DNA, 42 bp, Artificial Sequence
  Primer Sequence PKD2-4R
caggaaacagctatgaccatgaatggtgggagttagagaata

SEQ ID NO: 92 - DNA, 41 bp, Artificial Sequence
  Primer Sequence PKD2-5R
caggaaacagctatgacctggcatcctcatgtagctaactg

SEQ ID NO: 93 - DNA, 43 bp, Artificial Sequence
  Primer Sequence PKD2-6R
caggaaacagctatgaccgaatatcaagatccacaatgctgag

SEQ ID NO: 94 - DNA, 39 bp, Artificial Sequence
  Primer Sequence PKD2-7R
caggaaacagctatgaccagctttggctggtcacttgaa

SEQ ID NO: 95 - DNA, 43 bp, Artificial Sequence
  Primer Sequence PKD2-8R
caggaaacagctatgaccggtggtcatatagcaacctcatatg

SEQ ID NO: 96 - DNA, 46 bp, Artificial Sequence
  Primer Sequence PKD2-9R
caggaaacagctatgacctgaatagacacatatacatggatcaatg

SEQ ID NO: 97 - DNA, 43 bp, Artificial Sequence
  Primer Sequence PKD2-10R
caggaaacagctatgaccatcaagactccaagatagggaacat

SEQ ID NO: 98 - DNA, 40 bp, Artificial Sequence
  Primer Sequence PKD2-11R
caggaaacagctatgaccaatgcaggaggaaaggagaaat

SEQ ID NO: 99 - DNA, 45 bp, Artificial Sequence
  Primer Sequence PKD2-12R
caggaaacagctatgaccactaacacataaaccgactgagagaga

SEQ ID NO: 100 - DNA, 42 bp, Artificial Sequence
  Primer Sequence PKD2-13R
caggaaacagctatgaccaattcagagagatgagggaactgc

SEQ ID NO: 101 - DNA, 47 bp, Artificial Sequence
  Primer Sequence PKD2-14R
caggaaacagctatgaccagggttagacaatatgactacattgatgt

SEQ ID NO: 102 - DNA, 45 bp, Artificial Sequence
  Primer Sequence PKD2-15aR
caggaaacagctatgacccgtcatacctgaccgagtactatattc

SEQ ID NO: 103 - DNA, 45 bp, Artificial Sequence
  Primer Sequence PKD2-15bR
caggaaacagctatgaccgtacctgaattgtgtagctcgtgtaat

SEQ ID NO: 104 - DNA, 45 bp, Artificial Sequence
  Primer Sequence PKD2-15cR
caggaaacagctatgaccttggctgatactgtctaatgtatgaac

SEQ ID NO: 105 - DNA, 41 bp, Artificial Sequence
  Primer Sequence TSC1-1FV2
tgtaaaacgacggccagtgtccaacccacatcgtcagttat

SEQ ID NO: 106 - DNA, 42 bp, Artificial Sequence
  Primer Sequence TSC1-2F
tgtaaaacgacggccagtgatagaggaggaagaagcttgtgc

SEQ ID NO: 107 - DNA, 42 bp, Artificial Sequence
  Primer Sequence TSC1-3F
tgtaaaacgacggccagtgtgcattagtttgtcttgcaggta

SEQ ID NO: 108 - DNA, 43 bp, Artificial Sequence
  Primer Sequence TSC1-4F
tgtaaaacgacggccagtgtgacaggaagctgtgtaaggtaaa

SEQ ID NO: 109 - DNA, 41 bp, Artificial Sequence
  Primer Sequence TSC1-5F
tgtaaaacgacggccagtagacttgagagattggagcacat

SEQ ID NO: 110 - DNA, 45 bp, Artificial Sequence
  Primer Sequence TSC1-6F
tgtaaaacgacggccagttcagtgtttagagcctcttcatgtact

SEQ ID NO: 111 - DNA, 40 bp, Artificial Sequence
  Primer Sequence TSC1-7F
tgtaaaacgacggccagttgctggcagccacttgtttata

SEQ ID NO: 112 - DNA, 44 bp, Artificial Sequence
  Primer Sequence TSC1-8F
tgtaaaacgacggccagtctaatattccatcatttggatgttcc

SEQ ID NO: 113 - DNA, 41 bp, Artificial Sequence
  Primer Sequence TSC1-9F
tgtaaaacgacggccagtcttgctatcagagttccgtggct

SEQ ID NO: 114 - DNA, 46 bp, Artificial Sequence
  Primer Sequence TSC1-10F
tgtaaaacgacggccagtcagaataacctaaaaccacacactaacc

SEQ ID NO: 115 - DNA, 41 bp, Artificial Sequence
  Primer Sequence TSC1-11F
tgtaaaacgacggccagtcatggatgtaaacctcgtggatg

SEQ ID NO: 116 - DNA, 43 bp, Artificial Sequence
  Primer Sequence TSC1-12F
tgtaaaacgacggccagtcccagaaagttaactctagcagctt

SEQ ID NO: 117 - DNA, 41 bp, Artificial Sequence
  Primer Sequence TSC1-13F
tgtaaaacgacggccagtgcactcggctgacctttaaacta

SEQ ID NO: 118 - DNA, 49 bp, Artificial Sequence
  Primer Sequence TSC1-14F
tgtaaaacgacggccagtcagagcatgaagagttattacagacatattc

SEQ ID NO: 119 - DNA, 41 bp, Artificial Sequence
  Primer Sequence TSC1-15F
tgtaaaacgacggccagtaaactgcctagtctttcccaggt

SEQ ID NO: 120 - DNA, 43 bp, Artificial Sequence
  Primer Sequence TSC1-16F
tgtaaaacgacggccagtttgaccacaaggaagtgatctaact

SEQ ID NO: 121 - DNA, 48 bp, Artificial Sequence
  Primer Sequence TSC1-17F
tgtaaaacgacggccagtttaaagaattgtgtttgttaagctaacaac

SEQ ID NO: 122 - DNA, 42 bp, Artificial Sequence
  Primer Sequence TSC1-18F
tgtaaaacgacggccagtgaaatgttcgcagtgtgtgttaaa

SEQ ID NO: 123 - DNA, 38 bp, Artificial Sequence
  Primer Sequence TSC1-19F
tgtaaaacgacggccagtagccgttgagctaaggcatt

SEQ ID NO: 124 - DNA, 42 bp, Artificial Sequence
  Primer Sequence TSC1-20F
tgtaaaacgacggccagtccctgtttaatgacgtctatgtgc

SEQ ID NO: 125 - DNA, 43 bp, Artificial Sequence
  Primer Sequence TSC1-21F
tgtaaaacgacggccagtgccttctcagtccttcttacattgt

SEQ ID NO: 126 - DNA, 42 bp, Artificial Sequence
  Primer Sequence TSC1-23aF
tgtaaaacgacggccagtggagttcagtgtcagtgtgagtga

SEQ ID NO: 127 - DNA, 40 bp, Artificial Sequence
  Primer Sequence TSC1-23bF
tgtaaaacgacggccagtgtgaatgcacgtttcaaagctt

SEQ ID NO: 128 - DNA, 39 bp, Artificial Sequence
  Primer Sequence TSC1-23cF
tgtaaaacgacggccagtagcatgaggaactgcaccttt

SEQ ID NO: 129 - DNA, 43 bp, Artificial Sequence
  Primer Sequence TSC1-23dF
tgtaaaacgacggccagtcaaaggaaagcttaaaacccaatac

SEQ ID NO: 130 - DNA, 40 bp, Artificial Sequence
  Primer Sequence TSC1-23eFV2
tgtaaaacgacggccagtccgttgacaaggctctgctata

SEQ ID NO: 131 - DNA, 46 bp, Artificial Sequence
  Primer Sequence TSC1-23fF
tgtaaaacgacggccagttatctgtttacatccagagttctgtgac

SEQ ID NO: 132 - DNA, 41 bp, Artificial Sequence
  Primer Sequence TSC1-1RV2
caggaaacagctatgaccagccggagatagcgtgtaataag

SEQ ID NO: 133 - DNA, 39 bp, Artificial Sequence
  Primer Sequence TSC1-2R
caggaaacagctatgacccatgggcaagataattccctc

SEQ ID NO: 134 - DNA, 44 bp, Artificial Sequence
  Primer Sequence TSC1-3R
caggaaacagctatgaccagcaggattctagtggctctaaagtc

SEQ ID NO: 135 - DNA, 41 bp, Artificial Sequence
  Primer Sequence TSC1-4R
caggaaacagctatgacctaagctcaggacaagttgcacag

SEQ ID NO: 136 - DNA, 42 bp, Artificial Sequence
  Primer Sequence TSCC15R
caggaaacagctatgacctctagcttccttgctttaagttgc

SEQ ID NO: 137 - DNA, 46 bp, Artificial Sequence
  Primer Sequence TSC1-6R
caggaaacagctatgaccgtctacatgtccattccttagtacagca

SEQ ID NO: 138 - DNA, 46 bp, Artificial Sequence
  Primer Sequence TSC1-7R
caggaaacagctatgaccaaaggtataaatgcagcctatctaaaca

SEQ ID NO: 139 - DNA, 42 bp, Artificial Sequence
  Primer Sequence TSC1-8R
caggaaacagctatgacccaacagggattacctcctagatca

SEQ ID NO: 140 - DNA, 48 bp, Artificial Sequence
  Primer Sequence TSCC19R
caggaaacagctatgaccgaactgaactaagtcttactccagaaaaga

SEQ ID NO: 141 - DNA, 40 bp, Artificial Sequence
  Primer Sequence TSC1-10R
caggaaacagctatgaccagcagtgtgaaattttcccaac

SEQ ID NO: 142 - DNA, 43 bp, Artificial Sequence
  Primer Sequence TSC1-11R
caggaaacagctatgaccagatctaaaagagagctcctcctgc

SEQ ID NO: 143 - DNA, 43 bp, Artificial Sequence
  Primer Sequence TSC1-12R
caggaaacagctatgacctctggcataattaggcttctcaaag

SEQ ID NO: 144 - DNA, 44 bp, Artificial Sequence
  Primer Sequence TSC1-13R
caggaaacagctatgaccccagaatttccttgtttccatttaac

SEQ ID NO: 145 - DNA, 39 bp, Artificial Sequence
  Primer Sequence TSC1-14R
caggaaacagctatgacccaatggcacaaaatcccagat

SEQ ID NO: 146 - DNA, 44 bp, Artificial Sequence
  Primer Sequence TSC1-15R
caggaaacagctatgaccagtgtgaagaatgattcttgttcctc

SEQ ID NO: 147 - DNA, 39 bp, Artificial Sequence
  Primer Sequence TSC1-16R
caggaaacagctatgaccagatctgtttcccagagggca

SEQ ID NO: 148 - DNA, 42 bp, Artificial Sequence
  Primer Sequence TSC1-17R
caggaaacagctatgacctaagctatcatgctgacccaaaac

SEQ ID NO: 149 - DNA, 45 bp, Artificial Sequence
  Primer Sequence TSC1-18R
caggaaacagctatgaccttagtaaagctgaacaagtcaaggaca

SEQ ID NO: 150 - DNA, 45 bp, Artificial Sequence
  Primer Sequence TSC1-19R
caggaaacagctatgaccccatgacacagacactcaagtaatcta

SEQ ID NO: 151 - DNA, 45 bp, Artificial Sequence
  Primer Sequence TSC1-20R
caggaaacagctatgaccggaaataagtcatcaagccattctcta

SEQ ID NO: 152 - DNA, 41 bp, Artificial Sequence
  Primer Sequence TSC1-22R
caggaaacagctatgaccacaccacgtgacacagtccttat

SEQ ID NO: 153 - DNA, 40 bp, Artificial Sequence
  Primer Sequence TSC1-23aR
caggaaacagctatgaccgcattcagtcagctgtccaaag

SEQ ID NO: 154 - DNA, 39 bp, Artificial Sequence
  Primer Sequence TSC1-23bR
caggaaacagctatgaccacaagaggcgtatgcacacaa

SEQ ID NO: 155 - DNA, 45 bp, Artificial Sequence
  Primer Sequence TSC1-23cR
caggaaacagctatgacctaagtttgttcacgttttccttttcta

SEQ ID NO: 156 - DNA, 45 bp, Artificial Sequence
  Primer Sequence TSC1-23dR
caggaaacagctatgacccatctttcacaacttctccatctaaga

SEQ ID NO: 157 - DNA, 44 bp, Artificial Sequence
  Primer Sequence TSC1-23eRV2
caggaaacagctatgaccttgtagctacagctactcttccctca

SEQ ID NO: 158 - DNA, 38 bp, Artificial Sequence
  Primer Sequence TSC1-23fR
caggaaacagctatgacctcccctgcttgacctgtaag

SEQ ID NO: 159 - DNA, 38 bp, Artificial Sequence
  Primer Sequence TSC2-1FV2
tgtaaaacgacggccagtacagagtggtgggaaaggaa

SEQ ID NO: 160 - DNA, 40 bp, Artificial Sequence
  Primer Sequence TSC2-2F
tgtaaaacgacggccagtaaaggttatgcccaccagagac

SEQ ID NO: 161 - DNA, 42 bp, Artificial Sequence
  Primer Sequence TSC2-3F
tgtaaaacgacggccagtggtttgtgacttgcagttaaggag

SEQ ID NO: 162 - DNA, 40 bp, Artificial Sequence
  Primer Sequence TSC2-4F
tgtaaaacgacggccagtcacaggagatacgagctttgga

SEQ ID NO: 163 - DNA, 40 bp, Artificial Sequence
  Primer Sequence TSC2-5F
tgtaaaacgacggccagttgatgctgcagacctgtctctt

SEQ ID NO: 164 - DNA, 38 bp, Artificial Sequence
  Primer Sequence TSC2-6F
tgtaaaacgacggccagttttctggcagtgacgggttt

SEQ ID NO: 165 - DNA, 39 bp, Artificial Sequence
  Primer Sequence TSC2-7F
tgtaaaacgacggccagtgatgagccatgcgtgttattg

SEQ ID NO: 166 - DNA, 40 bp, Artificial Sequence
  Primer Sequence TSC2-8F
tgtaaaacgacggccagtatgacagcatcaatgacccaca

SEQ ID NO: 167 - DNA, 39 bp, Artificial Sequence
  Primer Sequence TSC2-9F
tgtaaaacgacggccagtattttgagaaccctgctgcct

SEQ ID NO: 168 - DNA, 38 bp, Artificial Sequence
  Primer Sequence TSC2-10F
tgtaaaacgacggccagttcttggctgtgattggagga

SEQ ID NO: 169 - DNA, 40 bp, Artificial Sequence
  Primer Sequence TSC2-11F
tgtaaaacgacggccagttatagtgatgagctgcggtgtg

SEQ ID NO: 170 - DNA, 38 bp, Artificial Sequence
  Primer Sequence TSC2-12F
tgtaaaacgacggccagtctctggtgccaagtccatgt

SEQ ID NO: 171 - DNA, 38 bp, Artificial Sequence
  Primer Sequence TSC2-13F
tgtaaaacgacggccagttgtgtggagcaagcttccat

SEQ ID NO: 172 - DNA, 39 bp, Artificial Sequence
  Primer Sequence TSC2-14F
tgtaaaacgacggccagttagcttgctttccagtccagc

SEQ ID NO: 173 - DNA, 41 bp, Artificial Sequence
  Primer Sequence TSC2-15F
tgtaaaacgacggccagtaggaattggaagtgtcacgagat

SEQ ID NO: 174 - DNA, 43 bp, Artificial Sequence
  Primer Sequence TSC2-16F
tgtaaaacgacggccagtggtgtttgtggtagaaagtgttctc

SEQ ID NO: 175 - DNA, 40 bp, Artificial Sequence
  Primer Sequence TSC2-17F
tgtaaaacgacggccagttgtgttttaaagcacgcactct

SEQ ID NO: 176 - DNA, 38 bp, Artificial Sequence
  Primer Sequence TSC2-18F
tgtaaaacgacggccagttcagcctgtcgatggaagaa

SEQ ID NO: 177 - DNA, 42 bp, Artificial Sequence
  Primer Sequence TSC2-19F
tgtaaaacgacggccagttactgcgtctgcgactacatgtac

SEQ ID NO: 178 - DNA, 38 bp, Artificial Sequence
  Primer Sequence TSC2-20F
tgtaaaacgacggccagtaagcagagcctcagatgcta

SEQ ID NO: 179 - DNA, 43 bp, Artificial Sequence
  Primer Sequence TSC2-21F
tgtaaaacgacggccagtacctcacattcctggtgtgttactt

SEQ ID NO: 180 - DNA, 40 bp, Artificial Sequence
  Primer Sequence TSC2-22F
tgtaaaacgacggccagtattcagggacttgctaagcctc

SEQ ID NO: 181 - DNA, 40 bp, Artificial Sequence
  Primer Sequence TSC2-23F
tgtaaaacgacggccagtaattggcccagaagctgtggtt

SEQ ID NO: 182 - DNA, 38 bp, Artificial Sequence
  Primer Sequence TSC2-24F
tgtaaaacgacggccagttatgccagtgtgttcgccat

SEQ ID NO: 183 - DNA, 39 bp, Artificial Sequence
  Primer Sequence TSC2-25F
tgtaaaacgacggccagtttcatcactaaggtgggctca

SEQ ID NO: 184 - DNA, 45 bp, Artificial Sequence
  Primer Sequence TSC2-26F
tgtaaaacgacggccagtgccttacttgttctcagtcatgtttac

SEQ ID NO: 185 - DNA, 42 bp, Artificial Sequence
  Primer Sequence TSC2-27-28F
tgtaaaacgacggccagtgaatgaactcccataagcctcttc

SEQ ID NO: 186 - DNA, 40 bp, Artificial Sequence
  Primer Sequence TSC2-29F
tgtaaaacgacggccagtttgggaacaagcttgtcactgt

SEQ ID NO: 187 - DNA, 39 bp, Artificial Sequence
  Primer Sequence TSC2-30F
tgtaaaacgacggccagtaatcagcttgaggctggtggt

SEQ ID NO: 188 - DNA, 39 bp, Artificial Sequence
  Primer Sequence TSC2-31F
tgtaaaacgacggccagtgacatcgtggtcctgaggatt

SEQ ID NO: 189 - DNA, 40 bp, Artificial Sequence
  Primer Sequence TSC2-32FV2
tgtaaaacgacggccagtttagcggcctaggacgtctatt

SEQ ID NO: 190 - DNA, 38 bp, Artificial Sequence
  Primer Sequence TSC2-33F
tgtaaaacgacggccagtatggcagcagtaagcagagc

SEQ ID NO: 191 - DNA, 39 bp, Artificial Sequence
  Primer Sequence TSC2-34F
tgtaaaacgacggccagtggatgctgatacctctgctca

SEQ ID NO: 192 - DNA, 39 bp, Artificial Sequence
  Primer Sequence TSC2-35-36F
tgtaaaacgacggccagtagagaaagtgccaggcatcaa

SEQ ID NO: 193 - DNA, 39 bp, Artificial Sequence
  Primer Sequence TSC2-37F
tgtaaaacgacggccagtaatggatggtcttgtctgcct

SEQ ID NO: 194 - DNA, 40 bp, Artificial Sequence
  Primer Sequence TSC2-38F
tgtaaaacgacggccagtcacgatgacatcatgcaaggta

SEQ ID NO: 195 - DNA, 38 bp, Artificial Sequence
  Primer Sequence TSC2-39-41F
tgtaaaacgacggccagtaaagttcaggggcagatgct

SEQ ID NO: 196 - DNA, 40 bp, Artificial Sequence
  Primer Sequence TSC2-42F
tgtaaaacgacggccagtatctacccctccaagtggattg

SEQ ID NO: 197 - DNA, 41 bp, Artificial Sequence
  Primer Sequence TSC2-1RV2
caggaaacagctatgacctccctgggagaactcaactacag

SEQ ID NO: 198 - DNA, 39 bp, Artificial Sequence
  Primer Sequence TSC2-2R
caggaaacagctatgaccacagaacctggtgcaagacca

SEQ ID NO: 199 - DNA, 41 bp, Artificial Sequence
  Primer Sequence TSC2-3R
caggaaacagctatgacctcagctgtcaaccatgttcctaa

SEQ ID NO: 200 - DNA, 40 bp, Artificial Sequence
  Primer Sequence TSC2-4R
caggaaacagctatgacctcacacagacctcatgacacca

SEQ ID NO: 201 - DNA, 40 bp, Artificial Sequence
  Primer Sequence TSC2-5R
caggaaacagctatgaccccttcccatccaggttacactt

SEQ ID NO: 202 - DNA, 40 bp, Artificial Sequence
  Primer Sequence TSC2-6R
caggaaacagctatgacctcaactttattcactgcggagc

SEQ ID NO: 203 - DNA, 38 bp, Artificial Sequence
  Primer Sequence TSC2-7R
caggaaacagctatgacccccagaaaccagggtgaaat

SEQ ID NO: 204 - DNA, 40 bp, Artificial Sequence
  Primer Sequence TSC2-8R
caggaaacagctatgaccagacaaccattcatgggagaca

SEQ ID NO: 205 - DNA, 44 bp, Artificial Sequence
  Primer Sequence TSC2-9R
caggaaacagctatgacctgtggatattctgttgaactgacaga

SEQ ID NO: 206 - DNA, 41 bp, Artificial Sequence
  Primer Sequence TSC2-10RV2
caggaaacagctatgacccaagcagaaagagcagaactcct

SEQ ID NO: 207 - DNA, 40 bp, Artificial Sequence
  Primer Sequence TSC2-11RV2
caggaaacagctatgacccatattcctgtctggggcctaa

SEQ ID NO: 208 - DNA, 40 bp, Artificial Sequence
  Primer Sequence TSC2-12R
caggaaacagctatgacccttggcttctgaggctcagaaa

SEQ ID NO: 209 - DNA, 40 bp, Artificial Sequence
  Primer Sequence TSC2-13RV2
caggaaacagctatgacctggacacgcacctcatagaact

SEQ ID NO: 210 - DNA, 41 bp, Artificial Sequence
  Primer Sequence TSC2-14R
caggaaacagctatgaccaatgaacaggggtaaacagacca

SEQ ID NO: 211 - DNA, 39 bp, Artificial Sequence
  Primer Sequence TSC2-15R
caggaaacagctatgacctcactcgaagaggaggacaga

SEQ ID NO: 212 - DNA, 40 bp, Artificial Sequence
  Primer Sequence TSC2-16R
caggaaacagctatgacccagactccaacacaacgcagat

SEQ ID NO: 213 - DNA, 39 bp, Artificial Sequence
  Primer Sequence TSC2-17R
caggaaacagctatgaccaagccacagatgtgtggactg

SEQ ID NO: 214 - DNA, 39 bp, Artificial Sequence
  Primer Sequence TSC2-18R
caggaaacagctatgaccaacagacttggctcttcccaa

SEQ ID NO: 215 - DNA, 40 bp, Artificial Sequence
  Primer Sequence TSC2-19RV2
caggaaacagctatgaccttcagcaccttccagtcagact

SEQ ID NO: 216 - DNA, 43 bp, Artificial Sequence
  Primer Sequence TSC2-20R
caggaaacagctatgaccaagtaacacaccaggaatgtcaggt

SEQ ID NO: 217 - DNA, 40 bp, Artificial Sequence
  Primer Sequence TSC2-21R
caggaaacagctatgaccaagcagagccaactcactcatc

SEQ ID NO: 218 - DNA, 42 bp, Artificial Sequence
  Primer Sequence TSC2-22R
caggaaacagctatgaccttcttcaaggaggagcgttcacat

SEQ ID NO: 219 - DNA, 45 bp, Artificial Sequence
  Primer Sequence TSC2-23R
caggaaacagctatgaccacacgatgtactgattaaacctgagat

SEQ ID NO: 220 - DNA, 38 bp, Artificial Sequence
  Primer Sequence TSC2-24R
caggaaacagctatgacctgagcacacccagacagtga

SEQ ID NO: 221 - DNA, 41 bp, Artificial Sequence
  Primer Sequence TSC2-25R
caggaaacagctatgaccatttccactcactgacttggagg

SEQ ID NO: 222 - DNA, 39 bp, Artificial Sequence
  Primer Sequence TSC2-26R
caggaaacagctatgaccacagaatgcaacctttccacc

SEQ ID NO: 223 - DNA, 40 bp, Artificial Sequence
  Primer Sequence TSC2-27-28R
caggaaacagctatgacctccttggtctgtctcacatgca

SEQ ID NO: 224 - DNA, 38 bp, Artificial Sequence
  Primer Sequence TSC2-29R
caggaaacagctatgacctgaaaacccgcaggaaacac

SEQ ID NO: 225 - DNA, 41 bp, Artificial Sequence
  Primer Sequence TSC2-30R
caggaaacagctatgaccagttacccccaaatatcccaaga

SEQ ID NO: 226 - DNA, 39 bp, Artificial Sequence
  Primer Sequence TSC2-31R
caggaaacagctatgacctactgcttctgaagctgccag

SEQ ID NO: 227 - DNA, 41 bp, Artificial Sequence
  Primer Sequence TSC2-32RV2
caggaaacagctatgaccacattctgcacagacgtcctcat

SEQ ID NO: 228 - DNA, 39 bp, Artificial Sequence
  Primer Sequence TSC2-33R
caggaaacagctatgaccaacatctcccccaagttcaga

SEQ ID NO: 229 - DNA, 38 bp, Artificial Sequence
  Primer Sequence TSC2-34R
caggaaacagctatgaccaacacgaaactgcacaggga

SEQ ID NO: 230 - DNA, 41 bp, Artificial Sequence
  Primer Sequence TSC2-35-36R
caggaaacagctatgaccaatgagcacttcatgctgtaggg

SEQ ID NO: 231 - DNA, 38 bp, Artificial Sequence
  Primer Sequence TSC2-37R
caggaaacagctatgacctgttaggctcggaacctgag

SEQ ID NO: 232 - DNA, 41 bp, Artificial Sequence
  Primer Sequence TSC2-38R
caggaaacagctatgacccagtctgcacttgccagttactc

SEQ ID NO: 233 - DNA, 38 bp, Artificial Sequence
  Primer Sequence TSC2-39-41R
caggaaacagctatgaccttcctcgcagatctgaaggc

SEQ ID NO: 234 - DNA, 40 bp, Artificial Sequence
  Primer Sequence TSC2-42R
caggaaacagctatgaccttctgtgtaccacttctgtggg

SEQ ID NO: 235 - DNA, 40 bp, Artificial Sequence
  Primer Sequence NPHP1-1F
tgtaaaacgacggccagtaagagaacatttgacccttccc

SEQ ID NO: 236 - DNA, 44 bp, Artificial Sequence
  Primer Sequence NPHP1-2F
tgtaaaacgacggccagtttctttcctaaggcgatatggtattt

SEQ ID NO: 237 - DNA, 38 bp, Artificial Sequence
  Primer Sequence NPHP1-3F
tgtaaaacgacggccagttaattgccttgcctgctcaa

SEQ ID NO: 238 - DNA, 45 bp, Artificial Sequence
  Primer Sequence NPHP1-4F
tgtaaaacgacggccagttccctaagataggtgtaatgtcacact

SEQ ID NO: 239 - DNA, 45 bp, Artificial Sequence
  Primer Sequence NPHP1-5F
tgtaaaacgacggccagtgaagttacactcatagctggtctgttc

SEQ ID NO: 240 - DNA, 43 bp, Artificial Sequence
  Primer Sequence NPHP1-6F
tgtaaaacgacggccagtggtgagttaggcagaatacataggg

SEQ ID NO: 241 - DNA, 46 bp, Artificial Sequence
  Primer Sequence NPHP1-7F
tgtaaaacgacggccagtgcaaagttattaaccatgtgttgaaaat

SEQ ID NO: 242 - DNA, 42 bp, Artificial Sequence
  Primer Sequence NPHP1-8FV2
tgtaaaacgacggccagtatggagacaacttgtacctggaga

SEQ ID NO: 243 - DNA, 48 bp, Artificial Sequence
  Primer Sequence NPHP1-9F
tgtaaaacgacggccagtgtattatagagatgcagaaacatgactgaa

SEQ ID NO: 244 - DNA, 45 bp, Artificial Sequence
  Primer Sequence NPHP1-10F
tgtaaaacgacggccagtggaagtgcctgtactctagttcatagc

SEQ ID NO: 245 - DNA, 42 bp, Artificial Sequence
  Primer Sequence NPHP1-11F
tgtaaaacgacggccagtttcataagccgaattcacaaaaga

SEQ ID NO: 246 - DNA, 41 bp, Artificial Sequence
  Primer Sequence NPHP1-12F
tgtaaaacgacggccagtccttgccatcttcctcacttagt

SEQ ID NO: 247 - DNA, 43 bp, Artificial Sequence
  Primer Sequence NPHP1-13F
tgtaaaacgacggccagttactaacaaatagggctgaaaccct

SEQ ID NO: 248 - DNA, 40 bp, Artificial Sequence
  Primer Sequence NPHP1-14F
tgtaaaacgacggccagtcaagagacaatggcagcagttg

SEQ ID NO: 249 - DNA, 41 bp, Artificial Sequence
  Primer Sequence NPHP1-15F
tgtaaaacgacggccagtttgcccagatagtacctcatgga

SEQ ID NO: 250 - DNA, 44 bp, Artificial Sequence
  Primer Sequence NPHP1-16F
tgtaaaacgacggccagtcaattcagcactactgggtggtatat

SEQ ID NO: 251 - DNA, 41 bp, Artificial Sequence
  Primer Sequence NPHP1-17F
tgtaaaacgacggccagtacacagggttgagactcgaaagt

SEQ ID NO: 252 - DNA, 42 bp, Artificial Sequence
  Primer Sequence NPHP1-18F
tgtaaaacgacggccagtatatgggtataggggcaaatgaag

SEQ ID NO: 253 - DNA, 39 bp, Artificial Sequence
  Primer Sequence NPHP1-19F
tgtaaaacgacggccagttatcatgggcttctacggcat

SEQ ID NO: 254 - DNA, 42 bp, Artificial Sequence
  Primer Sequence NPHP1-20aF
tgtaaaacgacggccagttccatcctacctcttaggtggctt

SEQ ID NO: 255 - DNA, 48 bp, Artificial Sequence
  Primer Sequence NPHP1-20bF
tgtaaaacgacggccagttgagaaagttgtatcacttaattcagtctg

SEQ ID NO: 256 - DNA, 43 bp, Artificial Sequence
  Primer Sequence NPHP1-1R
caggaaacagctatgacctacaacctgggaaggtaagtaggtt

SEQ ID NO: 257 - DNA, 41 bp, Artificial Sequence
  Primer Sequence NPHP1-2R
caggaaacagctatgacctatgcattgaaatgtaagtgcgg

SEQ ID NO: 258 - DNA, 41 bp, Artificial Sequence
  Primer Sequence NPHP1-3R
caggaaacagctatgaccaaacccaggaacttaccaacttg

SEQ ID NO: 259 - DNA, 48 bp, Artificial Sequence
  Primer Sequence NPHP1-4R
caggaaacagctatgaccttagttgactgattctattgttagtctcat

SEQ ID NO: 260 - DNA, 45 bp, Artificial Sequence
  Primer Sequence NPHP1-5R
caggaaacagctatgacctaatacaggtgtacaggcagagttttc

SEQ ID NO: 261 - DNA, 43 bp, Artificial Sequence
  Primer Sequence NPHP1-6R
caggaaacagctatgacccccaggaccattaatacacaatgtt

SEQ ID NO: 262 - DNA, 43 bp, Artificial Sequence
  Primer Sequence NPHP1-7R
caggaaacagctatgaccggtacaagttgtctccatttcaaga

SEQ ID NO: 263 - DNA, 43 bp, Artificial Sequence
  Primer Sequence NPHP1-8RV2
caggaaacagctatgacccaggatcaatgagaatgtttccaag

SEQ ID NO: 264 - DNA, 42 bp, Artificial Sequence
  Primer Sequence NPHP1-9R
caggaaacagctatgacccactgtcataggaaggatgaggaa

SEQ ID NO: 265 - DNA, 46 bp, Artificial Sequence
  Primer Sequence NPHP1-10R
caggaaacagctatgaccatgttgtttgtctaattgcaactatgac

SEQ ID NO: 266 - DNA, 48 bp, Artificial Sequence
  Primer Sequence NPHP1-11R
caggaaacagctatgaccccatgtaagtactgtttaacctgtatctca

SEQ ID NO: 267 - DNA, 44 bp, Artificial Sequence
  Primer Sequence NPHP1-12R
caggaaacagctatgaccatctgttcccacatactctgtgctat

SEQ ID NO: 268 - DNA, 42 bp, Artificial Sequence
  Primer Sequence NPHP1-13R
caggaaacagctatgacccattctcattcctcaagggattaa

SEQ ID NO: 269 - DNA, 45 bp, Artificial Sequence
  Primer Sequence NPHP1-14R
caggaaacagctatgacccatagaacaaacctgaggtatcaagag

SEQ ID NO: 270 - DNA, 44 bp, Artificial Sequence
  Primer Sequence NPHP1-15R
caggaaacagctatgaccagaatgtagctacctctcagatgctt

SEQ ID NO: 271 - DNA, 40 bp, Artificial Sequence
  Primer Sequence NPHP1-16R
caggaaacagctatgaccgagtaggtcaccaagtgctgaa

SEQ ID NO: 272 - DNA, 44 bp, Artificial Sequence
  Primer Sequence NPHP1-17R
caggaaacagctatgacctcacaaccagaaacagaagatacaag

SEQ ID NO: 273 - DNA, 46 bp, Artificial Sequence
  Primer Sequence NPHP1-18R
caggaaacagctatgaccgaggactgagttacctagacaatggata

SEQ ID NO: 274 - DNA, 42 bp, Artificial Sequence
  Primer Sequence NPHP1-19R
caggaaacagctatgaccgattagaataggcaagcaaacacc

SEQ ID NO: 275 - DNA, 41 bp, Artificial Sequence
  Primer Sequence NPHP1-20aR
caggaaacagctatgacctctccagtgcctgaaagtttctt

SEQ ID NO: 276 - DNA, 41 bp, Artificial Sequence
  Primer Sequence NPHP1-20bR
caggaaacagctatgacccccagttctcacttgtcacattt

SEQ ID NO: 277 - DNA, 41 bp, Artificial Sequence
  Primer Sequence NPHP2-1F
tgtaaaacgacggccagtacgtcgtccgtcatctagaactt

SEQ ID NO: 278 - DNA, 42 bp, Artificial Sequence
  Primer Sequence NPHP2-2F
tgtaaaacgacggccagtcacttggaactgatgagacaggtt

SEQ ID NO: 279 - DNA, 47 bp, Artificial Sequence
  Primer Sequence NPHP2-3FV2
tgtaaaacgacggccagtcaatggtaatatctacttcttaggacaag

SEQ ID NO: 280 - DNA, 44 bp, Artificial Sequence
  Primer Sequence NPHP2-4F
tgtaaaacgacggccagtggccagccactatgtaaattatattc

SEQ ID NO: 281 - DNA, 42 bp, Artificial Sequence
  Primer Sequence NPHP2-5F
tgtaaaacgacggccagttataacagtgcctgtcccacaata

SEQ ID NO: 282 - DNA, 39 bp, Artificial Sequence
  Primer Sequence NPHP2-6F
tgtaaaacgacggccagtgctgcagtgagctgtgatcat

SEQ ID NO: 283 - DNA, 44 bp, Artificial Sequence
  Primer Sequence NPHP2-7F
tgtaaaacgacggccagtccgttgtgaatgctgtattatgttag

SEQ ID NO: 284 - DNA, 42 bp, Artificial Sequence
  Primer Sequence NPHP2-8F
tgtaaaacgacggccagtacagaggattgttatcttcgatgg

SEQ ID NO: 285 - DNA, 45 bp, Artificial Sequence
  Primer Sequence NPHP2-9F
tgtaaaacgacggccagtggcagaattgtgtacatcatttaaatc

SEQ ID NO: 286 - DNA, 44 bp, Artificial Sequence
  Primer Sequence NPHP2-10F
tgtaaaacgacggccagtacctcaagttctactcctagctccac

SEQ ID NO: 287 - DNA, 45 bp, Artificial Sequence
  Primer Sequence NPHP2-11F
tgtaaaacgacggccagtgtgttaattatgagctcttggatcaaa

SEQ ID NO: 288 - DNA, 41 bp, Artificial Sequence
  Primer Sequence NPHP2-12F
tgtaaaacgacggccagtaactgacatggttagcagcacaa

SEQ ID NO: 289 - DNA, 46 bp, Artificial Sequence
  Primer Sequence NPHP2-13F
tgtaaaacgacggccagtaatatctcctgtgatgtagtagctcctc

SEQ ID NO: 290 - DNA, 45 bp, Artificial Sequence
  Primer Sequence NPHP2-14F
tgtaaaacgacggccagtctgccactattatggtgatgatatagg

SEQ ID NO: 291 - DNA, 42 bp, Artificial Sequence
  Primer Sequence NPHP2-15F
tgtaaaacgacggccagtagcttgaatgaacctaccaggaat

SEQ ID NO: 292 - DNA, 45 bp, Artificial Sequence
  Primer Sequence NPHP2-16F
tgtaaaacgacggccagttccacaccatacctaacttatcttgac

SEQ ID NO: 293 - DNA, 40 bp, Artificial Sequence
  Primer Sequence NPHP2-17F
tgtaaaacgacggccagtcccatatcttgagactgcagga

SEQ ID NO: 294 - DNA, 45 bp, Artificial Sequence
  Primer Sequence NPHP2-1R
caggaaacagctatgaccggataagtcattgactcattcaactga

SEQ ID NO: 295 - DNA, 46 bp, Artificial Sequence
  Primer Sequence NPHP2-2R
caggaaacagctatgaccactgtttcattcgagatctgttaacata

SEQ ID NO: 296 - DNA, 43 bp, Artificial Sequence
  Primer Sequence NPHP2-3RV2
caggaaacagctatgacctgtccattgcatagttccactaatc

SEQ ID NO: 297 - DNA, 41 bp, Artificial Sequence
  Primer Sequence NPHP2-4R
caggaaacagctatgaccgtggtaattcaggccttcttcct

SEQ ID NO: 298 - DNA, 45 bp, Artificial Sequence
  Primer Sequence NPHP2-5R
caggaaacagctatgaccggatgagtccatatgtctgttgtattc

SEQ ID NO: 299 - DNA, 41 bp, Artificial Sequence
  Primer Sequence NPHP2-6R
caggaaacagctatgaccggaagggaaggcacagaaatatt

SEQ ID NO: 300 - DNA, 47 bp, Artificial Sequence
  Primer Sequence NPHP2-7R
caggaaacagctatgaccatcattagagtgaattaggtgtaggagtg

SEQ ID NO: 301 - DNA, 43 bp, Artificial Sequence
  Primer Sequence NPHP2-8R
caggaaacagctatgacccataatcatgtctaaggagcaacca

SEQ ID NO: 302 - DNA, 42 bp, Artificial Sequence
  Primer Sequence NPHP2-9R
caggaaacagctatgacccttcatccttgtacttgtgcagct

SEQ ID NO: 303 - DNA, 48 bp, Artificial Sequence
  Primer Sequence NPHP2-10R
caggaaacagctatgacctggacaaataatagtcatgattaatagatg

SEQ ID NO: 304 - DNA, 39 bp, Artificial Sequence
  Primer Sequence NPHP2-11R
caggaaacagctatgaccgtgatcgtgcatgcctgtaat

SEQ ID NO: 305 - DNA, 40 bp, Artificial Sequence
  Primer Sequence NPHP2-12R
caggaaacagctatgaccggttgcagggaccaacagtaat

SEQ ID NO: 306 - DNA, 44 bp, Artificial Sequence
  Primer Sequence NPHP2-13R
caggaaacagctatgaccgcggtcctaggtgctaatataacaat

SEQ ID NO: 307 - DNA, 38 bp, Artificial Sequence
  Primer Sequence NPHP2-14R
caggaaacagctatgaccaattggccttaccatgccac

SEQ ID NO: 308 - DNA, 43 bp, Artificial Sequence
  Primer Sequence NPHP2-15R
caggaaacagctatgacctgcaccaacctaatttatctgaatg

SEQ ID NO: 309 - DNA, 46 bp, Artificial Sequence
  Primer Sequence NPHP2-16R
caggaaacagctatgaccggagacagatgttggctacagtaataat

SEQ ID NO: 310 - DNA, 44 bp, Artificial Sequence
  Primer Sequence NPHP2-17R
caggaaacagctatgaccatccttgatactgtaatacggctgtt

SEQ ID NO: 311 - DNA, 38 bp, Artificial Sequence
  Primer Sequence NPHP3-1FV2
tgtaaaacgacggccagttatgtcggagcaccactcca

SEQ ID NO: 312 - DNA, 44 bp, Artificial Sequence
  Primer Sequence NPHP3-2F
tgtaaaacgacggccagtcaacatgaagttcctgataattggta

SEQ ID NO: 313 - DNA, 40 bp, Artificial Sequence
  Primer Sequence NPHP3-3F
tgtaaaacgacggccagtgacattcaccctatgaaagagg

SEQ ID NO: 314 - DNA, 48 bp, Artificial Sequence
  Primer Sequence NPHP3-4F
tgtaaaacgacggccagttgagatgataaccagaattatgttaatcag

SEQ ID NO: 315 - DNA, 48 bp, Artificial Sequence
  Primer Sequence NPHP3-5F
tgtaaaacgacggccagttactctagaaggtatggcagtattaacatg

SEQ ID NO: 316 - DNA, 46 bp, Artificial Sequence
  Primer Sequence NPHP3-6F
tgtaaaacgacggccagtcctaatactgtctcctgttgttctagct

SEQ ID NO: 317 - DNA, 44 bp, Artificial Sequence
  Primer Sequence NPHP3-7F
tgtaaaacgacggccagtggcacttaggttgattaactaactgc

SEQ ID NO: 318 - DNA, 44 bp, Artificial Sequence
  Primer Sequence NPHP3-8F
tgtaaaacgacggccagtaagtatttaccaccacttccttctga

SEQ ID NO: 319 - DNA, 48 bp, Artificial Sequence
  Primer Sequence NPHP3-9F
tgtaaaacgacggccagtttcttgtaggtattatacaaaggctgtatg

SEQ ID NO: 320 - DNA, 46 bp, Artificial Sequence
  Primer Sequence NPHP3-10F
tgtaaaacgacggccagttcagaagttgactcttcagtagtctcag

SEQ ID NO: 321 - DNA, 42 bp, Artificial Sequence
  Primer Sequence NPHP3-11F
tgtaaaacgacggccagtagtaactgaccacctgattgctca

SEQ ID NO: 322 - DNA, 40 bp, Artificial Sequence
  Primer Sequence NPHP3-13F
tgtaaaacgacggccagtcgtgtccagagttcagattggt

SEQ ID NO: 323 - DNA, 46 bp, Artificial Sequence
  Primer Sequence NPHP3-14F
tgtaaaacgacggccagtagtataaagtgttaattcctgtggtgga

SEQ ID NO: 324 - DNA, 43 bp, Artificial Sequence
  Primer Sequence NPHP3-15F
tgtaaaacgacggccagtggtagtaaagaccgcttaattccag

SEQ ID NO: 325 - DNA, 43 bp, Artificial Sequence
  Primer Sequence NPHP3-16F
tgtaaaacgacggccagtcagcatgtttattgcactgaattaa

SEQ ID NO: 326 - DNA, 46 bp, Artificial Sequence
  Primer Sequence NPHP3-17F
tgtaaaacgacggccagtttaatggccgttagttacttatacaggt

SEQ ID NO: 327 - DNA, 45 bp, Artificial Sequence
  Primer Sequence NPHP3-18F
tgtaaaacgacggccagttgcaaatctcttgttagatgtacagtg

SEQ ID NO: 328 - DNA, 47 bp, Artificial Sequence
  Primer Sequence NPHP3-19F
tgtaaaacgacggccagttggtaaagtctctgattttgacctaactt

SEQ ID NO: 329 - DNA, 45 bp, Artificial Sequence
  Primer Sequence NPHP3-20F
tgtaaaacgacggccagtcctcattacacagtactcgcctactaa

SEQ ID NO: 330 - DNA, 45 bp, Artificial Sequence
  Primer Sequence NPHP3-22F
tgtaaaacgacggccagtgatgatcagatgtcagctacttaaagg

SEQ ID NO: 331 - DNA, 40 bp, Artificial Sequence
  Primer Sequence NPHP3-23F
tgtaaaacgacggccagtgaatgtgttgccatgtggaaat

SEQ ID NO: 332 - DNA, 46 bp, Artificial Sequence
  Primer Sequence NPHP3-24F
tgtaaaacgacggccagtgatgagtcagttctccacttaatttagg

SEQ ID NO: 333 - DNA, 43 bp, Artificial Sequence
  Primer Sequence NPHP3-25F
tgtaaaacgacggccagttaagctgataggaaatgcttctgag

SEQ ID NO: 334 - DNA, 44 bp, Artificial Sequence
  Primer Sequence NPHP3-26F
tgtaaaacgacggccagttgtgcttacagtattggattatggtc

SEQ ID NO: 335 - DNA, 42 bp, Artificial Sequence
  Primer Sequence NPHP3-27aF
tgtaaaacgacggccagtgtctgcttgagtgaatacactgga

SEQ ID NO: 336 - DNA, 43 bp, Artificial Sequence
  Primer Sequence NPHP3-27bF
tgtaaaacgacggccagttcaacaagagctggcagagtagtta

SEQ ID NO: 337 - DNA, 39 bp, Artificial Sequence
  Primer Sequence NPHP3-1R
caggaaacagctatgacccgaagagaatatggcctctca

SEQ ID NO: 338 - DNA, 46 bp, Artificial Sequence
  Primer Sequence NPHP3-2R
caggaaacagctatgacccaactttcctgaatcctacatgacttac

SEQ ID NO: 339 - DNA, 42 bp, Artificial Sequence
  Primer Sequence NPHP3-3R
caggaaacagctatgaccttagcagctgacagagagaacaca

SEQ ID NO: 340 - DNA, 45 bp, Artificial Sequence
  Primer Sequence NPHP3-4R
caggaaacagctatgaccaacctcatccttccttgttagttacag

SEQ ID NO: 341 - DNA, 44 bp, Artificial Sequence
  Primer Sequence NPHP3-5R
caggaaacagctatgaccctctcaattcaccacctttctttaca

SEQ ID NO: 342 - DNA, 46 bp, Artificial Sequence
  Primer Sequence NPHP3-6R
caggaaacagctatgacctatttggcaaactcaattctatttacag

SEQ ID NO: 343 - DNA, 41 bp, Artificial Sequence
  Primer Sequence NPHP3-7R
caggaaacagctatgacccgaggttcttcacaatcaatgag

SEQ ID NO: 344 - DNA, 49 bp, Artificial Sequence
  Primer Sequence NPHP3-8R
caggaaacagctatgacccatggtcctagtaatactaagaacataccac

SEQ ID NO: 345 - DNA, 42 bp, Artificial Sequence
  Primer Sequence NPHP3-9R
caggaaacagctatgacctacaacatggataatcaagccatg

SEQ ID NO: 346 - DNA, 39 bp, Artificial Sequence
  Primer Sequence NPHP3-10R
caggaaacagctatgaccaaggcaggcatgcaatacatt

SEQ ID NO: 347 - DNA, 44 bp, Artificial Sequence
  Primer Sequence NPHP3-12R
caggaaacagctatgaccaatgcctgctctagctattactgaat

SEQ ID NO: 348 - DNA, 40 bp, Artificial Sequence
  Primer Sequence NPHP3-13R
caggaaacagctatgacccccatcctcactgcaagttaca

SEQ ID NO: 349 - DNA, 47 bp, Artificial Sequence
  Primer Sequence NPHP3-14R
caggaaacagctatgacccattagtttaagaggcaatacatttacca

SEQ ID NO: 350 - DNA, 45 bp, Artificial Sequence
  Primer Sequence NPHP3-15R
caggaaacagctatgaccaacagactggtgtagtgatcagttctc

SEQ ID NO: 351 - DNA, 41 bp, Artificial Sequence
  Primer Sequence NPHP3-16R
caggaaacagctatgaccacaagcacactatggctatcagc

SEQ ID NO: 352 - DNA, 44 bp, Artificial Sequence
  Primer Sequence NPHP3-17R
caggaaacagctatgacctagataggcattaatccatgaaaagg

SEQ ID NO: 353 - DNA, 44 bp, Artificial Sequence
  Primer Sequence NPHP3-18R
caggaaacagctatgacctgacattaacagaatagggagaggat

SEQ ID NO: 354 - DNA, 41 bp, Artificial Sequence
  Primer Sequence NPHP3-19R
caggaaacagctatgacctccagctctgatttcataaagca

SEQ ID NO: 355 - DNA, 42 bp, Artificial Sequence
  Primer Sequence NPHP3-21R
caggaaacagctatgaccttaccacatgaagactaggcacag

SEQ ID NO: 356 - DNA, 41 bp, Artificial Sequence
  Primer Sequence NPHP3-22R
caggaaacagctatgaccgggtgtatgcatttatgatgctc

SEQ ID NO: 357 - DNA, 40 bp, Artificial Sequence
  Primer Sequence NPHP3-23R
caggaaacagctatgaccaatagcttgaatgggaggtgga

SEQ ID NO: 358 - DNA, 45 bp, Artificial Sequence
  Primer Sequence NPHP3-24R
caggaaacagctatgaccgaatcaagaatcaatgtaaccagttca

SEQ ID NO: 359 - DNA, 48 bp, Artificial Sequence
  Primer Sequence NPHP3-25R
caggaaacagctatgaccggaccttcatacaagtctaacttcaatagt

SEQ ID NO: 360 - DNA, 42 bp, Artificial Sequence
  Primer Sequence NPHP3-26R
caggaaacagctatgaccatgatgcatacatatgctcctctg

SEQ ID NO: 361 - DNA, 40 bp, Artificial Sequence
  Primer Sequence NPHP3-27aR
caggaaacagctatgacctggaatgaactggcacaatctc

SEQ ID NO: 362 - DNA, 44 bp, Artificial Sequence
  Primer Sequence NPHP3-27bR
caggaaacagctatgaccaactactgagcagcaagtattgacaa

SEQ ID NO: 363 - DNA, 38 bp, Artificial Sequence
  Primer Sequence NPHP4-1FV3
tgtaaaacgacggccagtagcagcatcttcacctcgtg

SEQ ID NO: 364 - DNA, 41 bp, Artificial Sequence
  Primer Sequence NPHP4-2F
tgtaaaacgacggccagtccagcaacaaagtccactcttct

SEQ ID NO: 365 - DNA, 40 bp, Artificial Sequence
  Primer Sequence NPHP4-3F
tgtaaaacgacggccagtagaagcctgtgtctgttccaag

SEQ ID NO: 366 - DNA, 40 bp, Artificial Sequence
  Primer Sequence NPHP4-4F
tgtaaaacgacggccagtgttgttgggtgctctggaataa

SEQ ID NO: 367 - DNA, 38 bp, Artificial Sequence
  Primer Sequence NPHP4-5F
tgtaaaacgacggccagttcaattctcaggctgccttg

SEQ ID NO: 368 - DNA, 43 bp, Artificial Sequence
  Primer Sequence NPHP4-6F
tgtaaaacgacggccagtctaacattctctgttaattggctgg

SEQ ID NO: 369 - DNA, 41 bp, Artificial Sequence
  Primer Sequence NPHP4-7FV3
tgtaaaacgacggccagtgtttgcagatggttcaaggtaac

SEQ ID NO: 370 - DNA, 43 bp, Artificial Sequence
  Primer Sequence NPHP4-8F
tgtaaaacgacggccagtgcactcatcttgactaagcatcatc

SEQ ID NO: 371 - DNA, 41 bp, Artificial Sequence
  Primer Sequence NPHP4-9F
tgtaaaacgacggccagtttgactgttctgacagtggtcga

SEQ ID NO: 372 - DNA, 41 bp, Artificial Sequence
  Primer Sequence NPHP4-10F
tgtaaaacgacggccagttgctacactgagctctcgttgaa

SEQ ID NO: 373 - DNA, 40 bp, Artificial Sequence
  Primer Sequence NPHP4-11F
tgtaaaacgacggccagttcctggttggatcgttctgata

SEQ ID NO: 374 - DNA, 42 bp, Artificial Sequence
  Primer Sequence NPHP4-12F
tgtaaaacgacggccagtggctctagatagacagcgacactt

SEQ ID NO: 375 - DNA, 42 bp, Artificial Sequence
  Primer Sequence NPHP4-13F
tgtaaaacgacggccagtcatggaatcacctctctgtcatta

SEQ ID NO: 376 - DNA, 39 bp, Artificial Sequence
  Primer Sequence NPHP4-14-15
tgtaaaacgacggccagtcctccagaggcaattaatcga

SEQ ID NO: 377 - DNA, 45 bp, Artificial Sequence
  Primer Sequence NPHP4-16F
tgtaaaacgacggccagtcaggtcttagatcttagtgtagctcca

SEQ ID NO: 378 - DNA, 42 bp, Artificial Sequence
  Primer Sequence NPHP4-17F
tgtaaaacgacggccagtcagagctgaaatctcttccaagtg

SEQ ID NO: 379 - DNA, 40 bp, Artificial Sequence
  Primer Sequence NPHP4-18F
tgtaaaacgacggccagtacacgcttggctaagagtcctt

SEQ ID NO: 380 - DNA, 41 bp, Artificial Sequence
  Primer Sequence NPHP4-19F
tgtaaaacgacggccagtgcttatgtggtgggttgatctgt

SEQ ID NO: 381 - DNA, 41 bp, Artificial Sequence
  Primer Sequence NPHP4-20F
tgtaaaacgacggccagttcagaactctgcagattggagct

SEQ ID NO: 382 - DNA, 42 bp, Artificial Sequence
  Primer Sequence NPHP4-21-22F
tgtaaaacgacggccagttgaagagtctctcaggaataggca

SEQ ID NO: 383 - DNA, 41 bp, Artificial Sequence
  Primer Sequence NPHP4-23F
tgtaaaacgacggccagtatcgcttaaggtggacttgagat

SEQ ID NO: 384 - DNA, 39 bp, Artificial Sequence
  Primer Sequence NPHP4-24F
tgtaaaacgacggccagtaataatggcagtgtggctgct

SEQ ID NO: 385 - DNA, 45 bp, Artificial Sequence
  Primer Sequence NPHP4-25F
tgtaaaacgacggccagttcctgtcctatagtgtgtaatgtgtgg

SEQ ID NO: 386 - DNA, 41 bp, Artificial Sequence
  Primer Sequence NPHP4-26F
tgtaaaacgacggccagttcgctgcgtgtattagtcacaga

SEQ ID NO: 387 - DNA, 41 bp, Artificial Sequence
  Primer Sequence NPHP4-27F
tgtaaaacgacggccagtgacacttgtccaggatgtgtgtt

SEQ ID NO: 388 - DNA, 41 bp, Artificial Sequence
  Primer Sequence NPHP4-28-29F
tgtaaaacgacggccagtacagtcatgtcagggttggttgt

SEQ ID NO: 389 - DNA, 42 bp, Artificial Sequence
  Primer Sequence NPHP4-30F
tgtaaaacgacggccagtttcatggtaatgttagacagctca

SEQ ID NO: 390 - DNA, 42 bp, Artificial Sequence
  Primer Sequence NPHP4-1RV3
caggaaacagctatgacctaatgcctgagacccagatgcctt

SEQ ID NO: 391 - DNA, 41 bp, Artificial Sequence
  Primer Sequence NPHP4-2R
caggaaacagctatgaccatccatctgttaactggaagcct

SEQ ID NO: 392 - DNA, 42 bp, Artificial Sequence
  Primer Sequence NPHP4-3R
caggaaacagctatgacccagagcagagctctctcatctgtt

SEQ ID NO: 393 - DNA, 41 bp, Artificial Sequence
  Primer Sequence NPHP4-4R
caggaaacagctatgacccttctactgccaccataagacga

SEQ ID NO: 394 - DNA, 45 bp, Artificial Sequence
  Primer Sequence NPHP4-5R
caggaaacagctatgaccggtgacagagagctactacttcatctg

SEQ ID NO: 395 - DNA, 41 bp, Artificial Sequence
  Primer Sequence NPHP4-6R
caggaaacagctatgaccaactagactgccattccatcctc

SEQ ID NO: 396 - DNA, 39 bp, Artificial Sequence
  Primer Sequence NPHP4-7RV3
caggaaacagctatgacctaacatctcaggccaacagca

SEQ ID NO: 397 - DNA, 40 bp, Artificial Sequence
  Primer Sequence NPHP4-8R
caggaaacagctatgacctgggtgagtcaacacctgacat

SEQ ID NO: 398 - DNA, 40 bp, Artificial Sequence
  Primer Sequence NPHP4-9R
caggaaacagctatgaccaagcattcatgcccactacatt

SEQ ID NO: 399 - DNA, 42 bp, Artificial Sequence
  Primer Sequence NPHP4-0R
caggaaacagctatgacccaggaaatcagtatgtgaacagca

SEQ ID NO: 400 - DNA, 44 bp, Artificial Sequence
  Primer Sequence NPHP4-11R
caggaaacagctatgaccatgcaatctacgacgattatcttaca

SEQ ID NO: 401 - DNA, 44 bp, Artificial Sequence
  Primer Sequence NPHP4-12R
caggaaacagctatgacccttgcaagtaattgactctggaattc

SEQ ID NO: 402 - DNA, 41 bp, Artificial Sequence
  Primer Sequence NPHP4-13R
caggaaacagctatgacctaactaaggacaggcacagtgca

SEQ ID NO: 403 - DNA, 46 bp, Artificial Sequence
  Primer Sequence NPHP4-14-15R
caggaaacagctatgaccaatctagtaagacctcagcacagacagt

SEQ ID NO: 404 - DNA, 43 bp, Artificial Sequence
  Primer Sequence NPHP4-16R
caggaaacagctatgaccctggtcaccgtatgattctaatgtt

SEQ ID NO: 405 - DNA, 40 bp, Artificial Sequence
  Primer Sequence NPHP4-17R
caggaaacagctatgacctggtaggtcagtttgcaggaga

SEQ ID NO: 406 - DNA, 41 bp, Artificial Sequence
  Primer Sequence NPHP4-18R
caggaaacagctatgaccatgacctctaaccccaatcagaa

SEQ ID NO: 407 - DNA, 38 bp, Artificial Sequence
  Primer Sequence NPHP4-19R
caggaaacagctatgaccacctctcacacgccattcat

SEQ ID NO: 408 - DNA, 43 bp, Artificial Sequence
  Primer Sequence NPHP4-20R
caggaaacagctatgaccggaggaaggtaagagagaatcatgt

SEQ ID NO: 409 - DNA, 41 bp, Artificial Sequence
  Primer Sequence NPHP4-21-22R
caggaaacagctatgaccggagactggaagcattctcaatt

SEQ ID NO: 410 - DNA, 39 bp, Artificial Sequence
  Primer Sequence NPHP4-23R
caggaaacagctatgaccgcatttccgaccagataccat

SEQ ID NO: 411 - DNA, 39 bp, Artificial Sequence
  Primer Sequence NPHP4-24R
caggaaacagctatgaccaatgcgcacctagtcatctca

SEQ ID NO: 412 - DNA, 41 bp, Artificial Sequence
  Primer Sequence NPHP4-25R
caggaaacagctatgaccaatgaagaggatcccaggatacc

SEQ ID NO: 413 - DNA, 40 bp, Artificial Sequence
  Primer Sequence NPHP4-26R
caggaaacagctatgaccagcttcattcatgctgttcagc

SEQ ID NO: 414 - DNA, 40 bp, Artificial Sequence
  Primer Sequence NPHP4-27R
caggaaacagctatgaccccacaatggcacatctaacgaa

SEQ ID NO: 415 - DNA, 41 bp, Artificial Sequence
  Primer Sequence NPHP4-28-29R
caggaaacagctatgacctgatttgaggaactcgctcctaa

SEQ ID NO: 416 - DNA, 40 bp, Artificial Sequence
  Primer Sequence NPHP4-30R
caggaaacagctatgaccctgcaactacagtgccagtgaa

SEQ ID NO: 417 - DNA, 41 bp, Artificial Sequence
  Primer Sequence PKHD1-1F
tgtaaaacgacggccagtttcgggatgaagagtgagagact

SEQ ID NO: 418 - DNA, 38 bp, Artificial Sequence
  Primer Sequence PKHD1-2F
tgtaaaacgacggccagttggtggctccatttgaagac

SEQ ID NO: 419 - DNA, 39 bp, Artificial Sequence
  Primer Sequence PKHD1-3F
tgtaaaacgacggccagttggtgattctgaggcaggtta

SEQ ID NO: 420 - DNA, 41 bp, Artificial Sequence
  Primer Sequence PKHD1-4F
tgtaaaacgacggccagtcacactgtcctgtgtcaatgaca

SEQ ID NO: 421 - DNA, 39 bp, Artificial Sequence
  Primer Sequence PKHD1-5F
tgtaaaacgacggccagttgctgaaggacccagttctta

SEQ ID NO: 422 - DNA, 44 bp, Artificial Sequence
  Primer Sequence PKHD1-6F
tgtaaaacgacggccagtgaactagacagatgtgagggtgacat

SEQ ID NO: 423 - DNA, 40 bp, Artificial Sequence
  Primer Sequence PKHD1-7F
tgtaaaacgacggccagttgacctgctttgccatattgag

SEQ ID NO: 424 - DNA, 39 bp, Artificial Sequence
  Primer Sequence PKHD1-8F
tgtaaaacgacggccagtgtgtgaaagcatgagccatga

SEQ ID NO: 425 - DNA, 44 bp, Artificial Sequence
  Primer Sequence PKHD1-9FV2
tgtaaaacgacggccagtgtcagatcttctggtagtgagttgtc

SEQ ID NO: 426 - DNA, 38 bp, Artificial Sequence
  Primer Sequence PKHD1-10F
tgtaaaacgacggccagtttatgaaagcaatggcctgg

SEQ ID NO: 427 - DNA, 43 bp, Artificial Sequence
  Primer Sequence PKHD1-11F
tgtaaaacgacggccagtatagaggttagttcccaatcttcct

SEQ ID NO: 428 - DNA, 41 bp, Artificial Sequence
  Primer Sequence PKHD1-12F
tgtaaaacgacggccagtgctgataccatgaatgattccac

SEQ ID NO: 429 - DNA, 41 bp, Artificial Sequence
  Primer Sequence PKHD1-13F
tgtaaaacgacggccagtgtgacaactttcgctattccatc

SEQ ID NO: 430 - DNA, 46 bp, Artificial Sequence
  Primer Sequence PKHD1-14F
tgtaaaacgacggccagtaactactctatctggctctaggttgact

SEQ ID NO: 431 - DNA, 39 bp, Artificial Sequence
  Primer Sequence PKHD1-15F
tgtaaaacgacggccagttgttggttcagtgattcaggc

SEQ ID NO: 432 - DNA, 47 bp, Artificial Sequence
  Primer Sequence PKHD1-16F
tgtaaaacgacggccagtcttgatagtagcagttcagacacttagtg

SEQ ID NO: 433 - DNA, 42 bp, Artificial Sequence
  Primer Sequence PKHD1-17-18F
tgtaaaacgacggccagtatagcaagttgaggaggaatgtcc

SEQ ID NO: 434 - DNA, 41 bp, Artificial Sequence
  Primer Sequence PKHD1-19F
tgtaaaacgacggccagtaagtcttcttgtgccaacaactt

SEQ ID NO: 435 - DNA, 43 bp, Artificial Sequence
  Primer Sequence PKHD1-20F
tgtaaaacgacggccagtgatgtggactcctcactacgtattg

SEQ ID NO: 436 - DNA, 40 bp, Artificial Sequence
  Primer Sequence PKHD1-21F
tgtaaaacgacggccagtgcatgtcatggatgaatgattg

SEQ ID NO: 437 - DNA, 44 bp, Artificial Sequence
  Primer Sequence PKHD1-22F
tgtaaaacgacggccagtgcagcagataagtaggaatctatgct

SEQ ID NO: 438 - DNA, 40 bp, Artificial Sequence
  Primer Sequence PKHD1-23F
tgtaaaacgacggccagtgattctcacatcgagtggtcct

SEQ ID NO: 439 - DNA, 45 bp, Artificial Sequence
  Primer Sequence PKHD1-24F
tgtaaaacgacggccagtgtatgtatcgtgttatccttgaggatg

SEQ ID NO: 440 - DNA, 43 bp, Artificial Sequence
  Primer Sequence PKHD1-25F
tgtaaaacgacggccagttgattagacgagattagatttcggt

SEQ ID NO: 441 - DNA, 45 bp, Artificial Sequence
  Primer Sequence PKHD1-26F
tgtaaaacgacggccagtgaataagaattagcgaatcatgaacac

SEQ ID NO: 442 - DNA, 41 bp, Artificial Sequence
  Primer Sequence PKHD1-27F
tgtaaaacgacggccagtattcagcattcagctccttgaat

SEQ ID NO: 443 - DNA, 39 bp, Artificial Sequence
  Primer Sequence PKHD1-28F
tgtaaaacgacggccagttctgcctgtatggttggtgat

SEQ ID NO: 444 - DNA, 44 bp, Artificial Sequence
  Primer Sequence PKHD1-29F
tgtaaaacgacggccagtacttgcctactagtccaagcacttat

SEQ ID NO: 445 - DNA, 43 bp, Artificial Sequence
  Primer Sequence PKHD1-30-31F
tgtaaaacgacggccagtttagaattgaatagatggttgagcc

SEQ ID NO: 446 - DNA, 42 bp, Artificial Sequence
  Primer Sequence PKHD1-32aF
tgtaaaacgacggccagtattgaggtttcactaacacatgcc

SEQ ID NO: 447 - DNA, 40 bp, Artificial Sequence
  Primer Sequence PKHD1-32bF
tgtaaaacgacggccagttcataagggaagaggcaagtcc

SEQ ID NO: 448 - DNA, 39 bp, Artificial Sequence
  Primer Sequence PKHD1-33F
tgtaaaacgacggccagtagttgtgcggattctgaggat

SEQ ID NO: 449 - DNA, 40 bp, Artificial Sequence
  Primer Sequence PKHD1-34F
tgtaaaacgacggccagtggaacttcatttgtgaaaccga

SEQ ID NO: 450 - DNA, 39 bp, Artificial Sequence
  Primer Sequence PKHD1-35F
tgtaaaacgacggccagtcacaagctaatggcttgcaat

SEQ ID NO: 451 - DNA, 44 bp, Artificial Sequence
  Primer Sequence PKHD1-36F
tgtaaaacgacggccagtgaggatagatctgagcacttaggaag

SEQ ID NO: 452 - DNA, 46 bp, Artificial Sequence
  Primer Sequence PKHD1-37F
tgtaaaacgacggccagtagcagcagagaatagtaatagctaacct

SEQ ID NO: 453 - DNA, 43 bp, Artificial Sequence
  Primer Sequence PKHD1-38F
tgtaaaacgacggccagttagtgcttacctatcctgaagcttg

SEQ ID NO: 454 - DNA, 45 bp, Artificial Sequence
  Primer Sequence PKHD1-39F
tgtaaaacgacggccagtattcctagtaagatttggagtgatgtc

SEQ ID NO: 455 - DNA, 41 bp, Artificial Sequence
  Primer Sequence PKHD1-40F
tgtaaaacgacggccagttgtctggaagcatgttctacatg

SEQ ID NO: 456 - DNA, 45 bp, Artificial Sequence
  Primer Sequence PKHD1-41F
tgtaaaacgacggccagtggagaatgtctttagctacagtgtagg

SEQ ID NO: 457 - DNA, 43 bp, Artificial Sequence
  Primer Sequence PKHD1-42-43F
tgtaaaacgacggccagtgaagtagtgttgcagcatctcttgt

SEQ ID NO: 458 - DNA, 41 bp, Artificial Sequence
  Primer Sequence PKHD1-44F
tgtaaaacgacggccagttccagcaaccttatcatacatgg

SEQ ID NO: 459 - DNA, 44 bp, Artificial Sequence
  Primer Sequence PKHD1-45F
tgtaaaacgacggccagtcacagattccatctaccttcattctc

SEQ ID NO: 460 - DNA, 43 bp, Artificial Sequence
  Primer Sequence PKHD1-46F
tgtaaaacgacggccagtgatgcctatactgacattgatggac

SEQ ID NO: 461 - DNA, 40 bp, Artificial Sequence
  Primer Sequence PKHD1-47F
tgtaaaacgacggccagtttgtcatatgtgtgattggcaa

SEQ ID NO: 462 - DNA, 42 bp, Artificial Sequence
  Primer Sequence PKHD1-48F
tgtaaaacgacggccagtatcctaagaccatcactccagtga

SEQ ID NO: 463 - DNA, 43 bp, Artificial Sequence
  Primer Sequence PKHD1-49F
tgtaaaacgacggccagtgcctaagacatatgtggagagaatg

SEQ ID NO: 464 - DNA, 41 bp, Artificial Sequence
  Primer Sequence PKHD1-50F
tgtaaaacgacggccagtaactactccatctgcgttctctg

SEQ ID NO: 465 - DNA, 42 bp, Artificial Sequence
  Primer Sequence PKHD1-51F
tgtaaaacgacggccagttggcttccttagaacatatggcta

SEQ ID NO: 466 - DNA, 45 bp, Artificial Sequence
  Primer Sequence PKHD1-52F
tgtaaaacgacggccagtcagaagtgaaggtaatctaaggattga

SEQ ID NO: 467 - DNA, 44 bp, Artificial Sequence
  Primer Sequence PKHD1-53F
tgtaaaacgacggccagttagataacactgtacacagctcccaa

SEQ ID NO: 468 - DNA, 45 bp, Artificial Sequence
  Primer Sequence PKHD1-54F
tgtaaaacgacggccagtctactcttatttcatctgcatgaccat

SEQ ID NO: 469 - DNA, 40 bp, Artificial Sequence
  Primer Sequence PKHD1-55F
tgtaaaacgacggccagtttggagtcacgtaagagtggaa

SEQ ID NO: 470 - DNA, 41 bp, Artificial Sequence
  Primer Sequence PKHD1-56F
tgtaaaacgacggccagtggatatgttggtcacagtggatt

SEQ ID NO: 471 - DNA, 44 bp, Artificial Sequence
  Primer Sequence PKHD1-57F
tgtaaaacgacggccagtaagcagaccttaatgttggtagaact

SEQ ID NO: 472 - DNA, 43 bp, Artificial Sequence
  Primer Sequence PKHD1-58F
tgtaaaacgacggccagtaatacacagaatcgttaaacttggc

SEQ ID NO: 473 - DNA, 45 bp, Artificial Sequence
  Primer Sequence PKHD1-59F
tgtaaaacgacggccagtggctatcctggatagctttaactaact

SEQ ID NO: 474 - DNA, 44 bp, Artificial Sequence
  Primer Sequence PKHD1-60F
tgtaaaacgacggccagtatgttcagttgttatgagaggaacac

SEQ ID NO: 475 - DNA, 38 bp, Artificial Sequence
  Primer Sequence PKHD1-61F
tgtaaaacgacggccagtggatgcaatgtggaaagcat

SEQ ID NO: 476 - DNA, 43 bp, Artificial Sequence
  Primer Sequence PKHD1-62F
tgtaaaacgacggccagtgcactctcagtatctggcacaatta

SEQ ID NO: 477 - DNA, 42 bp, Artificial Sequence
  Primer Sequence PKHD1-63F
tgtaaaacgacggccagttcactggtaataatggattgtgga

SEQ ID NO: 478 - DNA, 43 bp, Artificial Sequence
  Primer Sequence PKHD1-64F
tgtaaaacgacggccagtccaacttgtcttgcaataatttcct

SEQ ID NO: 479 - DNA, 44 bp, Artificial Sequence
  Primer Sequence PKHD1-65F
tgtaaaacgacggccagtgaagaacctgatggattaggtaacct

SEQ ID NO: 480 - DNA, 44 bp, Artificial Sequence
  Primer Sequence PKHD1-66F
tgtaaaacgacggccagttgtgttattgttggaatcttgtgatt

SEQ ID NO: 481 - DNA, 45 bp, Artificial Sequence
  Primer Sequence PKHD1-67F
tgtaaaacgacggccagtccataaagttggtggtcagtatatagg

SEQ ID NO: 482 - DNA, 44 bp, Artificial Sequence
  Primer Sequence PKHD1-68aF
tgtaaaacgacggccagtatcttgtcagaaatgctaagtatgca

SEQ ID NO: 483 - DNA, 44 bp, Artificial Sequence
  Primer Sequence PKHD1-68bF
tgtaaaacgacggccagtcagtgattctctctgttagtagctgg

SEQ ID NO: 484 - DNA, 43 bp, Artificial Sequenceq
  Primer Sequence PKHD1-68cF
tgtaaaacgacggccagtagagttagctgccagctctgttatt

SEQ ID NO: 485 - DNA, 47 bp, Artificial Sequence
  Primer Sequence PKHD1-1R
caggaaacagctatgaccgaacgttaacaagagatacaacacctaga

SEQ ID NO: 486 - DNA, 47 bp, Artificial Sequence
  Primer Sequence PKHD1-2R
caggaaacagctatgaccatagttctcaaggtaacctattgtgttct

SEQ ID NO: 487 - DNA, 41 bp, Artificial Sequence
  Primer Sequence PKHD1-3R
caggaaacagctatgaccagaagttggtcagtctgttcgtc

SEQ ID NO: 488 - DNA, 47 bp, Artificial Sequence
  Primer Sequence PKHD1-4R
caggaaacagctatgaccatactctcatcctccgttaagttctagac

SEQ ID NO: 489 - DNA, 41 bp, Artificial Sequence
  Primer Sequence PKHD1-5R
caggaaacagctatgaccagacacgctggctcatttacaat

SEQ ID NO: 490 - DNA, 41 bp, Artificial Sequence
  Primer Sequence PKHD1-6R
caggaaacagctatgaccactcacctaggtttgcaacaagc

SEQ ID NO: 491 - DNA, 39 bp, Artificial Sequence
  Primer Sequence PKHD1-7R
caggaaacagctatgaccagcaattctgtgccaactgct

SEQ ID NO: 492 - DNA, 41 bp, Artificial Sequence
  Primer Sequence PKHD1-8R
caggaaacagctatgaccgtgttgtatccatgtggacgaac

SEQ ID NO: 493 - DNA, 40 bp, Artificial Sequence
  Primer Sequence PKHD1-9RV2
caggaaacagctatgacccttcgagttagatggagcacca

SEQ ID NO: 494 - DNA, 41 bp, Artificial Sequence
  Primer Sequence PKHD1-10R
caggaaacagctatgaccacacaacttcattcacccaggta

SEQ ID NO: 495 - DNA, 39 bp, Artificial Sequence
  Primer Sequence PKHD1-11R
caggaaacagctatgacccaacattgagtgaggcacaag

SEQ ID NO: 496 - DNA, 45 bp, Artificial Sequence
  Primer Sequence PKHD1-12R
caggaaacagctatgacccctcatgccatacagacatataatctc

SEQ ID NO: 497 - DNA, 42 bp, Artificial Sequence
  Primer Sequence PKHD1-13R
caggaaacagctatgaccgagagccttgacaatggtatcatg

SEQ ID NO: 498 - DNA, 43 bp, Artificial Sequence
  Primer Sequence PKHD1-14R
caggaaacagctatgacccttatctgtctcctagcctcaccta

SEQ ID NO: 499 - DNA, 39 bp, Artificial Sequence
  Primer Sequence PKHD1-15R
caggaaacagctatgaccttcttcatgggtatgggactg

SEQ ID NO: 500 - DNA, 42 bp, Artificial Sequence
  Primer Sequence PKHD1-16R
caggaaacagctatgaccttgacagcaaggttataatgaccc

SEQ ID NO: 501 - DNA, 39 bp, Artificial Sequence
  Primer Sequence PKHD1-17-18R
caggaaacagctatgacctcagccactcagtgtccaaat

SEQ ID NO: 502 - DNA, 43 bp, Artificial Sequence
  Primer Sequence PKHD1-19R
caggaaacagctatgaccttgaatccagagagcaataccaata

SEQ ID NO: 503 - DNA, 44 bp, Artificial Sequence
  Primer Sequence PKHD1-20R
caggaaacagctatgaccatataagaccattagtgcctgaggtg

SEQ ID NO: 504 - DNA, 47 bp, Artificial Sequence
  Primer Sequence PKHD1-21R
caggaaacagctatgaccggagtaagaatacagacaccagaagtaag

SEQ ID NO: 505 - DNA, 43 bp, Artificial Sequence
  Primer Sequence PKHD1-22R
caggaaacagctatgaccctgcattctcaagattgagaacatt

SEQ ID NO: 506 - DNA, 43 bp, Artificial Sequence
  Primer Sequence PKHD1-23R
caggaaacagctatgacctattatcacctgtctgacaacctcc

SEQ ID NO: 507 - DNA, 38 bp, Artificial Sequence
  Primer Sequence PKHD1-24R
caggaaacagctatgaccagaatttctccagggcagca

SEQ ID NO: 508 - DNA, 44 bp, Artificial Sequence
  Primer Sequence PKHD1-25R
caggaaacagctatgaccatcagtgaggagtgagttagacttga

SEQ ID NO: 509 - DNA, 43 bp, Artificial Sequence
  Primer Sequence PKHD1-26R
caggaaacagctatgacccactcaacctctgcctaatgaacta

SEQ ID NO: 510 - DNA, 44 bp, Artificial Sequence
  Primer Sequence PKHD1-27R
caggaaacagctatgaccacagaaggactagattcctatcagca

SEQ ID NO: 511 - DNA, 43 bp, Artificial Sequence
  Primer Sequence PKHD1-28R
caggaaacagctatgaccgatgttaattacaagctccattggt

SEQ ID NO: 512 - DNA, 41 bp, Artificial Sequence
  Primer Sequence PKHD1-29R
caggaaacagctatgacctgattcgatgatggctaagatga

SEQ ID NO: 513 - DNA, 42 bp, Artificial Sequence
  Primer Sequence PKHD1-30-31R
caggaaacagctatgacctctgacctcactggcaaattaatc

SEQ ID NO: 514 - DNA, 41 bp, Artificial Sequence
  Primer Sequence PKHD1-32aR
caggaaacagctatgacctaatcagcacagtggtcagagac

SEQ ID NO: 515 - DNA, 41 bp, Artificial Sequence
  Primer Sequence PKHD1-32bR
caggaaacagctatgacccttccatcaggcagattgtgtta

SEQ ID NO: 516 - DNA, 42 bp, Artificial Sequence
  Primer Sequence PKHD1-33R
caggaaacagctatgacctaacaggtggcctcagattctaac

SEQ ID NO: 517 - DNA, 41 bp, Artificial Sequence
  Primer Sequence PKHD1-34R
caggaaacagctatgaccctacactctctgatggctccatc

SEQ ID NO: 518 - DNA, 41 bp, Artificial Sequence
  Primer Sequence PKHD1-35R
caggaaacagctatgacctgtgcattagaccagcttctcaa

SEQ ID NO: 519 - DNA, 45 bp, Artificial Sequence
  Primer Sequence PKHD1-36RV2
caggaaacagctatgacccctctgaccacttcttcctttacatag

SEQ ID NO: 520 - DNA, 40 bp, Artificial Sequence
  Primer Sequence PKHD1-37R
caggaaacagctatgacccatgctctaactgacctggttg

SEQ ID NO: 521 - DNA, 46 bp, Artificial Sequence
  Primer Sequence PKHD1-38R
caggaaacagctatgaccccaatacagttaagatctcatcttcttc

SEQ ID NO: 522 - DNA, 39 bp, Artificial Sequence
  Primer Sequence PKHD1-39R
caggaaacagctatgacccaaccacagcaatgccatcta

SEQ ID NO: 523 - DNA, 44 bp, Artificial Sequence
  Primer Sequence PKHD1-40R
caggaaacagctatgaccttcctaagcctaccttagaccagaat

SEQ ID NO: 524 - DNA, 44 bp, Artificial Sequence
  Primer Sequence PKHD1-41R
caggaaacagctatgaccagtaagccaatcagtgatgactacat

SEQ ID NO: 525 - DNA, 40 bp, Artificial Sequence
  Primer Sequence PKHD1-42-43R
caggaaacagctatgacccctctcagttctggtcttcctg

SEQ ID NO: 526 - DNA, 42 bp, Artificial Sequence
  Primer Sequence PKHD1-44R
caggaaacagctatgaccagtgctctcattgtgagcattcta

SEQ ID NO: 527 - DNA, 43 bp, Artificial Sequence
  Primer Sequence PKHD1-45R
caggaaacagctatgacccctggattagtgactaggaatttgt

SEQ ID NO: 528 - DNA, 47 bp, Artificial Sequence
  Primer Sequence PKHD1-46R
caggaaacagctatgaccacttaggcacatattagtgaatcacatac

SEQ ID NO: 529 - DNA, 40 bp, Artificial Sequence
  Primer Sequence PKHD1-47R
caggaaacagctatgaccggagaacctccaggatgtcttt

SEQ ID NO: 530 - DNA, 43 bp, Artificial Sequence
  Primer Sequence PKHD1-48R
caggaaacagctatgaccactaccatacactcatgattcagca

SEQ ID NO: 531 - DNA, 42 bp, Artificial Sequence
  Primer Sequence PKHD1-49R
caggaaacagctatgacccaataacgagataacctgctcctc

SEQ ID NO: 532 - DNA, 40 bp, Artificial Sequence
  Primer Sequence PKHD1-50R
caggaaacagctatgaccgtctggaattgaagggtgattg

SEQ ID NO: 533 - DNA, 45 bp, Artificial Sequence
  Primer Sequence PKHD1-51R
caggaaacagctatgaccattaacagtatgacaaggtggaatttg

SEQ ID NO: 534 - DNA, 41 bp, Artificial Sequence
  Primer Sequence PKHD1-52R
caggaaacagctatgaccaacataatcagatctggctgggt

SEQ ID NO: 535 - DNA, 42 bp, Artificial Sequence
  Primer Sequence PKHD1-53R
caggaaacagctatgaccactctgttaagcaacctgcttgat

SEQ ID NO: 536 - DNA, 44 bp, Artificial Sequence
  Primer Sequence PKHD1-54R
caggaaacagctatgacctactcacaagagagctggtaagtgaa

SEQ ID NO: 537 - DNA, 40 bp, Artificial Sequence
  Primer Sequence PKHD1-55R
caggaaacagctatgaccttctttactgcctccaatgcat

SEQ ID NO: 538 - DNA, 39 bp, Artificial Sequence
  Primer Sequence PKHD1-56R
caggaaacagctatgacccctctgaatggcaatcagatc

SEQ ID NO: 539 - DNA, 47 bp, Artificial Sequence
  Primer Sequence PKHD1-57R
caggaaacagctatgacccactgataattaagcacagattaggactg

SEQ ID NO: 540 - DNA, 43 bp, Artificial Sequence
  Primer Sequence PKHD1-58R
caggaaacagctatgacccattgtggctatcaatactcagcag

SEQ ID NO: 541 - DNA, 40 bp, Artificial Sequence
  Primer Sequence PKHD1-59R
caggaaacagctatgaccatcacatggctgagtccagatt

SEQ ID NO: 542 - DNA, 44 bp, Artificial Sequence
  Primer Sequence PKHD1-60R
caggaaacagctatgacccagattagcacagactccaactctag

SEQ ID NO: 543 - DNA, 40 bp, Artificial Sequence
  Primer Sequence PKHD1-61R
caggaaacagctatgaccacctgccttgacaactcacatt

SEQ ID NO: 544 - DNA, 42 bp, Artificial Sequence
  Primer Sequence PKHD1-62R
caggaaacagctatgacctgcaacatatgtcaatatggacct

SEQ ID NO: 545 - DNA, 45 bp, Artificial Sequence
  Primer Sequence PKHD1-63R
caggaaacagctatgaccgtgaaagtactcagaagctctaagtgc

SEQ ID NO: 546 - DNA, 45 bp, Artificial Sequence
  Primer Sequence PKHD1-64R
caggaaacagctatgacccagtccatgatactataccaaacaagg

SEQ ID NO: 547 - DNA, 46 bp, Artificial Sequence
  Primer Sequence PKHD1-65R
caggaaacagctatgacctcaagcttaatgatacagtcaagtgaat

SEQ ID NO: 548 - DNA, 47 bp, Artificial Sequence
  Primer Sequence PKHD1-66R
caggaaacagctatgaccattacttaagattaggcaatccttgtctc

SEQ ID NO: 549 - DNA, 41 bp, Artificial Sequence
  Primer Sequence PKHD1-67R
caggaaacagctatgacctggtgaatagctgagtgaaccag

SEQ ID NO: 550 - DNA, 43 bp, Artificial Sequence
  Primer Sequence PKHD1-68aR
caggaaacagctatgaccaatgtatcaataccaggtgagcctt

SEQ ID NO: 551 - DNA, 45 bp, Artificial Sequence
  Primer Sequence PKHD1-68bR
caggaaacagctatgaccactggtcttgtgacacatagaggataa

SEQ ID NO: 552 - DNA, 47 bp, Artificial Sequence
  Primer Sequence PKHD1-68cR
caggaaacagctatgaccggactgataagagataatgtatggacaat

SEQ ID NO: 553 - DNA, 41 bp, Artificial Sequence
  Primer Sequence SEC63-1F
tgtaaaacgacggccagtaattaatccagagggcaggacag

SEQ ID NO: 554 - DNA, 45 bp, Artificial Sequence
  Primer Sequence SEC63-2F
tgtaaaacgacggccagttaagcgtggtaatgaaggttagttaac

SEQ ID NO: 555 - DNA, 49 bp, Artificial Sequence
  Primer Sequence SEC63-3F
tgtaaaacgacggccagtgagtcagtagcatagtgatatggtactactg

SEQ ID NO: 556 - DNA, 40 bp, Artificial Sequence
  Primer Sequence SEC63-4F
tgtaaaacgacggccagtattacaggctgtgcctggccta

SEQ ID NO: 557 - DNA, 40 bp, Artificial Sequence
  Primer Sequence SEC63-5F
tgtaaaacgacggccagtatgagttggttggctaatggag

SEQ ID NO: 558 - DNA, 43 bp, Artificial Sequence
  Primer Sequence SEC63-7F
tgtaaaacgacggccagttatgtaacccatgtgtactgcaggt

SEQ ID NO: 559 - DNA, 38 bp, Artificial Sequence
  Primer Sequence SEC63-8F
tgtaaaacgacggccagtcaggctggtctcaaactcct

SEQ ID NO: 560 - DNA, 44 bp, Artificial Sequence
  Primer Sequence SEC63-9F
tgtaaaacgacggccagttcaagtgaattaagtatctcaggagg

SEQ ID NO: 561 - DNA, 40 bp, Artificial Sequence
  Primer Sequence SEC63-11F
tgtaaaacgacggccagtggccacagtgataaagatgctt

SEQ ID NO: 562 - DNA, 45 bp, Artificial Sequence
  Primer Sequence SEC63-12F
tgtaaaacgacggccagtgtgatgaattgtatactcctgaacatg

SEQ ID NO: 563 - DNA, 46 bp, Artificial Sequence
  Primer Sequence SEC63-13F
tgtaaaacgacggccagtaagctttgtgagttagggaattatgtat

SEQ ID NO: 564 - DNA, 47 bp, Artificial Sequence
  Primer Sequence SEC63-14F
tgtaaaacgacggccagtgagagccttatacagagtagtcaatcagt

SEQ ID NO: 565 - DNA, 44 bp, Artificial Sequence
  Primer Sequence SEC63-15F
tgtaaaacgacggccagtacgtctccttctttgtcaattgtagc

SEQ ID NO: 566 - DNA, 48 bp, Artificial Sequence
  Primer Sequence SEC63-17F
tgtaaaacgacggccagtgattcagattgatatgttctcattgagata

SEQ ID NO: 567 - DNA, 45 bp, Artificial Sequence
  Primer Sequence SEC63-18F
tgtaaaacgacggccagtcggctatgtagttgatactacagtggt

SEQ ID NO: 568 - DNA, 41 bp, Artificial Sequence
  Primer Sequence SEC63-19F
tgtaaaacgacggccagtttgtaccaagcagtttgtcagtg

SEQ ID NO: 569 - DNA, 45 bp, Artificial Sequence
  Primer Sequence SEC63-20F
tgtaaaacgacggccagtggctgttaaatactgtggtctaggaat

SEQ ID NO: 570 - DNA, 45 bp, Artificial Sequence
  Primer Sequence SEC63-21aF
tgtaaaacgacggccagtgatatgactcagtgttcttgctcaaga

SEQ ID NO: 571 - DNA, 46 bp, Artificial Sequence
  Primer Sequence SEC63-21bF
tgtaaaacgacggccagtcaagttgataatctcttgataagctctg

SEQ ID NO: 572 - DNA, 40 bp, Artificial Sequence
  Primer Sequence SEC63-1R
caggaaacagctatgaccacaatgaagggaggtggagaag

SEQ ID NO: 573 - DNA, 46 bp, Artificial Sequence
  Primer Sequence SEC63-2R
caggaaacagctatgaccgacacaatgacttattcatcattacacg

SEQ ID NO: 574 - DNA, 51 bp, Artificial Sequence
  Primer Sequence SEC63-3R
caggaaacagctatgaccattattaataacataacaatcaacagttatagc

SEQ ID NO: 575 - DNA, 44 bp, Artificial Sequence
  Primer Sequence SEC63-4R
caggaaacagctatgacctggagtattactgtcatcgaagttgg

SEQ ID NO: 576 - DNA, 46 bp, Artificial Sequence
  Primer Sequence SEC63-6R
caggaaacagctatgaccgttcttcttgtattaccaagacagattg

SEQ ID NO: 577 - DNA, 46 bp, Artificial Sequence
  Primer Sequence SEC63-7R
caggaaacagctatgaccggatcaatgggttatattctaacataca

SEQ ID NO: 578 - DNA, 40 bp, Artificial Sequence
  Primer Sequence SEC63-8R
caggaaacagctatgacctgcacgcataaggattatggta

SEQ ID NO: 579 - DNA, 38 bp, Artificial Sequence
  Primer Sequence SEC63-10R
caggaaacagctatgaccccatcagaacaatgagccaa

SEQ ID NO: 580 - DNA, 42 bp, Artificial Sequence
  Primer Sequence SEC63-11R
caggaaacagctatgaccaagtacaatctgcatatgcttgca

SEQ ID NO: 581 - DNA, 43 bp, Artificial Sequence
  Primer Sequence SEC63-12R
caggaaacagctatgaccatgttaacagaaccacctgagagaa

SEQ ID NO: 582 - DNA, 45 bp, Artificial Sequence
  Primer Sequence SEC63-13R
caggaaacagctatgacccagacttcatcccattatgaggataat

SEQ ID NO: 583 - DNA, 46 bp, Artificial Sequence
  Primer Sequence SEC63-14R
caggaaacagctatgacccacagctcaagaactatatccacattac

SEQ ID NO: 584 - DNA, 44 bp, Artificial Sequence
  Primer Sequence SEC63-16R
caggaaacagctatgaccgaagctgtacacgtaagacttgaaca

SEQ ID NO: 585 - DNA, 46 bp, Artificial Sequence
  Primer Sequence SEC63-17R
caggaaacagctatgacctctgtataaccttgactaccattcctta

SEQ ID NO: 586 - DNA, 47 bp, Artificial Sequence
  Primer Sequence SEC63-18R
caggaaacagctatgacccaccattacacataacactcagtaatcag

SEQ ID NO: 587 - DNA, 42 bp, Artificial Sequence
  Primer Sequence SEC63-19R
caggaaacagctatgaccgatatatgaagcagcatgatggtg

SEQ ID NO: 588 - DNA, 38 bp, Artificial Sequence
  Primer Sequence SEC63-20R
caggaaacagctatgaccaagaacccatttgctgaggc

SEQ ID NO: 589 - DNA, 44 bp, Artificial Sequence
  Primer Sequence SEC63-21aR
caggaaacagctatgaccatcctgcattgatctgctaagataga

SEQ ID NO: 590 - DNA, 47 bp, Artificial Sequence
  Primer Sequence SEC63-21bR
caggaaacagctatgacctctcactaaactggtgattgaggttatag

SEQ ID NO: 591 - DNA, 14137 bp, Artificial Sequence
  Primer Sequence PKD1 cDNA
gcactgcagcgccagcgtccgagcgggcggccgagctcccggagcggcctggccccgagccccgagcgggcgtcgctcagcagcaggtcgcggccgcagccccatccagccccgcgcccgccatgccgtccgcgggccccgcctgagctgcggcctccgcgcgcgggcgggcctggggacggcggggccatgcgcgcgctgccctaacgatgccgcccgccgcgcccgcccgcctggcgctggccctgggcctgggcctgtggctcggggcgctggcggggggccccgggcgcggctgcgggccctgcgagcccccctgcctctgcggcccagcgcccggcgccgcctgccgcgtcaactgctcgggccgcgggctgcggacgctcggtcccgcgctgcgcatccccgcggacgccacagcgctagacgtctcccacaacctgctccgggcgctggacgttgggctcctggcgaacctctcggcgctggcagagctggatataagcaacaacaagatttctacgttagaagaaggaatatttgctaatttatttaatttaagtgaaataaacctgagtgggaacccgtttgagtgtgactgtggcctggcgtggctgccgcgatgggcggaggagcagcaggtgcgggtggtgcagcccgaggcagccacgtgtgctgggcctggctccctggctggccagcctctgcttggcatccccttgctggacagtggctgtggtgaggagtatgtcgcctgcctccctgacaacagctcaggcaccgtggcagcagtgtccttttcagctgcccacgaaggcctgcttcagccagaggcctgcagcgccttctgcttctccaccggccagggcctcgcagccctctcggagcagggctggtgcctgtgtggggcggcccagccctccagtgcctcctttgcctgcctgtccctctgctccggccccccgccacctcctgcccccacctgtaggggccccaccctcctccagcacgtcttccctgcctccccaggggccaccctggtggggccccacggacctctggcctctggccagctagcagccttccacatcgctgccccgctccctgtcactgccacacgctgggacttcggagacggctccgccgaggtggatgccgctgggccggctgcctcgcatcgctatgtgctgcctgggcgctatcacgtgacggccgtgctggccctgggggccggctcagccctgctggggacagacgtgcaggtggaagcggcacctgccgccctggagctcgtgtgcccgtcctcggtgcagagtgacgagagcctcgacctcagcatccagaaccgcggtggttcaggcctggaggccgcctacagcatcgtggccctgggcgaggagccggcccgagcggtgcacccgctctgcccctcggacacggagatcttccctggcaacgggcactgctaccgcctggtggtggagaaggcggcctggctgcaggcgcaggagcagtgtcaggcctgggccggggccgccctggcaatggtggacagtcccgccgtgcagcgcttcctggtctcccgggtcaccaggagcctagacgtgtggatcggcttctcgactgtgcagggggtggaggtgggcccagcgccgcagggcgaggccttcagcctggagagctgccagaactggctgcccggggagccacacccagccacagccgagcactgcgtccggctcgggcccaccgggtggtgtaacaccgacctgtgctcagcgccgcacagctacgtctgcgagctgcagcccggaggcccagtgcaggatgccgagaacctcctcgtgggagcgcccagtggggacctgcagggacccctgacgcctctggcacagcaggacggcctctcagccccgcacgagcccgtggaggtcatggtattcccgggcctgcgtctgagccgtgaagccttcctcaccacggccgaatttgggacccaggagctccggcggcccgcccagctgcggctgcaggtgtaccggctcctcagcacagcagggaccccggagaacggcagcgagcctgagagcaggtccccggacaacaggacccagctggcccccgcgtgcatgccagggggacgctggtgccctggagccaacatctgcttgccgctggacgcctcctgccacccccaggcctgcgccaatggctgcacgtcagggccagggctacccggggccccctatgcgctatggagagagttcctcttctccgttcccgcggggccccccgcgcagtactcggtcaccctccacggccaggatgtcctcatgctccctggtgacctcgttggcttgcagcacgacgctggccctggcgccctcctgcactgctcgccggctcccggccaccctggtccccgggccccgtacctctccgccaacgcctcgtcatggctgccccacttgccagcccagctggagggcacttgggcctgccctgcctgtgccctgcggctgcttgcagccacggaacagctcaccgtgctgctgggcttgaggcccaaccctggactgcggctgcctgggcgctatgaggtccgggcagaggtgggcaatggcgtgtccaggcacaacctctcctgcagctttgacgtggtctccccagtggctgggctgcgggtcatctaccctgccccccgcgacggccgcctctacgtgcccaccaacggctcagccttggtgctccaggtggactctggtgccaacgccacggccacggctcgctggcctgggggcagtgtcagcgcccgctttgagaatgtctgccctgccctggtggccaccttcgtgcccggctgcccctgggagaccaacgataccctgttctcagtggtagcactgccgtggctcagtgagggggagcacgtggtggacgtggtggtggaaaacagcgccagccgggccaacctcagcctgcgggtgacggcggaggagcccatctgtggcctccgcgccacgcccagccccgaggcccgtgtactgcagggagtcctagtgaggtacagccccgtggtggaggccggctcggacatggtcttccggtggaccatcaacgacaagcagtccctgaccttccagaacgtggtcttcaatgtcatttatcagagcgcggcggtcttcaagctctcactgacggcctccaaccacgtgagcaacgtcaccgtgaactacaacgtaaccgtggagcggatgaacaggatgcagggtctgcaggtctccacagtgccggccgtgctgtcccccaatgccacgctagcactgacggcgggcgtgctggtggactcggccgtggaggtggccttcctgtggacctttggggatggggagcaggccctccaccagttccagcctccgtacaacgagtccttcccggttccagacccctcggtggcccaggtgctggtggagcacaatgtcatgcacacctacgctgccccaggtgagtacctcctgaccgtgctggcatctaatgccttcgagaacctgacgcagcaggtgcctgtgagcgtgcgcgcctccctgccctccgtggctgtgggtgtgagtgacggcgtcctggtggccggccggcccgtcaccttctacccgcacccgctgccctcgcctgggggtgttctttacacgtgggacttcggggacggctcccctgtcctgacccagagccagccggctgccaaccacacctatgcctcgaggggcacctaccacgtgcgcctggaggtcaacaacacggtgagcggtgcggcggcccaggcggatgtgcgcgtctttgaggagctccgcggactcagcgtggacatgagcctggccgtggagcagggcgcccccgtggtggtcagcgccgcggtgcagacgggcgacaacatcacgtggaccttcgacatgggggacggcaccgtgctgtcgggcccggaggcaacagtggagcatgtgtacctgcgggcacagaactgcacagtgaccgtgggtgcggccagccccgccggccacctggcccggagcctgcacgtgctggtcttcgtcctggaggtgctgcgcgttgaacccgccgcctgcatccccacgcagcctgacgcgcggctcacggcctacgtcaccgggaacccggcccactacctcttcgactggaccttcggggatggctcctccaacacgaccgtgcgggggtgcccgacggtgacacacaacttcacgcggagcggcacgttccccctggcgctggtgctgtccagccgcgtgaacagggcgcattacttcaccagcatctgcgtggagccagaggtgggcaacgtcaccctgcagccagagaggcagtttgtgcagctcggggacgaggcctggctggtggcatgtgcctggcccccgttcccctaccgctacacctgggactttggcaccgaggaagccgcccccacccgtgccaggggccctgaggtgacgttcatctaccgagacccaggctcctatcttgtgacagtcaccgcgtccaacaacatctctgctgccaatgactcagccctggtggaggtgcaggagcccgtgctggtcaccagcatcaaggtcaatggctcccttgggctggagctgcagcagccgtacctgttctctgctgtgggccgtgggcgccccgccagctacctgtgggatctgggggacggtgggtggctcgagggtccggaggtcacccacgcttacaacagcacaggtgacttcaccgttagggtggccggctggaatgaggtgagccgcagcgaggcctggctcaatgtgacggtgaagcggcgcgtgcgggggctcgtcgtcaatgcaagccgcacggtggtgcccctgaatgggagcgtgagcttcagcacgtcgctggaggccggcagtgatgtgcgctattcctgggtgctctgtgaccgctgcacgcccatccctgggggtcctaccatctcttacaccttccgctccgtgggcaccttcaatatcatcgtcacggctgagaacgaggtgggctccgcccaggacagcatcttcgtctatgtcctgcagctcatagaggggctgcaggtggtgggcggtggccgctacttccccaccaaccacacggtacagctgcaggccgtggttagggatggcaccaacgtctcctacagctggactgcctggagggacaggggcccggccctggccggcagcggcaaaggcttctcgctcaccgtgctcgaggccggcacctaccatgtgcagctgcgggccaccaacatgctgggcagcgcctgggccgactgcaccatggacttcgtggagcctgtggggtggctgatggtggccgcctccccgaacccagctgccgtcaacacaagcgtcaccctcagtgccgagctggctggtggcagtggtgtcgtatacacttggtccttggaggaggggctgagctgggagacctccgagccatttaccacccatagcttccccacacccggcctgcacttggtcaccatgacggcagggaacccgctgggctcagccaacgccaccgtggaagtggatgtgcaggtgcctgtgagtggcctcagcatcagggccagcgagcccggaggcagcttcgtggcggccgggtcctctgtgcccttttgggggcagctggccacgggcaccaatgtgagctggtgctgggctgtgcccggcggcagcagcaagcgtggccctcatgtcaccatggtcttcccggatgctggcaccttctccatccggctcaatgcctccaacgcagtcagctgggtctcagccacgtacaacctcacggcggaggagcccatcgtgggcctggtgctgtgggccagcagcaaggtggtggcgcccgggcagctggtccattttcagatcctgctggctgccggctcagctgtcaccttccgcctgcaggtcggcggggccaaccccgaggtgctccccgggccccgtttctcccacagcttcccccgcgtcggagaccacgtggtgagcgtgcggggcaaaaaccacgtgagctgggcccaggcgcaggtgcgcatcgtggtgctggaggccgtgagtgggctgcaggtgcccaactgctgcgagcctggcatcgccacgggcactgagaggaacttcacagcccgcgtgcagcgcggctctcgggtcgcctacgcctggtacttctcgctgcagaaggtccagggcgactcgctggtcatcctgtcgggccgcgacgtcacctacacgcccgtggccgcggggctgttggagatccaggtgcgcgccttcaacgccctgggcagtgagaaccgcacgctggtgctggaggttcaggacgccgtccagtatgtggccctgcagagcggcccctgcttcaccaaccgctcggcgcagtttgaggccgccaccagccccagcccccggcgtgtggcctaccactgggactttggggatgggtcgccagggcaggacacagatgagcccagggccgagcactcctacctgaggcctggggactaccgcgtgcaggtgaacgcctccaacctggtgagcttcttcgtggcgcaggccacggtgaccgtccaggtgctggcctgccgggagccggaggggacgtggtcctgcccctgcaggtgctgatgcggcgatcacagcgcaactacttggaggcccacgttgacctgcgcgactgcgtcacctaccagactgagtaccgctgggaggtgtatcgcaccgccagctgccagcggccggggcgcccagcgcgtgtggccctgcccggcgtggacgtgagccggcctcggctggtgctgccgcggctggcgctgcctgtggggcactactgctttgtgtttgtcgtgtcatttggggacacgccactgacacagagcatccaggccaatgtgacggtggcccccgagcgcctggtgcccatcattgagggtggctcataccgcgtgtggtcagacacacgggacctggtgctggatgggagcgagtcctacgaccccaacctggaggacggcgaccagacgccgctcagtttccactgggcctgtgtggcttcgacacagagggaggctggcgggtgtgcgctgaactttgggccccgcgggagcagcacggtcaccattccacgggagcggctggcggctggcgtggagtacaccttcagcctgaccgtgtggaaggccggccgcaaggaggaggccaccaaccagacggtgctgatccggagtggccgggtgcccattgtgtccttggagtgtgtgtcctgcaaggcacaggccgtgtacgaagtgagccgcagctcctacgtgtacttggagggccgctgcctcaattgcagcagcggctccaagcgagggcggtgggctgcacgtacgttcagcaacaagacgctggtgctggatgagaccaccacatccacgggcagtgcaggcatgcgactggtgctgcggcggggcgtgctgcgggacggcgagggatacaccttcacgctcacggtgctgggccgctctggcgaggaggagggctgcgcctccatccgcctgtcccccaaccgcccgccgctggggggctcttgccgcctcttcccactgggcgctgtgcacgccctcaccaccaaggtgcacttcgaatgcacgggctggcatgacgcggaggatgctggcgccccgctggtgtacgccctgctgctgcggcgctgtcgccagggccactgcgaggagttctgtgtctacaagggcagcctctccagctacggagccgtgctgcccccgggtttcaggccacacttcgaggtgggcctggccgtggtggtgcaggaccagctgggagccgctgtggtcgccctcaacaggtctttggccatcaccctcccagagcccaacggcagcgcaacggggctcacagtctggctgcacgggctcaccgctagtgtgctcccagggctgctgcggcaggccgatccccagcacgtcatcgagtactcgttggccctggtcaccgtgctgaacgagtacgagcgggccctggacgtggcggcagagcccaagcacgagcggcagcaccgagcccagatacgcaagaacatcacggagactctggtgtccctgagggtccacactgtggatgacatccagcagatcgctgctgcgctggcccagtgcatggggcccagcagggagctcgtatgccgctcgtgcctgaagcagacgctgcacaagctggaggccatgatgctcatcctgcaggcagagaccaccgcgggcaccgtgacgcccaccgccatcggagacagcatcctcaacatcacaggagacctcatccacctggccagctcggacgtgcgggcaccacagccctcagagctgggagccgagtcaccatctcggatggtggcgtcccaggcctacaacctgacctctgccctcatgcgcatcctcatgcgctcccgcgtgctcaacgaggagcccctgacgctggcgggcgaggagatcgtggcccagggcaagcgctcggacccgcggagcctgctgtgctatggcggcgccccagggcctggctgccacttctccatccccgaggctttcagcggggccctggccaacctcagtgacgtggtgcagctcatctttctggtggactccaatccctttccctttggctatatcagcaactacaccgtctccaccaaggtggcctcgatggcattccagacacaggccggcgcccagatccccatcgagcggctggcctcagagcgcgccatcaccgtgaaggtgcccaacaactcggactgggctgcccggggccaccgcagctccgccaactccgccaactccgttgtggtccagccccaggcctccgtcggtgctgtggtcaccctggacagcagcaaccctgcggccgggctgcatctgcagctcaactatacgctgctggacggccactacctgtctgaggaacctgagccctacctggcagtctacctacactcggagccccggcccaatgagcacaactgctcggctagcaggaggatccgcccagagtcactccagggtgctgaccaccggccctacaccttcttcatttccccggggagcagagacccagcggggagttaccatctgaacctctccagccacttccgctggtcggcgctgcaggtgtccgtgggcctgtacacgtccctgtgccagtacttcagcgaggaggacatggtgtggcggacagaggggctgctgcccctggaggagacctcgccccgccaggccgtctgcctcacccgccacctcaccgccttcggcgccagcctcttcgtgcccccaagccatgtccgctttgtgtttcctgagccgacagcggatgtaaactacatcgtcatgctgacatgtgctgtgtgcctggtgacctacatggtcatggccgccatcctgcacaagctggaccagttggatgccagccggggccgcgccatccctttctgtgggcagcggggccgcttcaagtacgagatcctcgtcaagacaggctggggccggggctcaggtaccacggcccacgtgggcatcatgctgtatggggtggacagccggagcggccaccggcacctggacggcgacagagccttccaccgcaacagcctggacatcttccggatcgccaccccgcacagcctgggtagcgtgtggaagatccgagtgtggcacgacaacaaagggctcagccctgcctggttcctgcagcacgtcatcgtcagggacctgcagacggcacgcagcgccttcttcctggtcaatgactggctttcggtggagacggaggccaacgggggcctggtggagaaggaggtgctggccgcgagcgacgcagcccttttgcgcttccggcgcctgctggtggctgagctgcagcgtggcttctttgacaagcacatctggctctccatatgggaccggccgcctcgtagccgtttcactcgcatccagagggccacctgctgcgttctcctcatctgcctcttcctgggcgccaacgccgtgtggtacggggctgttggcgactctgcctacagcacggggcatgtgtccaggctgagcccgctgagcgtcgacacagtcgctgttggcctggtgtccagcgtggttgtctatcccgtctacctggccatcctttttctcttccggatgtcccggagcaaggtggctgggagcccgagccccacacctgccgggcagcaggtgctggacatcgacagctgcctggactcgtccgtgctggacagctccttcctcacgttctcaggcctccacgctgagcaggcctttgttggacagatgaagagtgacttgtttctggatgattctaagagtctggtgtgctggccctccggcgagggaacgctcagttggccggacctgctcagtgacccgtccattgtgggtagcaatctgcggcagctggcacggggccaggcgggccatgggctgggcccagaggaggacggcttctccctggccagcccctactcgcctgccaaatccttctcagcatcagatgaagacctgatccagcaggtccttgccgagggggtcagcagcccagcccctacccaagacacccacatggaaacggacctgctcagcagcctgtccagcactcctggggagaagacagagacgctggcgctgcagaggctgggggagctggggccacccagcccaggcctgaactgggaacagccccaggcagcgaggctgtccaggacaggactggtggagggtctgcggaagcgcctgctgccggcctggtgtgcctccctggcccacgggctcagcctgctcctggtggctgtggctgtggctgtctcagggtgggtgggtgcgagcttccccccgggcgtgagtgttgcgtggctcctgtccagcagcgccagcttcctggcctcattcctcggctgggagccactgaaggtcttgctggaagccctgtacttctcactggtggccaagcggctgcacccggatgaagatgacaccctggtagagagcccggctgtgacgcctgtgagcgcacgtgtgccccgcgtacggccaccccacggctttgcactcttcctggccaaggaagaagcccgcaaggtcaagaggctacatggcatgctgcggagcctcctggtgtacatgctttttctgctggtgaccctgctggccagctatggggatgcctcatgccatgggcacgcctaccgtctgcaaagcgccatcaagcaggagctgcacagccgggccttcctggccatcacgcggtctgaggagctctggccatggatggcccacgtgctgctgccctacgtccacgggaaccagtccagcccagagctggggcccccacggctgcggcaggtgcggctgcaggaagcactctacccagaccctcccggccccagggtccacacgtgctcggccgcaggaggcttcagcaccagcgattacgacgttggctgggagagtcctcacaatggctcggggacgtgggcctattcagcgccggatctgctgggggcatggtcctggggctcctgtgccgtgtatgacagcgggggctacgtgcaggagctgggcctgagcctggaggagagccgcgaccggctgcgcttcctgcagctgcacaactggctggacaacaggagccgcgctgtgttcctggagctcacgcgctacagcccggccgtggggctgcacgccgccgtcacgctgcgcctcgagttcccggcggccggccgcgccctggccgccctcagcgtccgcccctttgcgctgcgccgcctcagcgcgggcctctcgctgcctctgctcacctcggtgtgcctgctgctgttcgccgtgcacttcgccgtggccgaggcccgtacttggcacagggaagggcgctggcgcgtgctgcggctcggagcctgggcgcggtggctgctggtggcgctgacggcggccacggcactggtacgcctcgcccagctgggtgccgctgaccgccagtggacccgtttcgtgcgcggccgcccgcgccgcttcactagcttcgaccaggtggcgcagctgagctccgcagcccgtggcctggcggcctcgctgctcttcctgcttttggtcaaggctgcccagcagctacgcttcgtgcgccagtggtccgtctttggcaagacattatgccgagctctgccagagctcctgggggtcaccttgggcctggtggtgctcggggtagcctacgcccagctggccatcctgctcgtgtcttcctgtgtggactccctctggagcgtggcccaggccctgttggtgctgtgccctgggactgggctctctaccctgtgtcctgccgagtcctggcacctgtcacccctgctgtgtgtggggctctgggcactgcggctgtggggcgccctacggctgggggctgttattctccgctggcgctaccacgccttgcgtggagagctgtaccggccggcctgggagccccaggactacgagatggtggagttgttcctgcgcaggctgcgcctctggatgggcctcagcaaggtcaaggagttccgccacaaagtccgctttgaagggatggagccgctgccctctcgctcctccaggggctccaaggtatccccggatgtgcccccacccagcgctggctccgatgcctcgcacccctccacctcctccagccagctggatgggctgagcgtgagcctgggccggctggggacaaggtgtgagcctgagccctcccgcctccaagccgtgttcgaggccctgctcacccagtttgaccgactcaaccaggccacagaggacgtctaccagctggagcagcagctgcacagcctgcaaggccgcaggagcagccgggcgcccgccggatcttcccgtggcccatccccgggcctgcggccagcactgcccagccgccttgcccgggccagtcggggtgtggacctggccactggccccagcaggacaccccttcgggccaagaacaaggtccaccccagcagcacttagtcctccttcctggcgggggtgggccgtggagtcggagtggacaccgctcagtattactttctgccgctgtcaaggccgagggccaggcagaatggctgcacgtaggttccccagagagcaggcaggggcatctgtctgtctgtgggcttcagcactttaaagaggctgtgtggccaaccaggacccagggtcccctccccagctcccttgggaaggacacagcagtattggacggtttctagcctctgagatgctaatttatttccccgagtcctcaggtacagcgggctgtgcccggccccaccccctgggcagatgtcccccactgctaaggctgctggcttcagggagggttagcctgcaccgccgccaccctgcccctaagttattacctctccagttcctaccgtactccctgcaccgtctcactgtgtgtctcgtgtcagtaatttatatggtgttaaaatgtgtatatttttgtatgtcactattttcactagggctgaggggcctgcgcccagagctggcctcccccaacacctgctgcgcttggtaggtgtggtggcgttatggcagcccggctgctgcttggatgcgagcttggccttgggccggtgctgggggcacagctgtctgccaggcactctcatcaccccagaggccttgtcatcctcccttgccccaggccaggtagcaagagagcagcgcccaggcctgctggcatcaggtctgggcaagtagcaggactaggcatgtcagaggaccccagggtggttagaggaaaagactcctcctgggggctggctcccagggtggaggaaggtgactgtgtgtgtgtgtgtgtgcgcgcgcgcacgcgcgagtgtgctgtatggcccaggcagcctcaaggccctcggagctggctgtgcctgcttctgtgtaccacttctgtgggcatggccgcttctagagcctcgacacccccccaacccccgcaccaagcagacaaagtcaataaaagagctgtctgactgc